(19) United States
(12) Patent Application Publication
(10) Pub. No.: US 2026/0324695 A1
(43) Pub. Date: Oct. 22, 2026

(54) AMINO ACID ALTERNATIVE CURING SYSTEM

(71) Applicant: THE TEXAS A&M UNIVERSITY SYSTEM, College Station, TX (US)

(72) Inventors: Wesley N. Osburn, Bryan, TX (US); Katherine M. Modrow, Denton, TX (US)

(21) Appl. No.: 19/552,117

(22) Filed: Feb. 27, 2026

Related U.S. Application Data
(62) Division of application No. 17/783,557, filed on Dec. 17, 2020, now abandoned.
(60) Provisional application No. 62/951,838, filed on Dec. 20, 2019.

(51) Int. Cl. A23L 13/72; A23B 4/28; A23B 4/32; A23L 13/40

(52) U.S. Cl. CPC A23L 13/72; A23B 4/285; A23B 4/325; A23L 13/428; A23L 13/432

(57) ABSTRACT

This invention is in the field of meat processing and contemplates curing compositions and methods of use thereof. The invention also contemplates methods of using the curing compositions in the processing of meat, including both pre-rigor and post-rigor meat.

### CROSS-REFERENCE TO RELATED APPLICATIONS

The present application is a divisional of, and claims priority to co-pending U.S. application Ser. No. 17/783,557, filed on Jun. 8, 2022, which is a national entry of PCT/US2020/065611, filed Dec. 17, 2020, which claims the benefit of U.S. Provisional Patent Application No. 62/951,838, filed on Dec. 19, 2019, now expired, which is incorporated herein by reference.

### FIELD OF THE INVENTION

This invention is in the field of meat processing and contemplates curing compositions and methods of use thereof. The invention also contemplates methods of using the curing compositions in the processing of meat, including both pre-rigor and post-rigor meat.

### BACKGROUND OF THE INVENTION

Sodium nitrite is added to processed meat products to maintain microbial quality, flavor, color, and shelf stability. Consumer demand for natural and organic products has increased due to concerns of the health risks associated with the addition of synthetic additives (i.e., sodium nitrite). Currently, no effective single replacement ingredient possessing the functional properties of sodium nitrite has been identified. Therefore, there is a continued need effective single replacement ingredient possessing the functional properties of sodium nitrite in processed meat products.

### SUMMARY OF THE INVENTION

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

This invention is in the field of meat processing and contemplates curing compositions and methods of use thereof. The invention also contemplates methods of using the curing compositions in the processing of meat, including both pre-rigor and post-rigor meat.

In one embodiment, the invention relates to a method for curing pre-rigor meat comprising, a. providing i. a curing composition comprising amino acid L-arginine, ii. pre-rigor meat, b. treating the pre-rigor meat with said curing composition as a function of the weight of the meat being treated to provide the desired meat product. In one embodiment, said meat is pre-rigor meat. In one embodiment, said meat is post-rigor meat. In one embodiment, said curing composition further comprises NaCl and sodium erythorbate. In one embodiment, said curing composition further comprises citrulline. In one embodiment, the sodium chloride is in a range from 0.5% to 2.0% by weight of said meat. The invention is not to be limited by the range or types of salt to be added. In one embodiment, the curing composition is injected into said meat. The invention is not limited to means on introduction of composition to said meat. In one embodiment, said curing composition is in the form of a solution. In one embodiment, the curing composition is injected into said meat. In one embodiment, said meat is immersed in said solution for at least two hours. In one embodiment, the treating step is performed by mixing said curing composition directly with meat, and mechanical agitation the of the meat mixture to provide uniform distribution of the curing composition in the meat being treated. The present invention is not limited to the means of mixing of composition and meat. In one embodiment, said mechanical agitation comprises at one of the following: kneading, mixing, tumbling, massaging, chopping, and emulsifying. In one embodiment, said curing composition is a dry formulation. In one embodiment, said curing composition is applied dry to meat surfaces. In one embodiment, said method is a replacement for the standard nitrite curing method. In one embodiment, said method is in partial substitution of a standard nitrite curing method. In one embodiment, the invention may also be applied to fermented/acidulated products. In one embodiment, the method is used with the addition of an encapsulated acid (lactic.citric, blends) or a fermentation starter culture. In one embodiment, the method produces meat with reduced sodium content relative to the nitrite curing process.

In one embodiment, the invention relates to a method for curing pre-rigor meat comprising, a. providing i. a curing composition comprising amino acid L-arginine, ii. pre-rigor meat, b. treating the pre-rigor meat with said curing composition as a function of the weight of the meat being treated to provide the desired meat product. In one embodiment, said curing composition further comprises NaCl and sodium erythorbate. In one embodiment, the invention relates to a said curing composition further comprises citrulline. In one embodiment, the sodium chloride is in a range from 0.5% to 2.0% by weight of said pre-rigor meat. The invention is not to be limited by the range or types of salt to be added. In one embodiment, said curing composition does not comprise potassium hydroxide. In one embodiment, the curing composition is injected into said pre-rigor meat. In one embodiment, said curing composition is in the form of a solution. In one embodiment, the curing composition is injected into said pre-rigor meat. In one embodiment, said pre-rigor meat is immersed in said solution for at least one hour. In one embodiment, said pre-rigor meat is immersed in said solution for at least two hours. In one embodiment, said pre-rigor meat is immersed in said solution for less than ten days. In one embodiment, the treating step is performed by mixing said curing composition directly with pre-rigor cuts of meat, and mechanical agitation of the meat mixture to provide uniform distribution of the curing composition in the meat being treated. In one embodiment, said mechanical agitation comprises at one of the following: kneading, mixing, tumbling, massaging, chopping, and emulsifying. In one embodiment, said curing composition is a dry formulation. In one embodiment, said curing method may be done in conjunction with a fermentation process. Although not limiting the present mention, in one embodiment, said curing method is not required to be made in conjunction with a fermentation process. In one embodiment, said curing method prevents, eliminates or reduces to an acceptable level the growth of microorganisms, including food borne pathogens commonly associated with processed meat products.

In one embodiment, the invention relates to a method for curing post-rigor meat comprising, a. providing i. a curing composition comprising amino acid L-arginine, ii. post-rigor meat, b. treating the post-rigor meat with said curing composition as a function of the weight of the meat being treated to provide the desired meat product. In one embodiment, the invention relates to a said curing composition further comprises NaCl and sodium erythorbate. In one embodiment, said curing composition comprises a curing accelerator. In one embodiment, said curing accelerator comprises cherry powder. In one embodiment, said curing accelerator comprises sodium erythorbate. In one embodiment, said curing composition comprises a combination of salt, sugar, and amino acid. In one embodiment, said curing composition comprises citrulline. In one embodiment, said composition further comprises at least one cure accelerator (natural or artificial, see Example 26). In one embodiment, the sodium chloride is in a range from 0.5% to 2.0% by weight of said post-rigor meat. The invention is not to be limited by the range or types of salt to be added. In one embodiment, the invention relates to a said curing composition further comprises celery juice powder. In one embodiment, the invention relates to a said curing composition further comprises celery juice powder and cherry powder. In one embodiment, said curing composition does not comprise potassium hydroxide. In one embodiment, the curing composition is injected into said post-rigor meat. In one embodiment, said curing composition is in the form of a solution. In one embodiment, the curing composition is injected into said post-rigor meat. In one embodiment, said post-rigor meat is immersed in said solution for at least one hour. In one embodiment, said post-rigor meat is immersed in said solution for at least two hours. In one embodiment, said post-rigor meat is immersed in said solution for less than 10 days. In one embodiment, the treating step is performed by mixing said curing composition directly with the cuts of meat, and mechanical agitation of the meat mixture to provide uniform distribution of the curing composition in the meat being treated. In one embodiment, said mechanical agitation comprises at one of the following: kneading, mixing, tumbling, massaging, chopping, and emulsifying. In one embodiment, said curing composition is a dry formulation. In one embodiment, said curing method may be done in conjunction with a fermentation process. Although not limiting the present mention, in one embodiment, said curing method is not done in conjunction with fermentation. In one embodiment, said curing method comprises a meat processing aid. In one embodiment, said curing method comprises a meat flavor enhancer. In one embodiment, said curing method comprises improved shelf life for meats. In one embodiment, said curing method prevents, eliminates or reduces to an acceptable level the growth of microorganisms, including food borne pathogens commonly associated with processed meat products. In one embodiment, the invention may also be applied to the manufacture of various pet food products manufactured in a similar fashion as the previously mentioned process meat products (i.e. pet treats).

In one embodiment, the invention relates to curing compositions comprising a combination of salt, sugar, and amino acid. In one embodiment, said amino acid comprises L-arginine. In one embodiment, said amino acid comprises citrulline. In one embodiment, said amino acid comprises a combination of L-arginine and citrulline. In one embodiment, said composition comprises 4-20% amino acid by mass. In one embodiment, said composition comprises 12-16% sugar by mass. In one embodiment, said composition comprises 65-84% salt by mass. In one embodiment, said composition further comprises erythorbate. In one embodiment, said composition may be added to an aqueous solution to create a curing solution. In one embodiment, said curing solution comprises 4% to 26% curing composition by mass. In one embodiment, said curing composition may be up to 300% the mass of the meat to be treated. In one embodiment, said composition comprises a meat processing aid. In one embodiment, said composition comprises a meat flavor enhancer. In one embodiment, said composition comprises improve shelf life for meats. In one embodiment, said composition further comprises at least one cure accelerator. In one embodiment, said composition comprises no nitrite.

In one embodiment, the invention relates to a method of extending the shelf life of a meat product comprising: a. providing i. a curing composition comprising amino acid L-arginine, ii. pre-rigor meat, b. treating the pre-rigor meat with said curing composition as a function of the weight of the meat being treated to provide the desired meat product. In one embodiment, said method reduces the lipid oxidation of the meat product. In one embodiment, said method increases microbial stability. In one embodiment, said method provides similar shelf stability to a traditionally cured product. In one embodiment, said meat is pre-rigor meat. In one embodiment, said meat is post-rigor meat. In one embodiment, said curing composition further comprises NaCl and sodium erythorbate. In one embodiment, said curing composition further comprises citrulline. In one embodiment, the sodium chloride is in a range from 0.5% to 2.0% by weight of said meat. The invention is not to be limited by the range or types of salt to be added. In one embodiment, the curing composition is injected into said meat. The invention is not limited to means on introduction of composition to said meat. In one embodiment, said curing composition is in the form of a solution. In one embodiment, the curing composition is injected into said meat. In one embodiment, said meat is immersed in said solution for at least two hours. In one embodiment, the treating step is performed by mixing said curing composition directly with meat, and mechanical agitation the of the meat mixture to provide uniform distribution of the curing composition in the meat being treated. The present invention is not limited to the means of mixing of composition and meat. In one embodiment, said mechanical agitation comprises at one of the following: kneading, mixing, tumbling, massaging, chopping, and emulsifying. In one embodiment, said curing composition is a dry formulation. In one embodiment, said curing composition is applied dry to meat surfaces. In one embodiment, said method is a replacement for the standard nitrite curing method. In one embodiment, said method is in partial substitution of a standard nitrite curing method. In one embodiment, the invention may also be applied to fermented/acidulated products. In one embodiment, the method is used with the addition of an encapsulated acid (lactic, citric, blends) or a fermentation starter culture.

In one embodiment, the invention relates to a method of enhancing the color of a meat product comprising: a. providing i. a curing composition comprising amino acid L-arginine, ii. pre-rigor meat, b. treating the pre-rigor meat with said curing composition as a function of the weight of the meat being treated to provide the desired meat product. In one embodiment, said process leads to uniform external brown color compared to sodium nitrite treated meat. In one embodiment, said method reduces the lipid oxidation of the meat product. In one embodiment, said method increases microbial stability. In one embodiment, said method provides similar shelf stability to a traditionally cured product. In one embodiment, said meat is pre-rigor meat. In one embodiment, said meat is post-rigor meat. In one embodiment, said curing composition further comprises NaCl and sodium erythorbate. In one embodiment, said curing composition further comprises citrulline. In one embodiment, the sodium chloride is in a range from 0.5% to 2.0% by weight of said meat. The invention is not to be limited by the range or types of salt to be added. In one embodiment, the curing composition is injected into said meat. The invention is not limited to means on introduction of composition to said meat. In one embodiment, said curing composition is in the form of a solution. In one embodiment, the curing composition is injected into said meat. In one embodiment, said meat is immersed in said solution for at least two hours. In one embodiment, the treating step is performed by mixing said curing composition directly with meat, and mechanical agitation the of the meat mixture to provide uniform distribution of the curing composition in the meat being treated. The present invention is not limited to the means of mixing of composition and meat. In one embodiment, said mechanical agitation comprises at one of the following: kneading, mixing, tumbling, massaging, chopping, and emulsifying. In one embodiment, said curing composition is a dry formulation. In one embodiment, said curing composition is applied dry to meat surfaces. In one embodiment, said method is a replacement for the standard nitrite curing method. In one embodiment, said method is in partial substitution of a standard nitrite curing method. In one embodiment, the invention may also be applied to fermented/acidulated products. In one embodiment, the method is used with the addition of an encapsulated acid (lactic, citric, blends) or a fermentation starter culture. In one embodiment, said composition comprises no nitrite.

In one embodiment, the invention relates to a method of enhancing the flavor of a meat product comprising: a. providing i. a curing composition comprising amino acid L-arginine, ii. pre-rigor meat, b. treating the pre-rigor meat with said curing composition as a function of the weight of the meat being treated to provide the desired meat product. In one embodiment, said method produces a more intense cured meat flavor than traditional nitrite curing. In one embodiment, said method reduces the lipid oxidation of the meat product. In one embodiment, said method increases microbial stability. In one embodiment, said method provides similar shelf stability to a traditionally cured product. In one embodiment, said meat is pre-rigor meat. In one embodiment, said meat is post-rigor meat. In one embodiment, said curing composition further comprises NaCl and sodium erythorbate. In one embodiment, said curing composition further comprises citrulline. In one embodiment, the sodium chloride is in a range from 0.5% to 2.0% by weight of said meat. In one embodiment, the curing composition is injected into said meat. The invention is not limited to means on introduction of composition to said meat. In one embodiment, said curing composition is in the form of a solution. In one embodiment, the curing composition is injected into said meat. In one embodiment, said meat is immersed in said solution for at least two hours. In one embodiment, the treating step is performed by mixing said curing composition directly with meat, and mechanical agitation the of the meat mixture to provide uniform distribution of the curing composition in the meat being treated. The present invention is not limited to the means of mixing of composition and meat. In one embodiment, said mechanical agitation comprises at one of the following: kneading, mixing, tumbling, massaging, chopping, ad emulsifying. In one embodiment, said curing composition is a dry formulation. In one embodiment, said curing composition is applied dry to meat surfaces. In one embodiment, said method is a replacement for the standard nitrite curing method. In one embodiment, said method is in partial substitution of a standard nitrite curing method. In one embodiment, the invention may also be applied to fermented/acidulated products. In one embodiment, the method is used with the addition of an encapsulated acid (lactic, citric, blends) or a fermentation starter culture. In one embodiment, said composition comprises no nitrite.

Other objects, advantages, and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### DEFINITIONS

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

In the art, a distinction is usually made between processed and non-processed meat products. The term ‘processed meat’ typically is used to refer to meat products, the preparation of which involves processing steps in addition to merely skinning the carcass, dismembering the carcass and/or boning of the meat. Processed meat and poultry products are a very broad category of many different types of products all defined by having undergone at least one further processing or preparation step such as grinding, adding an ingredient, subjecting to heat-treatment, smoking, fermenting, drying, etc. Such treatment significantly change the appearance, texture and/or taste of the meat. Some processed meat products are ready-to-cook, other processed meat and poultry are ready-to-eat. Processed meat products include, for example, whole hams, whole or partial turkey breasts, fish cakes, fish fillets, smoked fish, surimi, delicatessen-style meat products, such as for example, baked ham, boiled ham, roasted turkey breast, roast beef, corned beef, pastrami, bologna, capicola, mortadella, salami, chicken loaf, chicken roll, turkey loaf, turkey roll, hot dogs, frankfurter, sausage, cooked ham, cooked chicken, cooked turkey, cured ham, cured sausage, cured jerky, fermented sausage etc. In one embodiment, the invention may also be applied to the manufacture of various pet food products manufactured in a similar fashion as the previously mentioned process meat products (i.e. pet treats).

According to a preferred embodiment of the invention, the meat product is a fresh or non-processed meat product, preferably a fresh or non-processed meat product selected from the group consisting of animal carcasses, animal carcass parts, fresh or raw cut meat pieces, raw ground meat, raw ground meat products, etc. According to a preferred embodiment of the invention, the meat product is a processed meat product manufactured from fresh trimmings from meat animal, exotic, poultry or fish species, typically obtained by mixing finely comminuted, minced or sliced muscle meat, with one or more additional ingredients, such as animal fat, common salt, spices, binders, fillers, etc. It can also be applied via injection, marination/soaking of whole muscle pieces or can be applied to the surface of whole muscles/pieces (dry rub or cure). Frozen trimmings from meat animal, exotic, poultry or fish species can also be used in singly or in combination with fresh trimmings. In one embodiment, the invention may also be applied to fermented/acidulated products.

As used herein, the term “aging of muscle” refers to the storage of meat or muscle foods at refrigerator temperatures.

As used herein, the term “enhanced tenderness” refers to the reduced shear force and/or increased desirability of taste panel tenderness ratings which occurs as a result of treatment.

As used herein, the term “high pH” when referring to the ultimate pH value of muscle or meat means a pH (acidity) reading that is higher than that normally found in muscle or meat after the completion of rigor mortis.

As used herein, the term “hot boned” and “hot boning” refers to removal of meat from carcasses prior to rigor mortis.

As used herein, the term “Pre-rigor meat” refers to meat removed from carcasses prior to rigor mortis.

As used herein, the term “lean color” refers to the ultimate color of meat after exposure to air and binding of oxygen to myoglobin which impart a bright, cherry red color to the meat. Lean color may be described in terms of redness, brightness, hue, and many other objective and subjective terms.

As used herein, the term “meat” shall include, without limitation, both cooked and uncooked meats irrespective of the state of rigor-mortis, and all edible meats, such as, for example, beef, pork, lamb, deer, bison, poultry and the like.

As used herein, the term “meat quality traits” refer to those characteristics of meat or muscle foods that influence the appearance, eating quality or processing quality of the meat or are indicative of such characteristics. Examples include color, tenderness, flavor, juiciness, and water holding capacity, among others.

As used herein, the term “meat texture” refers to the physical properties of meat and muscle relating to eating quality, including tenderness.

As used herein, the term “microbial stability” refers preventing, eliminating or reducing to an acceptable level the growth of microorganisms, including food borne pathogens commonly associated with processed meat products. In one embodiment, the present invention curing process provides the meat or muscle product to maintain micro-organisms at their current level and resist (or slow) excessive growth of spoilage micro-organisms.

As used herein, the term “muscle type” refers to the broad classification of striated, skeletal muscle into categories based upon their blend of muscle fiber type. Muscles are comprised of a mix of muscle fiber types. Each fiber (muscle cell) can be classified by several different systems as a particular type. One example of a classification system is red, intermediate, and white. Another is beta-red, alpha-red, and alpha white. Still others classify as type I, type IIA, and type IIB. Each system depends on specific biochemical and biophysical characteristics of the muscle. Skeletal muscles are comprised of a blend of muscle fiber types. Thus, whole skeletal muscles are often classified on the basis of the predominate nature of their fiber type profile. Those with many beta-red fibers might be considered “red” muscles while those with many alpha-white muscle fibers would be considered “white” muscles. This is an imperfect system because even the “white” muscles contain some beta-red fibers. Skeletal muscles exhibit characteristics that can be associated with one or more muscle fiber types, depending on the relative proportions of different muscle fiber types.

As used herein, the term “Tenderness of meat” refers to objective measures and/or subjective measure of the amount of force needed to cut or fragment cooked meat.

As used herein, the term “Whole pre-rigor skeletal muscle” refers to striated skeletal muscle from animals used for meat.

As used herein, the term “meat” refers to muscle from animals, including, but not limited to beef, pork, poultry, lamb, wildlife/exotic animals, and fish.

As used herein, the term “off-flavor” refers to a flavor not usually associated with fresh meat.

As used herein, the term “salt” refers to a composition primarily containing sodium chloride. In some embodiments, salt also contains some potassium chloride salt, a blend of potassium and sodium chloride salt, any type of sea salt, or kosher salt. In preferred embodiments said salt is at least 99% sodium chloride salt. In preferred embodiments said salt is at least 95% sodium chloride salt.

As used herein, the term “sugar” is meant to encompass mono-, di- or oligo- or polysaccharides, e.g. saccharose, fructose, mannose, maltose etc., preferably saccharose or fructose, or a mixture thereof, and the sugar may be present in the form of a powder, a granulate or a solution. Also sugars with a low metabolic reaction rate and consequently a low calorie content such as palatinose, may be used. An example of a sugar product that does not have any sweet taste is trehalose.

As used herein, the term “curing system” refers to a system for the preservation and flavoring of food product, including but not limited to meat. Curing systems include, but are not limited to, injection, immersion, tumbling, dry application of curing composition, and a combination (inject and dry rub). The curing system of the present invention prevents, eliminates or reduces to an acceptable level the growth of microorganisms, including food borne pathogens commonly associated with processed meat products.

As used herein, the term “cure accelerator” refers to a composition that affects the curing reaction by reducing conditions and reduced pH of meat and the meat system, respectively. “Natural” cure accelerators include acidifiers such as vinegar, lemon juice solids and reducing agents like cherry powder. Some cure accelerators are artificial e.g., ascorbic acid, erythorbic acid, or their derivatives. Cure accelerators tend to speed up chemical conversion of nitric acid to nitric oxide. They also serve as oxygen scavengers, which slow the fading of the cured meat color in the presence of sunlight and oxygen. It is believed that some cure accelerators have antimicrobial properties.

As used herein, the term “oxidation reduction potential” refers to the biochemical ability of the muscle/meat to counter oxidation through subsequent reduction of the oxidized compounds.

As used herein, the term “Pre-rigor” refers to muscle that has not completed the process of rigor mortis or attained its ultimate, post-slaughter pH.

As used herein, the term “Sarcomere length” or “SL” reflects the degree of muscle contraction present in the muscle.

As used herein, the term “Shear force” refers to the amount of mechanical force needed to cut a core of meat; a standardized procedure to provide an objective measure of meat tenderness.

As used herein, the term “Sodium citrate” is used herein to refer to citric acid and its salts, and includes sodium citrate, calcium citrate and other salts of citric acid. The USDA considers citric acid and its salts to be covered by the phrase, citric acid. (9 CFR § 318.7)

NOMENCLATURE

| | |
|---|---|
| Acetyl-CoA | Acetyl coenzyme A |
| ASS | Argininosuccinate synthase |
| ADP | Adenosine diphosphate |
| ATP | Adenosine triphosphate |
| Ca²⁺ | Calcium |
| CFR | Code of Federal Regulations |
| CP | Carbamoyl Phosphate |
| Dmb | Deoxymyoglobin |
| eNOS | Endothelial NOS |
| ETC | Electron Transport Chain |
| GSNO | S-nitrosoglutathione |
| HNO₂ | Nitrous acid |
| H₂N₂O₂ | Hyponitrous acid |
| HNO₃ | Nitric acid |
| iNOS | Inducible NOS |
| I/R | Ischemia/reperfusion |
| Mb | Myoglobin |
| mM | Millimolar |
| Mmb | Metmyoglobin |
| mtNOS | Mitochondrial NOS |
| N₂ | Dinitrogen gas |
| Na⁺ | Sodium |
| NaCl | Sodium chloride |
| NaE | Sodium erythorbate |
| Ngb | Neuroglobin |
| NH₂OH | Hydroxylamine |
| NH₃ | Ammonia |
| NH₄NO₂ | Ammonium nitrite |
| nNOS | Isoform neuronal NOS |
| NO | Nitric Oxide |
| NOS | Nitric Oxide Synthase |
| NO₂ | Nitrite |
| N₂O | Nitrous Oxide |
| NO(II)Mb | Nitric oxide myoglobin |
| OAA | Oxaloacetate |
| Omb | Oxymyoglobin |
| ppm | Parts per million |
| ROS | Reactive oxygen species |
| RSNO | S-nitrosothiol |
| USDA | United States Department of Agriculture |

### BRIEF DESCRIPTION OF THE DRAWINGS

The file of this patent contains at least one drawing executed in color. Copies of this patent with color drawings will be provided by the Patent and Trademark Office upon request and payment of the necessary fee.

The accompanying figures, which are incorporated into and form a part of the specification, illustrate several embodiments of the present invention and, together with the description, serve to explain the principles of the invention. The figures are only for the purpose of illustrating a preferred embodiment of the invention and are not to be construed as limiting the invention.

FIG. 1 shows cured meat color formation. The steps to form nitrosylhemochromagen (cured meat pigment) from myoglobin (fresh meat pigment). Ascorbate and SH-groups are included in this figure to indicate influence of color change reaction being accelerated or inhibited. The initial form of nitrite as nitrite or nitric oxide also influences the rate of color change reaction. Adapted from Small-Scale Sausage Production, 1985 [1].

FIG. 2 shows variable conditions of nitrite with intermediate compounds depending on stability and state. Nitric acid (HNO₃) can convert to nitrous acid (HNO₂), nitrite (NO₂), or nitric oxide (NO) and back to nitric acid. These forms can convert to hyponitrous acid (H₂N₂O₂) or nitrous oxide (N₂O) and back. These states can convert to hydroxylamine (NH₂OH) and back, then to ammonia (NH₃), ammonium nitrite (NH₄NO₂), or dinitrogen gas (N₂). Adapted from Proceedings of the International Symposium on Nitrite in Meat Products, September 1973 [2].

FIG. 3 shows the Arginine Synthesis Pathways. The main metabolic pathway for arginine synthesis in mammals is done through P5C synthase and proline oxidase. Reactions occur by a chemical equilibrium favoring P5C formation that is a bifunctional polypeptide. Reactions 1-6 and 9-11 take place in mitochondria, reactions 7 and 8 in the cytosol, and reaction 12 can occur in both. Abbreviations: OAA, oxaloacetate; CP, carbamoyl phosphate. Adapted from Wu and Morris; Arginine metabolism; nitric oxide and beyond [3].

FIG. 4 shows the citrulline/NO Cycle. This particular cycle can be couple to the citric acid cycle (right). Fumerate produced in the cytosol then enters the citric acid cycle in the mitochondrion to convert into oxaloacetate. Enzymes to catalyze 1-3 reactions occur with fumarase, malate dehydrogenase and aspartate aminotransferase. The reactions are reversible but the diagram only shows the unidirectional flow in NO-producing cells. Adapted from Nussler et al. [4] and Wu and Morris; Arginine metabolism: nitric oxide and beyond [3].

FIG. 5 shows the effects of NO on meat tenderness. Mechanism in sarcolemma and sarcoplasmic reticulum to demonstrate negative effects of NO on meat tenderness by concentration of calcium and negative feedback on calpain activation. L-NAME (NOS inhibitor) positively influences meat tenderness in a counter reaction by removing negative feedback on calcium concentration in the cell and activates calpain. Adapted from Warner et al., Effects of nitric oxide and oxidation in vivo and postmortem on meat tenderness from modified Harper [5, 6].

FIG. 6 shows the procedure flow. The procedure applied to six collection times over a four day period to separate treatments for reps. Due to the sensitivity of pre-rigor meat, the samples were collected, treated with L-arginine concentrations, stabilized, and frozen all in the same day.

FIG. 7 shows a beaker of control (distilled water) and brine treated (L-arginine) samples of “test tube sausages.”

FIG. 8 shows low (1-1000 ppm), high (2-5000 ppm), and L-arginine concentrations and control (C-0 ppm) “test tube pork loin sausages”. Starting on the left, the low concentration (1) exhibits slight cured color the high concentration (2) exhibits pink cured color formation, and the control (C) has no detectable cured color.

FIG. 9 shows the color of low (A) and high concentrations of beef frankfurters with and without sodium erythorbate. Low (A-1000 ppm) and high (B-5000 ppm) L-arginine with (~547 ppm-“+”) or without (0 ppm “−”) added sodium erythorbate (cure accelerator) compared to naturally cured/uncured celery juice powder (CJP 0.5%, with cherry juice powder 0.4%, as cure accelerator) and sodium nitrite cured (NO₂, 156 ppm) with sodium erythorbate (547 ppm) cure accelerator frankfurters.

FIG. 10 shows the external color of L-arginine treated and sodium nitrite treated beef frankfurters.

FIG. 11 shows the internal color of L-arginine treated and sodium nitrite treated beef frankfurters.

### DETAILED DESCRIPTION OF THE INVENTION

This invention is in the field of meat processing and contemplates curing compositions and methods of use thereof. The invention also contemplates methods of using the curing compositions in the processing of both pre-rigor and post-rigor meat.

Curing meat products requires sodium nitrite to generate residual nitrite for preservation and development of a pink cured meat color. This study investigated the use of the essential amino acid L-arginine to activate the Nitric Oxide Synthase (NOS) in pre-rigor porcine muscle to evaluate the efficacy of this system in generating nitric oxide (NO) and residual nitrite (NO₂) as an alternative curing method. Pre-rigor porcine Semimembranosus muscle were collected from four separate carcasses at six different harvest intervals (N=24). Varying concentrations of L-arginine solutions were applied to the pre-rigor muscle samples in tubes containing NaCl and sodium erythorbate in deionized water, immersed for two hours, and transferred into separate tubes for stabilization. Cooked samples were cooked to 62° C in one hour in a water bath. After stabilization the samples were homogenized, centrifuged, and frozen at −30° C for three weeks and then analyzed for residual nitrite in raw, cooked, and cooked pellet samples, and curing efficiency in cooked samples. The data showed that raw samples overall had higher (P<0.05) levels of residual nitrite at 32 mM (14.34 ppm) compared to the control (0 mM; 0.08 ppm). The cooked samples had less residual nitrite compared to the raw samples, suggesting that the NOS system converted the nitrite to NO to form the cured meat pigment nitrosylhemochromagen. The highest concentration of residual nitrite in the cooked pellets muscle samples occurred at 32 mM (15.69 ppm). For curing efficiency and NO-hemochrome values no differences were found with respect to L-arginine concentration in the cooked supernatant samples. Differences (P<0.05) in total heme pigmentation were observed for 2 mM (24.22 ppm), 4 mM (34.17 ppm), 8 mM (70.38 ppm), 16 mM (20.14 ppm), and 32 mM (31.67 ppm) L-arginine concentrations compared to the control (0 ppm) but no significant differences between L-arginine concentrations. The pellet of cooked samples analyzed for curing efficiency were highest at 32 mM (156.72%) which was significantly different (P<0.05) compared to the control (0.00%) and to the other concentrations. This data suggests that the NOS system can generate NO and residual nitrite with the addition of L-arginine in pre-rigor porcine Semimembranosus muscle. Based on these results, there is the possibility to develop an amino acid alternative curing system for meat products.

### 1. Introduction

Sodium nitrate and nitrite are defined as a crystalline salt used as an oxidizing agent and meat curing agent that easily dissolves in water [7]. Nitrite is a highly reactive compound that can function as an oxidizing, reducing or a nitrosylating agent, and can be converted to a variety of related compounds in meat including nitrous acid, nitric oxide and nitrate [7]. The ability of nitrite to act as a curing agent depends on its distribution and amount within a product, which increases product shelf life and stability. Current curing methods with sodium nitrite are efficient and safe, but recent concerns regarding the potential carcinogenic compounds (i.e., nitrosamines) [8, 9] that can be formed from cured meat products has increased consumer concern regarding the safety of consuming cured products. Cured products include, but are not limited to, sausages, bacon, hams, jerky/dried meat products, and fermented/acidulated products. This concern has resulted in the development of alternative curing methods where nitrite is indirectly added to meat via a “high nitrite source” (i.e., vegetable/celery powder). However, these alternative curing methods are not as efficient as sodium nitrite and can develop mess than desirable organoleptic properties (vegetable taste or aroma) and less intense cured meat color [10].

The Nitric Oxide Synthase (NOS) system is vital for muscle function due to its ability to use L-arginine to convert nitrite to nitric oxide which has been proven to improve vasodilation and muscle metabolism [3, 11, 12]. Little to no research has been conducted to evaluate the NOS system's ability to generate NO and nitrite post-harvest muscle/meat, thereby presenting an opportunity to investigate the feasibility of using the NOS system as an alternative curing method.

Arginine is a major component of activating and stabilizing the NOS system, suggesting the same mechanics in muscle may still be active in pre-rigor meat. The residual nitrite and curing efficiency were used in this study to establish a baseline of any curing ability capable by arginine. This study investigates the efficacy of an essential amino acid, arginine, as a component of an alternative curing system for pork muscle and evaluates the cure reaction efficiency of the amino acid as an alternative curing system.

### 1.1. Brief History of Sodium Nitrate and Nitrite

The use of sodium nitrates and nitrites is widely utilized in many products, with strict regulations on concentrations and balance with salt and cure accelerants depending on the type of product being produced for consumption. The history of nitrite starts as early 1200 BC, through its use as a meat preservative through use of saltpeter and establishment of using saltpeter for stable red color by the Romans in the 10^{th} century [13]. During the end of the 19^{th} and beginning of the 20^{th} century started experiments for regulation and the use for concentrated nitrite instead of nitrate to cure meat products.

Haldane reported the formation of nitrosohemoglobin by adding nitrite to hemoglobin and its breakdown into nitroso-hemochromagen as being responsible for the cured red/pink color of cooked meat [14]. The reduction of nitrate to nitrite then to nitrous acid and finally nitric oxide was first studied by Haldane [14] and showed that nitrite is the primary compound for curing meat and enhancing its antimicrobial properties [13, 14].

The levels of nitrite used in the manufacture of cured meat products were determined by research starting in 1925 by the USDA Bureau of Animal Industry. It was established that no more than 200 ppm (mg/kg) of nitrate, nitrite, or any combination based on meat weight could be used to cure meat. These regulations were then clarified in 1970 by the USDA to include cure accelerators and separation of nitrites and nitrites usage based on the curing method and product being made [15]. This was amended in 1978 for bacon manufacturing, which stated that nitrate could not be used only nitrite for better control of nitrite concentrations [16]. Table 1 represents the amount allowed for cured meat and poultry products in the United States.

TABLE 1
Curing Agent Regulations
Maximum allowed added levels of curing ingredients
in meat and poultry in the United States.^{a}

| | Curing method | | | |
|---|---|---|---|---|
| | Immersion | Massaged | | Dry |
| | cured | or pumped | Comminuted | cured |
| Curing agent | (ppm) | (ppm) | (ppm) | (ppm) |
| Sodium nitrite | 200 | 200 | 156 | 625 |
| Potassium nitrite | 200 | 200 | 156 | 625 |
| Sodium nitrate | 700 | 700 | 1718 | 2187 |
| Potassium nitrate | 700 | 700 | 1718 | 2187 |

^{a}Limits are calculated by total formulation and brine weight for immersion cured, massaged, or pumped, and raw meat (green) weight for comminuted or dry cured products.
Adapted from USDA FSIS Directive 7620.3 [17]

### 1.2. Meat Curing Mechanism

The conversion of nitrate to nitrite to nitric oxide is the fundamental process that allows for meat to be cured. Since nitrite is the active component of a cure, which usually contains salt, sugar, and nitrate and/or nitrite, the method of introducing the nitrite into the meat determines the concentration of nitrite needed for efficient and rapid distribution [18]. Dry curing is direct contact of the cure on the meat surface. This method is less efficient and requires a longer time to become active. Using a brine by either immersion of product in the brine or direct injection via needles allows for quicker absorption and distribution throughout the meat. Based on the uniformity of brine distribution, the curing process should produce a characteristic pink, heat stable color throughout the product, a typical cured meat flavor through the direct or indirect retardation of oxidative rancidity, and a texture different from fresh meat [18]. In addition to the specialized texture and color of cured meat products, nitrite provides some preservation against spoilage organisms resulting in a long product shelf life. Under aerobic conditions, NO bound to hemoglobin will convert to methemoglobin, which will lead to the conversion of metmyoglobin (Mmb) if not controlled [19]. Nitric oxide reacts very quickly with oxymyoglobin (Omb) to form metmyoglobin and nitrate, while nitric oxide myoglobin (NO(II)Mb) reacts very slowly with oxygen to form metmyoglobin and nitrate. This autooxidation of NO(II)Mb is the result of slow dissociation, 02 binding, and subsequent dioxygenation of the released NO, producing a low-spin ferric Mb dihistidyl hemichrome [20].

### 1.3.1. Cured Meat Color Formation

Some meat color changes are undesirable. In fresh meat with undenatured myoglobin and oxymyoglobin, or reduced globin hemochromes of well-cooked meats that can result in a red or pink color when cooked [21]. In cured meats, the concentration, stability, or discoloration of the cured meat pigments or any cured color discoloration by nitroso-myoglobin and nitroso-hemochromagen can be measured to determine the rate of fading of cooked meat pigments if no influence from oxidative changes take place [22]. Extraction of cured meat color pigments by acetone can assess the conversion to cured meat pigment and the efficiency of this conversion. While the extraction process is efficient, there is concern that these pigments can be negatively impacted when exposed to light, resulting in fading or color changes. The exposure of cured meat to light and oxygen can be abated by handling and storage of samples and conducting testing in diminished light conditions. Initial formation of cured meat color starts with the oxidation of deoxymyoglobin to metmyoglobin, where nitrite is then reduced to nitric oxide to react with metmyoglobin [23]. From here, formation of nitrosylmetmyoglobin and rapid autoreduction to nitrosylmyoglobin or simultaneous NO coordination through autoreduction forms nitrosylmyoglobin shows a conversion by the presence of iron (II) nitrosylmyoglobin radical cation. This reaction when thermally processed then produces the stable denatured hemochrome, nitrosylmyochrome, and nitric oxide myoglobin to produce the nitrosylhemochromagen characteristic “cured pink” color.

Nitrosylmyoglobin when heated denatures the protein for detaches from the heme, where a second mole of nitrite is bound to the denatured protein necessary to form nitrosylhemochromagen [23].

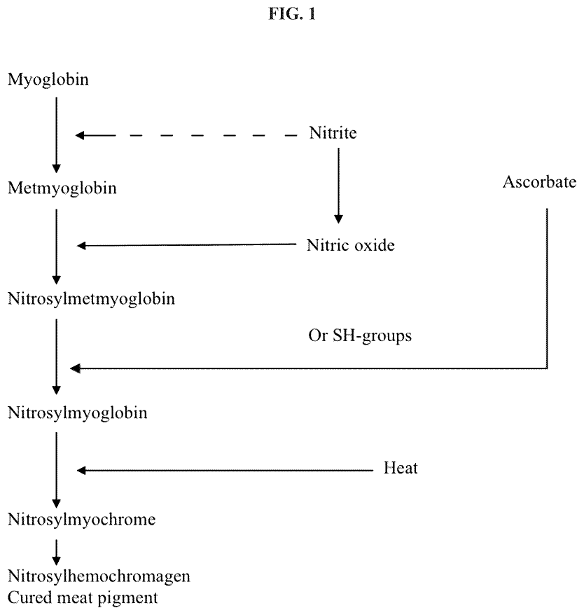

FIG. 1 shows cured meat color formation. The steps to form nitrosylhemochromagen (cured meat pigment) from myoglobin (fresh meat pigment). Ascorbate and SH-groups are included in this figure to indicate influence of color change reaction being accelerated or inhibited. The initial form of nitrite as nitrite or nitric oxide also influences the rate of color change reaction, Adapted from Small-Scale Sausage Production, 1985 [1].

### 1.3.2. Curing Accelerators

Compound requirements for a nitrite accelerant includes its ability to speed up the cure reaction to provide antimicrobial and antioxidant stability for increased cured meat product shelf life. Sodium ascorbate and sodium erythorbate can reduce the effects of dissociation and reduce metmyoglobin to allow for reduction to deoxymyoglobin [1]. Phenolic compounds, organic acids, and flavonoids are three major compounds that can be added as natural antimicrobial and antioxidants via cranberry and tomato extracts.

These organic acids and phenolic compounds naturally reduce product pH as well, creating acidic conditions that favor the conversion of nitrite to NO, resulting in an efficient curing process and reducing the amount of residual nitrite found in cooked products [24]. However, these natural accelerants may produce off flavors and colors at higher concentrations. Spice extracts from rosemary, thyme, sage, and garlic can play a dual role as an antibotulinal and carcinogen reducing agent when thermally processed. Reduction of carcinogenic compounds occurs through the reduction of heterocyclic aromatic amines in cured cook meat.

### 1.3.3. Residual Nitrite

Residual nitrite is defined as nitrite left in a product (roughly 10-20% of the originally added nitrite) after the curing process has been completed. It slowly recedes during the shelf life of the product until it is negligible or undetectable [25]. Residual nitrite is necessary to ensure a cured meat color stability is maintained through regeneration of cured meat pigment lost due to oxidation and light induced iron-nitric oxide dissociation [26]. Residual nitrite from cured meat products has decreased considerably in the past 20 years from 52.5 ppm in the 1970s to an average of 10 ppm in 1996 when tested from retail products that were not in the last week of their shelf life “sell by” date [27, 28].

Nitrite depletion occurs during the storage of cured meat products at a rate dependent on production formulation and pH, as well as the length of time and product temperature during processing and storage. The sulfhydryl-disulfide content in the meat plays an important role in the redox reactions when sulfhydryl groups are blocked by metallic ions and nitrite loss decreases [29, 30]. A correlation exists between low pH (results formation of S-nitroso cysteine) and nitroso-thiol content to maintain nitrite stability while decreasing total nitrogen content. When cured meat is subjected to thermal processing meat pH should be maintained from 5.5-6.0 using a stabilizer such as sodium erythorbate. This minimizes nitrite loss breakdown into intermediate nitroso-thiols, minimizing the formation of disulfides that can further increase the amount of lost nitrite [30].

### 1.3.4. Shelf Life Stability

Antimicrobial safety is an integral part of nitrite curing methods by either inhibiting or controlling growth of food spoilage and pathogenic bacteria. Improved bacterial shelf life against Staphylococcus aureus and Clostridium botulinum have been shown in cured meat products with the minimum ingoing nitrite levels at 50-60 ppm in conjunction with pH, salt concentration, reductants, and iron content [31]. The higher level of nitrite in most products is not for color development but for control of bacterial growth of C. botulinum and any toxin production, with levels higher than 70 ppm able to sustain a longer shelf life [32].

### 1.4. Health Concerns of Sodium Nitrite

The industry in the 1970s was able to eliminate most carcinogen concerns in cured meat consumption by eliminating the use of nitrate, reducing the levels of nitrite, and controlling manufacturing processes to better monitor any ingoing nitrite [8]. However, this does not negate the fact that most nitrate is ingested from the intake of food, especially vegetables, and ingestion of nitrite is mainly from nitrite by conversion of nitrate to nitrite from bacteria [8]. The most critical step in mammals for vasodilation is the synthesis of nitric oxide by nitric oxide synthase which catalyzes the oxidation of L-arginine to nitric oxide and L-citrulline [33]. However, since nitrate can convert to ammonia through reduction and oxidation processes, as well as reverse and/or form hydroxylamine and nitric oxide [32], the reduction and oxidation rates must be controlled with another substrate such as tetrahydrobiopterin or sodium erythorbate to be stable in a biological system or be used for an alternative curing system.

### 1.4.1. Nitrosamines and Carcinogenic Properties

Meat products cured with nitrite possesses a unique flavor profile and are less susceptible to the creation of off flavors due to lipid oxidation. The established red-pink color of cure meat from nitrite addition adds a threshold for consumer acceptance and desirability. Nitrite in connection with secondary amines were the focus for elimination in order to control nitrosamine formation, causing awareness of nitrite and secondary amines in cured meats caused initial public health hazard concerns by studies conducted in the early 1970s [8]. The most concern for nitrosamine formation comes with frying bacon since there are secondary amines present, nitrite is available for reaction, a near neutral pH, and a product temperature reaching above 130° C. This led to the regulations in 1978 reducing added nitrite in bacon from 200 to 125 ppm, the addition of sodium erythorbate or ascorbate at 550 ppm, and banned all nitrate addition during bacon processing. This regulation has led to present day levels of nitrosamine to be virtually eliminated in meat and poultry products [8]. Public controversy after four separate studies in 1979, 1980, 1981, and 1982 [34-36] showing that nitrite usage in regulated settings had no effect on increasing carcinogenic tumors were quelled, and further studies in the 1990s showed that any epidemiological studies associating risk of childhood leukemia [37-39] were weak and unwarranted with consumption of nitrite [40, 41]. There is also the argument that swallowing any saliva in combination with any food could be a result of potential formation of nitrosated compounds since most ingested nitrite is formed in saliva [8].

Nitrosamine formation in cured meats is a cause for concern, formed by the reaction of secondary or tertiary amines with a nitrosation agent such as nitrous anhydride from nitrite in an acidic aqueous solution [42]. Nitrosamines can cause DNA damage by the generation of nitric oxide which is an active nitrosating agent that can react with secondary amines in meat to form carcinogenic nitrosamines [27]. Drying processes and the application of heat used in the manufacturing of many cured meat products can aid in the formation of nitrosamines. However, nitrosamine formation can be inhibited by the addition of ascorbic acid, sulfur dioxide, and sodium erythorbate as part of the curing process to regulate the conversion of nitrite to nitric oxide. Bacon is the only cured meat that consistently contains some type of nitrosamine after cooking [18]. This is due to the presence of secondary amines, readily available nitrite, a near neutral pH found in most bacon, and the high cooking temperatures used to cook bacon, such as frying at a temperature of or exceeding 130° C.

N-nitrosamines are possibly formed during production and storage of cured meat products in volatile and non-volatile compounds. The volatile nitrosamine compounds are mostly carcinogenic and nonvolatile nitrosamines can be toxic or carcinogenic if decarboxylated into their carcinogenic counterparts [43]. With ingoing nitrite levels, meat quality, fat content, processing, maturation, and handling with storage, the levels of nitrosamine formation are hard to predict [43]. Increasing nitrite does increase most nitrosamine formation linearly but using erythorbic acid or ascorbyl palmitate can control most formations along with antioxidants and polyphosphates [44].

### 1.4.2. Replacing Nitrite

Direct replacement of nitrate and nitrite is the complete removal of nitrate and nitrite from a curing system [45]. Organic acid salts such a propionate, citrate, acetate, lactate, and pyruvate can inhibit C. botulinum growth but only as a secondary barrier and does not have any toxin reduction [46]. Sorbic acid and alkaline salts can control spoilage and inhibit C. botulinum spore outgrowth but can affect flavor [47]. Cured color development, spoilage due to lipid oxidation, pH, and residual nitrates and nitrites are all affected as well.

Indirect replacement of nitrate and nitrite is the process of removing some or all nitrate and nitrite from the curing system and replacing it with another source [48]. Starter cultures such as lactic acid bacteria can be used to produce colors similar to cured meat color thresholds. Naturally occurring nitrate is found in cabbage, lettuce, celery, spinach, beets, and radishes and are used to create juice or powdered concentrates to supply a source of nitrate/nitrite for curing in a non-traditional or alternative fashion [48].

The difficult challenge has been to identify an ingredient that provides the same functional benefits of nitrite without compromising food safety. Sorbic acid [47], short-chain alkynoic and organic acids [46], and cooked cured meat pigment [49] has been investigate but were not as effective as nitrite. Single ingredient alternatives may be able to replace a single functional attribute of nitrite. However, numerous scientific studies have not found a full replacement for nitrite that stabilizes cured meat color, produces desired cured meat flavor, prevents lipid oxidation, changes texture, and acts as a preservative in the same manner as nitrite [48].

### 1.4.3. Alternative Curing Methods

Vegetable juice powder (VJP) with starter cultures containing Staphylococcus carnosus have shown to be an effective replacement for nitrite [50]. However, no matter the replacement, there is still a need for a cure accelerant. Cherry and lemon powder can be utilized for cure accelerant and color stabilizers, but also can carry off flavors in higher concentrations. But as previously stated, these alternative ingredients do not possess all the functional attributes of nitrite. Often a higher concentration of these ingredients is necessary to attain desirable curing reactions, resulting in flavors or bitterness.

Additionally, since starter cultures are required to convert nitrate to nitrite, there is no accurate way to ascertain the exact amount of nitrite generated in the product [51]. Residual nitrite levels can be determined but at lower levels than sodium nitrite-cured products, resulting in less available residual nitrite to generate nitric oxide to maintain antimicrobial properties throughout the product's shelf life [50].

Bacteriocins are antimicrobial proteins or peptides produced by bacteria that can inhibit other bacteria [52]. These are considered safe and natural food preservatives, with nisin specifically used in heat processed food that increases sensitivity of spores to heat. As nisin offers the closest replacement efficiency to nitrite, it is considered to be a possible acceptable alternative to nitrite or at least an acceptable way to reduce nitrite levels without compromising on food safety [52]. Enterocins have also shown to reduce the number of Listeria innocua and Listeria monocytogenes during storage.

New technology has resulted in the development of pre-converted celery juice powder. The celery juice powder has undergone conversion of nitrate to nitrite and the nitrite concentrations have been standardized to a greater degree. Pre-converted celery juice powder removes the fermentation/conversion step for meat processors and is readily incorporated into formulas already established for conventional curing [10, 53]. Often the amount of ingoing nitrite (amount of pre-converted celery juice powder) is added at lower concentrations, which may result in lower curing efficiency and shelf life stability as shown in emulsified cooked sausages studied by Sindelar [50]. There has been no great variation between cured meat and total meat pigment between celery juice powder and sodium nitrite, or lower concentrations of 50 to 100 ppm when used in manufacturing turkey processed meat logs when tested by Redfield [10]. However, source and concentration did affect cured meat color perception, acceptability, and flavor when celery juice powder was used. Results of this study indicated that off flavors can be diminished and cure color is optimal when celery juice powder is added at lower concentration levels, making the alternative curing process not as effective as curing with sodium nitrite.

### 1.4.4. Regulations of Alternatively Cured Products

The USDA does permit the manufacturing of uncured versions of typical cured meats according to 9 CFR 319.2 [54], provided that the product is similar in size, flavor, consistency, and general appearance and labeled properly to display this process. There is also allowance for another category in natural, which is defined by 21 CFR 101.22 [55] to not contain any artificial flavor or flavoring, coloring ingredient, or chemical preservative, or any other artificial or synthetic ingredient, and the product and its ingredients are not more than minimally processed. By definition, technically natural and organic products are uncured, but with indirect addition of nitrate or nitrite that are allowed by the industry the products are still considered cured [51].

### 1.4.5. Sources and Health Benefits of Sodium Nitrite

Nitrite plays an important role in human health by synthesizing nitric oxide via the nitric oxide synthase (NOS) system to control blood pressure, blood flow in cardiac muscles, immune response, wound repair, and neurological functions [56]. Exogenous sources for nitrate are primarily from consumption plants and water, while endogenous nitrite consumption is mostly from the ingestion of saliva that naturally produces nitrite [57].

### 1.5. Nitric Oxide (NO) and the Nitric Oxide Synthase (NOS) System

### 1.5.1. IV.I Nitric Oxide Mechanisms

The basic conversion of nitrate to nitrite to nitric oxide is more commonly converted in the live system for use in vasodilation. Nitrate/nitrite is absorbed into the bloodstream and diverted to the lungs to be filtered to either form or decompose to nitric oxide. Nitric oxide (NO) is the product of the chemically equivalent guanidino nitrogens of L-arginine by the enzyme nitric oxide synthase (NOS) [58]. The major breakdown product of NO in aqueous solutions is nitrite. It is sparingly soluble in water with a half-life in aqueous solution at 3.8 to 6.2 seconds [59]. Nitric oxide is unstable and can easily convert to nitrogen and oxygen gas when in concentrated states. In aqueous solution the nitric oxide can revert to nitrite to stabilize, with a longer half-life as nitric oxide becomes more dilute [59]. The metabolic pathways of NO and N-oxides have a rapid loss of antioxidants in human plasma, specifically protein thiols. This causes the formation of S-nitrosothiol (RSNO), which does not allow NO to react directly with thiols. However, the nitrosonium side of NO that a possible storage area for NO can allow for direct reaction to thiols to bind. Cysteine by direct use is the lone thiol source in proteins that forms S-nitrosoprotein derivatives that have endothelium-derived relaxing properties and allows the plasma protein to become a reservoir for nitric oxide [33]. This cysteine source can overcome RSNO inhibition and allow for access to nitric oxide stores within the plasma protein.

### 1.5.2. NO Regulators and Inhibitors

S-nitrosothiols S-nitrosohemoglobin and S-nitrosoglutathione are NO products that regulate protein expression and function as well as act as sources for NO [12]. The creation can be produced by NOS and accept NO groups by nitrosylation in proteins, mainly storing in the mitochondria. This NO release from the S-nitrosothiols can act as a powerful vasodilator and survive with metal ion chelators and blood-like conditions for temperature and pH.

Deoxymyoglobin (Dmb) is a nitrite reductase that generates NO and is regulated by pH [60]. This helps with the regulation of mitochondrial function and reactive oxygen species production even at low oxygen concentration. Also, Dmb reduces nitrite to NO at a rate 36 times faster than deoxyhemoglobin in vitro [60]. As oxygen sensors hemoglobin and myoglobin shift from being NO scavengers to NO producers in hypoxia, this transition triggers a release of NO from the mitochondria. Deoxymyoglobin dependent nitrite reduction is able to produce NO, but with the use of metmyoglobin does not reduce nitrite [60]. As myoglobin deoxygenates, it is able to reduce nitrite to bioactive NO before mitochondria become oxygen limited. Thus, the NO formed from nitrite reduction can inhibit respiring mitochondria to conserve tissue oxygen [60].

### 1.5.3. Nitric Oxide Synthase (NOS) Isoforms

There are three different main NOS isoforms: Inducible (iNOS), endothelial (eNOS), and neuronal (nNOS). Inducible NOS (iNOS) is not found in cells unless induced by cytokines, microbes, or microbial products but nearly every tissue in the body can express this enzyme when stimulated. iNOS expression results in a sustained production of NO, which exerts both cytostatic/cytotoxic and cytoprotective actions in mammalian tissues and antimicrobial activity toward certain pathogens [58]. The iNOS isoenzyme overall is not regulated by Ca² or calmodulin once it is expressed, meaning arginine has more chance of transport and reaction [3]. If it is possible to keep this system intact after rigor, the enzymatic production of nitric oxide can be stabilized. The inducing of iNOS expression like in macrophages has been shown to increase L-arginine transport [61], but when in vivo must compete with the same transport system used by L-lysine and L-orthinine that can alter cellular NO synthesis rates [61, 62].

The blood vessel wall NO is mainly produced from L-arginine by endothelial NOS (eNOS) [12]. eNOS is specifically located in the endothelial cells within the vascular system. Various cofactors such as tetrahydrobiopterin (BHu₄), flavin adenine dinucleotide and flavin mononucleotide, calmodulin, and iron haeme help the monomer isoforms bind and catalyze NO production through generation of 02 [63, 64]. Agonists such as acetylcholine, bradykinin, and histamine increase the concentration of calcium that binds to calmodulin and bypasses the inhibitor site Thr495 to generate NO [12].

Interestingly, it has been shown that purified constitutive, endothelial NO— synthase (ecNOS) forms simultaneously NO and O₂⁻, the ratio of both depending on the concentration of the ecNOS substrate L-arginine and the redox conditions of the cofactors [65]. ecNOS and mitochondria are co-located suggesting that there is a mitochondrial NOS (mtNOS) that converts L-arginine to L-citrulline conversion within the mitochondria and is prevalent in skeletal muscle [66]. NO can interact with other heme-containing proteins like cytochrome c oxidase or iron-sulfur clusters related to the respiratory chain and promotes enzyme inhibition [67]. NO competes with cytochrome c oxidase for binding at the O₂ site within the cell that decreases O₂ consumption and ATP formation, allowing for continual function at low O₂ concentrations with little energy [68]. The isoform neuronal NOS (nNOS) is the most prevalent form in the skeletal muscle due to its contact with the central and peripheral nervous systems [69]. nNOS is expressed in the surface membranes that surrounds the sarcoplasmic reticulum and increases in expression when induced by chronic hypoxia [70].

### 1.5.4. NOS in Different Cells

Nitric oxide synthesis by eNOS and iNOS plays a crucial role in macrophage antimicrobial activity. The production of reactive nitrogen intermediates through macrophages has even been shown to inhibit the replication of tumor cells while slowing the nitrosamine metabolism in carcinogenesis [71]. This can only be done by the conversion of L-arginine to nitrite and L-citrulline without the loss of the guanidino carbon [72]. There is evidence that macrophages can generate broadly cytotoxic molecules from the guanidine molecule of L-arginine and form nitrite and nitrate [71]. However, there are no specific microbial targets that can be inhibited by macrophages, suggesting that although they have nitrite capabilities, there must be no interference in order for L-arginine to be used in a macrophage biosynthetic pathway [72]. Also, there is not significant evidence that reactive nitrogen intermediates (RNIs) are found within human mononuclear phagocytes that have antimicrobial properties [73].

Mitochondria of cardiomyocytes are the primary focus of diffusion and NO binds to myoglobin for breakdown by reactive oxygen species for the function of vasodilation [74]. The different kinetics of the reaction of NO with the oxygen-derived radicals superoxide anion (O₂⁻), hydrogen peroxide (H₂O₂) and hydroxyl radical (HO⁻) has been shown that all three compounds are produced by cells from mammalian species, especially from the endothelial cells and macrophages, both of which also capable of synthesizing NO [59]. The accumulation of NO from typical nitrite concentrations found in biological tissues rises about 100-fold when the pH falls from 7.4 to 5.5 [75]. Enzyme independent NO (without any isoform of NOS) occurs through conversion of nitrate to nitrite in the mouth by anaerobic bacteria, in the very acidic conditions in the lumen of the stomach, and in biological tissues undergoing intracellular acidosis [75].

### 1.5.5. Nitrite in Metabolism and NOS Activity

Concentrations of nitrite are found stored in micromolar levels in vascular and muscle tissues (1-20 micromolar) and mostly derived from the oxidation of NO Synthase (NOS)-generated NO [76]. In vascular and muscle tissues, the monomeric hemoglobins, myoglobin (Mb) and neuroglobin (Ngb), catalyze NO₂⁻ reduction by the same reaction as hemoglobin through hypoxic vasodilation in allosteric structural transition of the protein from relaxed to tense state [77]. However, the muscle tissues react at lower oxygen tensions (p50 Mb1/42.4 mmHg; p50 Ngb1/42.2 mmHg) [76]. Mb-dependent NO₂⁻ reduction has been implicated in the protective effects of NO₂⁻ after ischemia/reperfusion (I/R) in the heart as well as in vasodilation [76, 78, 79]. Nitrite reduction specifically controlled by the mitochondrial electron transport chain (ETC) has been shown to occur in near anoxic conditions [80]. The best conditions for reaction occur at pH less than 7 and with relatively high (millimolar) concentrations of nitrite. Nitrite regulates mitochondrial function by modifying specific proteins in the mitochondria and inhibits reactive oxygen species (ROS) generation that creates nitrite dependent S-nitrosation [81]. These paths create a NO-dependent inhibition of mitochondrial oxygen consumption, even when oxygen tension is decreased and can stimulate hypoxic mitochondrial biogenesis [82] Myoglobin can be used as a functional nitrite reductase that regulate the cellular response to hypoxia [83]. It is similar to the resting state of hemoglobin but reduces nitrite almost 60 times faster than T-state hemoglobin due to the low heme redox potential found in myoglobin that does not have an allosteric state [76].

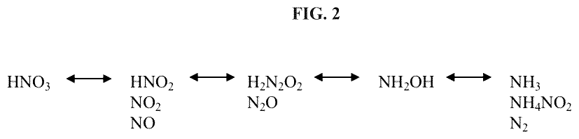

Nitrite is more inhibitory under acidic conditions as part of the biochemical oxidation-reduction chain that allows for nitrite to be reversible and have multiple intermediate compounds as demonstrated in FIG. 2. Hydroxylamine and nitric oxide do possess anti-microbial properties, but not as high or in varying conditions as nitrite [2].

FIG. 2 shows variable conditions of nitrite with intermediate compounds depending on stability and state. Nitric acid (HNO₃) can convert to nitrous acid (HNO₂), nitrite (NO₂), or nitric oxide (NO) and back to nitric acid. These forms can convert to hyponitrous acid (H₂N₂O₂) or nitrous oxide (N₂O) and back. These states can convert to hydroxylamine (NH₂OH) and back, then to ammonia (NH₃), ammonium nitrite (NH₄NO₂), or dinitrogen gas (N₂). Adapted from Proceedings of the International Symposium on Nitrite in Meat Products, September 1973 [2].

Nitrite is the primary oxidative product of NO derived from the conversion of L-arginine to NO by the purified enzyme ecNOS [84]. N-labeled L-arginine has demonstrated that almost all circulating nitrite is mainly derived from the L-arginine-NO pathway and in smaller proportions from the NO-related adducts peroxynitrite or RSNO. Since L-arginine is the only physiological nitrogen donor for the NOS-catalyzed reaction [12, 58], the need for increased uptake and synthesis of L-arginine is imperative to generate higher NO concentrations.

### 1.6. L-Arginine in NO Generation and Metabolism

### 1.6.1. L-Arginine and the Nitric Oxide Synthase (NOS) System

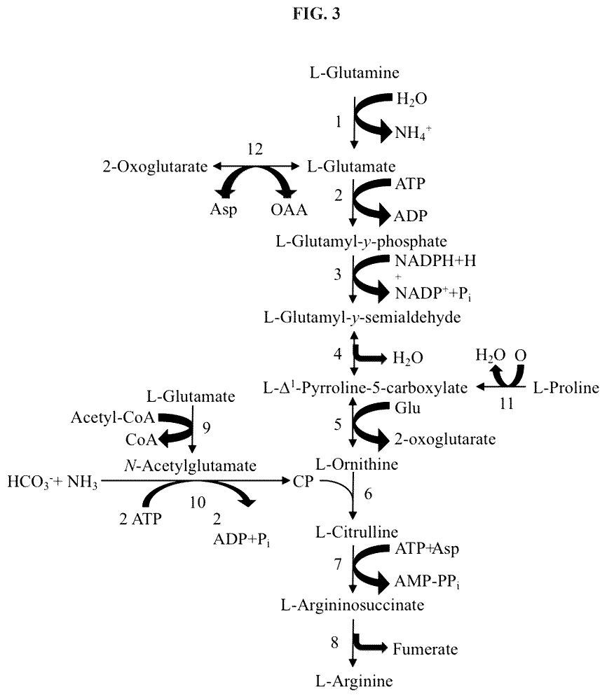

L-Arginine is a conditionally essential amino acid in adult humans and other animals and in the synthesis of creatine, the precursor for mammalian nitrite/nitrate synthesis, and the generation of nitric oxide through the nitric oxide synthase (NOS) system [3]. Many cells utilize nitric oxide for vasodilation, immune responses, neurotransmission, and adhesion of platelets and leucocytes [3]. Arginine has multiple pathways for synthesis, such as L-citrulline cyclic regeneration by glutamine/glutamate, and the cell signaling molecules of nitric oxide, glutamate, and agmatine use the regulate key cellular processes (FIG. 3).

FIG. 3 shows the Arginine Synthesis Pathways. The main metabolic pathway for arginine synthesis in mammals is done through P5C synthetase and proline oxidase. Reactions occur by a chemical equilibrium favoring P5C formation that is a bifunctional polypeptide. Reactions 1-6 and 9-11 take place in mitochondria, reactions 7 and 8 in the cytosol, and reaction 12 can occur in both. Abbreviations: OAA, oxaloacetate; CP, carbamoyl phosphate. Adapted from Wu and Morris; Arginine metabolism; nitric oxide and beyond [3].

### 1.6.2. Components of Arginine Synthesis

L-citrulline is responsible for most of the endogenous synthesis of arginine in adult humans by generation from glutamine or glutamate. The L-citrulline aids in circulating arginine to other proteins, assisting in storage in other systems beyond the small intestine, liver, and kidneys [3]. The highest rates of arginine synthesis occur within the hepatic urea cycle and directly correlate to NO synthesis [3].

Argininosuccinate synthase (ASS) acts as a rate-controlling enzyme in L-arginine biosynthesis when iNOS is initiated, which regulates the L-arginine recycling pathway which in turn regulates iNOS synthesis [3]. L-glutamine and hypoxia inhibit L-arginine synthesis in NO producing cells, but can be countered if ASS activity is not hindered [85]. The most important mechanism for arginine uptake in most cell types is system y+, which is a high-affinity, Na+-independent transporter of arginine, lysine and ornithine [3]. Regulation of system y⁺ presents a problem in the modulation of cellular L-arginine metabolism represented by the competing L-lysine, L-ornithine, canavanine, and NOS inhibitors N^{G}-monomethyl-L-arginine and N^{G}-iminoethyl-L-ornithine as shown in studies by Schmidt and Bogle [86-89]. However, system y⁺ has been shown to co-induce with iNOS in most cell types allowing for L-arginine to flow in transport to promote the influx of NO synthesis to the induced cell [86, 90, 91]. Arginase can also be used as a regulatory enzyme for arginine availability, competing with iNOS for arginine and can only be inhibited by N^{G}-hydroxyarginine if it is produced from iNOS and not oxidized to citrulline and NO [3, 92].

### 1.6.3. L-arginine and L-citrulline

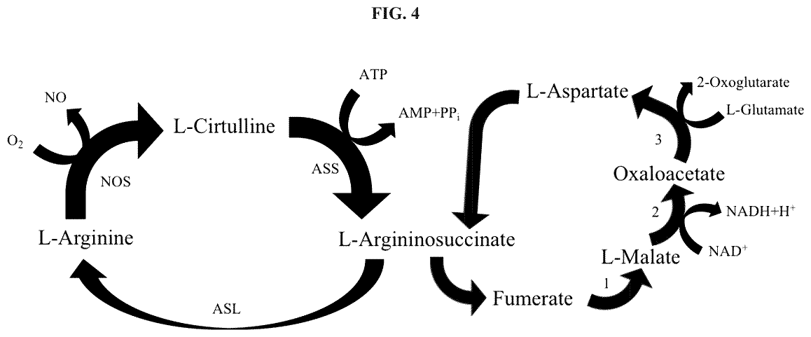

With the supplementation of L-citrulline in combination with L-arginine, there is a way to promote the L-citrulline-to-L-arginine recycling pathway to sustain localized L-arginine availability for eNOS-catalyzed NO production [93]. L-citrulline used as a precursor for L-arginine is an effective supplement to inhibit arginase and increase L-arginine plasma levels while simultaneously increasing plasma NOx and cGMP. NO synthesis occurs in mostly all cell types through the arginine biosynthetic pathway and recycles citrulline to arginine by the arginine/citrulline cycle that can be looped in with the citric acid cycle as shown in FIG. 4 [3, 4].

FIG. 4 shows the citrulline/NO Cycle. This particular cycle can be couple to the citric acid cycle (right). Fumerate produced in the cytosol then enters the citric acid cycle in the mitochondrion to convert into oxaloacetate. Enzymes to catalyze 1-3 reactions occur with fumarase, malate dehydrogenase and aspartate aminotransferase. The reactions are reversible but the diagram only shows the unidirectional flow in NO-producing cells. Adapted from Nussler et al. [4] and Wu and Morris; Arginine metabolism: nitric oxide and beyond [3].

### 1.7. I.VII NO in Muscle to Meat Conversion

There is little or no medical research investigating the NOS systems and the effect of NO in muscles after death to determine if the NOS system is still functional during the conversion of muscle to meat, or its viability post-rigor muscle.

Hypoxic/ischemia conditions that trigger NOS and NO production in the mammalian cell also occur in postmortem muscles. Modulation of NO level in pre-slaughter and post-slaughter muscle cells using NO donors and NOS inhibitors are reported to affect the meat quality attributes of tenderness, water holding capacity and color in a variety of animal species including beef, lamb, pork and chicken [94]. The combination of NO and protein S-nitrosylation is thought to be regulatory in postmortem aging and the development of meat quality, particularly affecting the myofibrillar proteins [95]. Myofibrillar proteins have been shown to be endogenously S-nitrosylated in skeletal muscle with a high reactivity to S-nitrosoglutathione (GSNO) [5, 96].

### 1.7.1. Effects of NO on Meat Quality

Degradation of myofibrillar proteins during aging affects overall meat tenderness and is mainly caused by protease calpain-1. Since NOS can inhibit calpain-1 from proteolysis by modification and protein S-nitrosylation affects proteolysis by calpain-1 in myofibrillar proteins, there is a concern on the potential impact on meat quality.

Increasing the levels of S-nitrosoglutathione (GSNO) modifies myofibrillar proteins by decreasing their thiol content while accumulating S-nitrosylated protein [97]. There is some evidence that the accumulation of S-nitrosylated protein by NO results in the unfolding of the tertiary structure of myofibrillar proteins allowing more degradation by calpain-1 to occur. In a study by Cook et al. [94] in bull longissimus lumborum muscles, there was an effect on tenderness early on, tenderizing meat faster in the NO enhanced samples than the NO inhibited samples and slowly decreasing by the end of ageing at Day 8 after being measured at Day 1, 3, 6, and 8. Free radical activity is much higher immediately after slaughter, showing higher NO concentrations and effects calcium levels as well to activate proteolytic enzymes [94].

### 1.7.2. Measuring NO and NOS Levels

Measuring NO is difficult due to its short half-life, but can be monitored when bonded to metal chelates measured by electron paramagnetic resonance (EPR) or the binding to intrinsic metallo-heme centers within the tissue such as myoglobin contained in muscle tissue [75]. Measuring nitrosyl-heme formation by spectrophotometry will indicate if NO formation has occurred and its concentration within muscle samples.

Concentrations of nitrite measured can indicate nitrite-mediated NO formation formed from ischemia from vascular occlusion [98]. Measurement by this residual nitrite is dependent on pH directly correlating with increased reduction caused by acidosis.

### 1.7.3. NOS System Potential in Pre- and Post-Rigor Meat

NOS is mainly concentrated in fast twitch fibers, making it readily available for access in post rigor relaxation of muscle and more prone to stress effects pre-slaughter [99]. Low concentrations of NO when exposed to superoxides can inactivate NO in uncontracted skeletal muscles, while higher concentrations of both superoxides and NO can form peryoxynitrite that decomposes to extremely reactive free radicals with fiber breakdown capability [94].

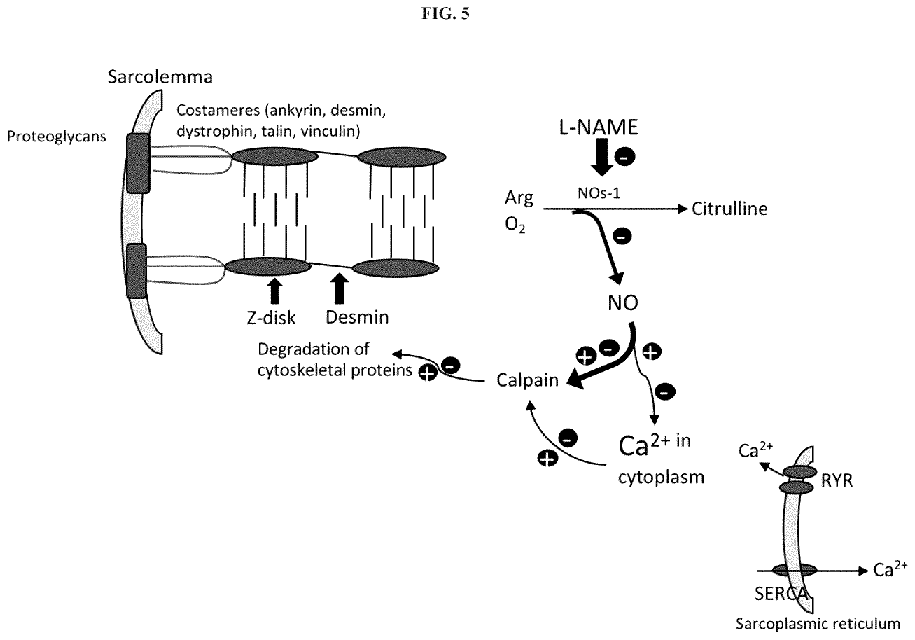

The idea that “stress” physiology of any animal perimortem would be important in determining quality through effects on ultimate pH, muscle glycogen and the dark-cutting condition but also through independent mechanisms [5]. Not only does NO affect calcium uptake, but also its release from the sarcoplasmic reticulum that which affects meat tenderness [6]. FIG. 5 demonstrates the positive and negative effects on protein degradation by calcium fluctuation.

FIG. 5 shows the effects of NO on meat tenderness. Mechanism in sarcolemma and sarcoplasmic reticulum to demonstrate negative effects of NO on meat tenderness by concentration of calcium and negative feedback on calpain activation. L-NAME (NOS inhibitor) positively influences meat tenderness in a counter reaction by removing negative feedback on calcium concentration in the cell and activates calpain. Adapted from Warner et al., Effects of nitric oxide and oxidation in vivo and postmortem on meat tenderness from modified Harper [5, 6].

Muscle redox state in vivo is regulated by NO, which can serve as an antioxidant or combine with other free radicals that also react quickly with lipid membranes. NOS activity is increased during contraction by various stimulation protocols and exercise [67]. In a study by Melody et al., [100] psoas major, longissimus dorsi, and semimembranosus muscles were taken from pigs sampled at 30 min, 45 min, 1 h, 6 hr, 12 h, and 24 h. The semimembranosus muscle in pigs had higher levels of calpastatin activity and NOS regulation of calpain activity, affecting shear force and tenderness postmortem [100].

### 1.8. Literature Summary

Sodium nitrite has been used for many years as a safe way to cure meat products for a longer shelf life and antimicrobial properties in food storage. The cured “pink” color is characteristic throughout cure meat products and an appealing texture and color to consumers. The myoglobin pigment complexing with nitrite or nitric oxide and protein being denatured by heat and combining with nitrite to forms the desired cured color pigment nitroso-hemochromagen. Although current curing methods with sodium nitrite are efficient and safe, the recent concerns of carcinogenic compounds (i.e. nitrosamines) [8, 9] that can be formed in cured meat products has pushed the meats industry to develop alternative curing methods by indirect nitrite sources coupled with antimicrobial compounds and color stabilizing ingredients. However, multiple studies have shown these methods to be less efficient as sodium nitrite and produce less than desirable organoleptic properties.

Focusing on the Nitric Oxide Synthase (NOS) system that is involved within the muscle that uses L-arginine to convert nitrite to nitric oxide can correlate to the same form of nitric oxide used to cure meat products. The NOS system is found in most tissues within the body and is found in inducible NOS (iNOS) forms when said tissues are exposed to hypoxia or ischemia/reperfusion. Other forms such as neuronal NOS(nNOS) that signals contraction and relaxation of nitric oxide within the nervous system and sarcoplasmic reticulum, endothelial NOS (eNOS) within blood vessel walls in vasculature, and constitutive endothelial NOS (ecNOS) that co-localizes with mitochondrial NOS (mtMOS) within tissue mitochondria and skeletal muscle can also be activated by L-arginine to produce nitric oxide with antimicrobial functions and storage of nitric oxide capabilities. Due to nitric oxide having a short half-life, the NOS system is harder to measure for efficiency in producing nitric oxide by arginine activation.

Arginine is an essential amino acid and is mostly synthesized by citrulline that can be found in most tissues with the ability to generate nitric oxide in a biosynthetic pathway that can recycle through the citrulline/NO cycle with the citric acid cycle.

With little research into the activation of the NOS system in muscles after death, the only meat based studies have focused on the effects of nitric oxide on meat quality by the inhibition or promotion of calpains, stress physiology, and calpastatin activity [5, 94, 95, 100].

The objective of the present invention was to investigate the efficacy of an essential amino acid L-arginine as a component of the Nitric Oxide Synthase (NOS) system as an alternative curing system for pork muscle and evaluate the cure reaction efficiency of the amino acid as an alternative curing system.

### Materials and Methods

### 2.1. Experimental Design

Pre-rigor pork Semimembranosus muscle samples were collected from four pre-rigor pork carcasses (n=4) harvested at the Rosenthal Meat Science and Technology Center at Texas A&M University at six separate times over a four day period (N=24). Muscle samples were treated with five concentrations of L-arginine, using water as the control treatment. Samples were either subjected to heat treatment (water bath increasing to 62° C for 60 min) or left raw/fresh (uncooked). All treated muscle samples were analyzed for residual nitrite, and cooked samples were analyzed for nitrosylhemochromagen levels to determine curing efficiency.

The overall experiment was designed as a 6 (5 L-arginine concentrations plus a control) by 4 (pork carcasses) by 2 (heating treatment (raw and cooked)) factorial replicated 6 times (collection) (N=288).

### 2.2. Reagent Preparation

### 2.2.1. Immersion/Stabilization Phase

Solutions were prepared according to Wu to stabilize the muscle samples for enclosed reactions within the 50 mL conical tubes. Each 50 mL conical tube contained for the first immersion and stabilization phase contained 0.9% sodium chloride (NaCl) (granular USP, FCC, Avantor-Macron Fine Chemicals) and 576 ppm sodium erythorbate (NaE) (FCC, Spectrum Chemical), in 8 mL deionized water was prepared. The NaCl was used to stabilize any reaction and the NaE was used to accelerate any cure reaction that could occur. The L-arginine was prepared separately so as to be administered in specific concentration once the five grams of meat was added to the reaction tubes by creating dilutions of millimolar concentrations at 0 mM, 2 mM, 4 mM, 8 mM, 16 mM, and 32 mM.

### 2.3. Sample Collection, Preparation, and Treatment

Pre-rigor semimembranosus muscles were collected from four pork carcasses (left side of each carcass) at six different harvest times across four days approximately one hour after exsanguination. The semimembranosus muscle was selected in this study due to its myoglobin and mitochondria content contained in lean skeletal muscle, proving assurance of the presence of the nitric oxide synthase (NOS) system that generates nitric oxide if it remains viable. Samples were aseptically excised (60-75 g) from the left and right side of the semimembranosus muscle, using the aitch bone as the reference point. The muscle samples were transported to the research lab are within the Rosenthal Meat Science Center and any excess connective tissue and fat was removed.

### 2.4. Treatment of Pre-Rigor Pork Semimembranosus Muscles

### 2.4.1. Raw Muscle Samples

The procedures for determining the following sample reactions followed the procedures outlined by Wu [101]24 5 g muscle samples were individually placed into 50 mL conical tubes. A total of 24 5 g samples were placed, with 6 tubes for each carcass muscle sample. Each tube received 8 mL of the 0.9% NaCl and 576 ppm sodium erythorbate solution. Next 2 mL of the deionized, distilled water (control), or one of the five L-arginine was added. The L-arginine solution was used to activate the NOS system to generate NO and residual nitrite [101].

After two hours of immersion, the samples were reweighed to determine the percent solution pickup and subsequently transferred to new 50 mL centrifuge conical tubes containing 25 mL 0.9% NaCl solution to stabilize and cease any further reactions. Raw (unheated) samples were homogenized immediately for 30 sec at 7000 rpm (Kinematica Polytron Pt-10-35 GT Homogenizer, Kinematica Inc, Bohemia, NY).

Samples were centrifuged at 4500×g for ten minutes at 4° C until the supernatant was clear. (Avanti J-25 Centrifuge with JA 17 Rotor, Beckman Coulter Inc., Atlanta, GA). The supernatant was removed by pipetting 10 mL and transferring the supernatant into a 15 mL centrifuge tube. The supernatant was then tested for pH before being stored at −30° C.

### 2.4.2. Cooked Muscle Samples

Muscle samples subjected to heating followed the same protocol as described for raw (unheated) samples except the sample tubes were placed in a water bath and cooked from 27° C to 62° C internal temperature within one hour to simulate a hot dog cook cycle. Temperature was monitored using a thermocouple probe (HH501BT Type T Thermometer, Omega Engineering Inc., Norwalk, CT) All cooked samples were weighed for weight pickup and then subjected to the same procedures as the raw samples except that both the supernatant and residual pellet of cooked meat samples were subjected to cure efficiency testing later.

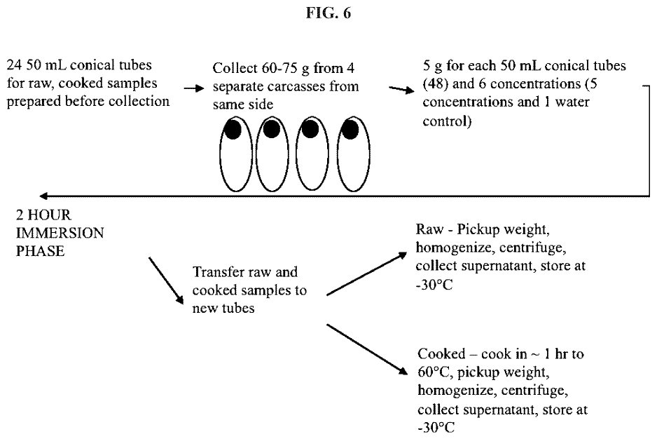

FIG. 6 shows the procedure flow. The procedure applied to six collection times over a four day period to separate treatments for reps. Due to the sensitivity of pre-rigor meat, the samples were collected, treated with L-arginine concentrations, stabilized, and frozen all in the same day.

### 2.5. pH Assessment

Initial pre-rigor muscle sample pH (approximately one hour after exsanguination) of the muscle sample before muscles were dissected into 5 g samples for analysis (5-7 minutes after excision from carcass) were taken via a handheld pH probe. Supernatant were used to determine pH with a glass probe (probe placed into tube directly to not dilute sample further since samples were already diluted by the deionized water). pH of raw and cooked samples were determined using a benchtop pH meter (VWR Symphony 810, VWR International) with a glass probe (VWR Symphony Red Tip Reference Probe, VWR International Radnor, PA) and benchtop pH meter.

### 2.6. Proximate Composition Assessment

Samples of untreated pre-rigor meat were comminuted and then subjected to liquid nitrogen freezing and then powdered using a Waring blender (Model 33BL79, Waring Commercial, New Hartford, CT) to determine moisture (AOAC 985.14 oven drying method) and protein (AOAC 992.15) using a nitrogen analyzer (F528, Leco Corp., St. Joseph, MI). Fat content was determined by subtracting moisture and protein from 100% (AOAC 2005, AOAC 2019).

### 2.7. Residual Nitrite Assessment

The supernatant for raw and cooked samples were tested for residual nitrite after deproteinization by sample preparation for amino acid analysis by HPLC [102]. Determination of nitrite (UV/VIS Spectrophotometric Method) was used to detect any residual nitrite for best results in detecting minute amounts of nitrite from an enclosed system [102].

### 2.8. Cure Efficiency Assessment

Cooked meat samples were subjected to analysis to determine the degree of nitrosylation of residual nitrite, the procedure set forth by Pearson and Tauber (Pearson and Tauber, 1984) from Hornsey's [22] procedure for analyzing small samples was used [103] to analyze sample supernatant and pellet. 2 mL or 2 g of the samples were treated with acetone to measure NO-heme concentration and separately 2 mL or 2 g of the samples were treated with acetone and hydrochloric acid to measure total heme concentration in a 1 cm quartz cuvette. NO-heme concentration (ppm acid hematin) was determined using a spectrophotometer (2100 Series Spectrophotometer, Unico, Dayton, NJ) by reading samples at 540 nm. Total heme concentration (ppm acid hematin) was determined at 640 nm determined nitrosylation, which indicated how well varying concentrations of L-arginine affected the NOS system's ability to cure, known as cure efficiency. This procedure measured how much myoglobin was converted to nitroso-hemochromagen, the cured meat color, and the level of conversion compared to all pigmentation within the sample.

### 2.9. Statistical Analysis

Data was analyzed by iMP software for Least Square Means and ANOVA with P=0.05 to determine significant main effects (arginine concentration, nitrosylation).

Least squares means were calculated to determine significant main effects, and significant differences were determined by Tukey's HSD with P<0.05. Analyses for the samples were replicated three times. The experiment was replicated three times. Sample analyses were conducted in triplicate.

### Results and Discussion

### 3.1. Proximate Composition and pH

Initial muscle sample pH (Table 2) was slightly lower than sample pH after the immersion phase (5.87) but was not significantly different (5.83-6.05). The increase in muscle sample pH was due to the partially alkaline of L-arginine, which under physiological conditions can vary from a pH of 7.2 to 8.2 [104]. Moisture (72.29%), protein (20.13%), and fat (1.23%) contents for untreated muscle samples were consistent across all replications (Table 2). Initial pH values were important to determine a baseline between all carcasses to ensure there were no outliers or carcasses that would skew end pH values. End pH values were important to determine any effects L-arginine could have on the samples that would affect color change or stability.

Percent sample weight pickup was determined after two hours of immersion in the L-arginine, sodium erythorbate, and NaCl for raw (unheated) samples. Percent for cooked samples was determined after two hours of immersion and after one hour of cooking to an internal temperature of 62° C and cooling to room temperature. The pickup percentages (Table 2) across all treatments (0 mM-32 mM) were not significantly different between L-arginine concentrations or heat treatment (raw and cooked) (24.38-28.09%). The importance of sample pickup was to determine the intake of L-arginine for a better immersion and reaction phase to activate the NOS system.

TABLE 2
Least Squares Means of Proximate Composition, Initial
pH of Carcass Samples, and Percent Solution Pickup of
Raw and Cooked Pre-rigor Semimembranosus Pork Muscles

Treatment

| Variable | Carcass | Raw | Cooked | SEM¹ |
|---|---|---|---|---|
| n | 24 | 96 | 96 | |
| Proximate | | | | |
| Composition | | | | |
| Moisture, % | 72.29 | | | 1.54 |
| Protein, % | 20.13 | | | 1.79 |
| Fat, % | 7.58 | | | 1.23 |
| Initial pH | 5.87 | | | |
| SEM¹ | 0.05 | | | |
| pH after 2 hours of | | | | |
| sample immersion | | | | |
| 0 mM | | 5.83^{a} | 5.88^{a} | |
| 2 mM | | 5.84^{a} | 5.88^{a} | |
| 4 mM | | 5.85^{a} | 5.86^{a} | |
| 8 mM | | 5.83^{a} | 5.87^{a} | |
| 16 mM | | 5.88^{a} | 5.94^{a} | |
| 32 mM | | 6.01^{a} | 6.05^{a} | |
| SEM¹ | | 0.05 | 0.05 | |
| Sample Pickup, % | | | | |
| 0 mM | | 25.16^{a} | 24.38^{a} | |
| 2 mM | | 26.57^{a} | 25.68^{a} | |
| 4 mM | | 26.89^{a} | 25.00^{a} | |
| 8 mM | | 26.84^{a} | 25.68^{a} | |
| 16 mM | | 28.09^{a} | 25.86^{a} | |
| 32 mM | | 27.25^{a} | 27.09^{a} | |
| SEM¹ | | 1.38 | 1.24 | |

¹SEM: Standard error of the mean (largest) of the least squares means
^{ab}LSMeans within a column with different superscripts are significantly different (P < 0.05)

### 3.2. Residual Nitrite Values for Supernatant (Raw and Cooked) and Pellet (Cooked) Samples

Residual nitrite was determined using the modified AOAC Official Method 973.31 (Nitrite Analysis in Cured Meats Procedure) and was verified by Wu [101, 102, 105] with sample (plasma or serum) preparation for amino acid analysis by HPLC and determination of nitrite (UV/VIS Spectrophotometric Method) [102]. This procedure was used to determine any residual nitrite found in samples. All samples were tested three weeks after being held in a −30° C freezer then thawed in a 0° C cooler.

Residual nitrite means (Table 3) of raw muscle sample supernatant show that the 32 mM L-arginine treatment resulted in higher residual nitrite levels (14.34 ppm) than the control (0.08 ppm). The 4 mM (8.00 ppm), 8 mM (9.66 ppm), 16 mM (9.23 ppm) L-arginine treatments were significantly different than the control or the 32 mM treatment, but were not different among the three L-arginine concentrations. The residual nitrite range generated by the NOS system at each L-arginine concentration is shown in Table 3 and indicates the variability of the NOS system in generation residual nitrite through the addition of varying concentrations of L-arginine.

The wide variation in residual nitrite at each L-arginine concentration tested may be due to length of storage, which resulted in pigment fading and nitrite converting to nitric oxide (a gas), as evidenced by previous studies done by Cassens et al. [15, 27, 28] and Keeton et al. [25] that showed a loss of 70 to 80% nitrite during storage and would not be measured as residual nitrite but later measured as nitroso-hemochromagen. The samples are better tested when freshly converted and not stored, allowing 50 to 70% nitrite to be analyzed in the product after it is formulated [18].

TABLE 3
Least Squares Means for Residual Nitrite of
Raw Pre-rigor Semimembranosus Muscles Supernatant
Generated by the Nitric Oxide Synthase System
at Various L-Arginine Concentrations

| | Residual Nitrite | Range of Residual Nitrite |
|---|---|---|
| Concentration | (ppm)¹ | (ppm) |
| n | 144 | |
| 0 mM | 0.08^{b} | 0, 0.69 |
| 2 mM | 4.53^{b} | 0, 20.22 |
| 4 mM | 8.00^{ab} | 0, 33.48 |
| 8 mM | 9.66^{ab} | 0, 21.62 |
| 16 mM | 9.23^{ab} | 0, 28.95 |
| 32 mM | 14.34^{a} | 0, 66.61 |
| SEM² | 2.37 | |

¹ppm = absorbance level × standard curve slope (1.7438) × dilution factor (200),
^{ab}LSMeans within a column with different superscripts are significantly different (P < 0.05)
²SEM: Standard error of the mean (largest) of the least squares means

Residual nitrite means of the supernatant of cooked muscle samples are reported in Table 4. The 4 mM treatment was significantly higher for residual nitrite (8.79 ppm) compared to the other treatments and the control (0.07 ppm). The remaining L-arginine treatments were also different from the control. The 2 mM (5.81 ppm), 8 mM (5.85 ppm), 16 mM (3.19 ppm), and 32 mM (7.86 ppm) concentrations, however, were not significantly different between each other.

The lower residual nitrite values for cooked meat supernatant compared to raw supernatant samples (32 mM cooked—7.86 ppm versus 32 mM—14.34 ppm) may be attributed to both heating and perhaps length of frozen storage prior to analysis. It has been reported that thermal processing can result in a 20 to 80% loss of nitrite [18], therefore the amount of residual nitrite in cooked meat samples would be expected to be lower than the raw samples tested.

TABLE 4
Least Squares Means for Residual Nitrite of Cooked Pre-rigor
Semimembranosus Muscles Supernatant Generated by the Nitric
Oxide Synthase System at Various L-Arginine Concentrations

| | Residual Nitrite | Range of Residual Nitrite |
|---|---|---|
| Concentration | (ppm)¹ | (ppm) |
| n | 144 | |
| 0 mM | 0.07^{b} | 0, 1.05 |
| 2 mM | 5.81^{ab} | 0, 13.24 |
| 4 mM | 8.79^{a} | 0, 38.36 |
| 8 mM | 5.85^{ab} | 0, 20.93 |
| 16 mM | 3.19^{ab} | 0, 11.51 |
| 32 mM | 7.86^{ab} | 0, 18.48 |
| SEM² | 1.93 | |

¹ppm = absorbance level × standard curve slope (1.7438) × dilution factor (200),
^{ab}LSMeans within a column with different superscripts are significantly different (P < 0.05)
²SEM: Standard error of the mean (largest) of the least squares means

Residual nitrite values of cooked muscle pellet samples are reported in Table 5. The 32 mM treatment was significantly higher for residual nitrite (15.69 ppm) compared to the other treatments and the control (0.04 ppm). The remaining L-arginine treatments were also different than the control. The 2 mM (10.46 ppm), 4 mM (9.35 ppm), 8 mM (11.22 ppm), 16 mM (14.06 ppm), and 32 mM (15.69 ppm) concentrations, however, were not significantly different between each other. Again, this observation may be attributed to both heating and perhaps length of frozen storage prior to analysis. It has been reported that thermal processing can result in a 20 to 80% loss of nitrite [18], therefore the amount of residual nitrite in cooked meat sample pellets would be expected to be lower than the raw samples tested.

TABLE 5
Least Squares Means for Residual Nitrite of Cooked Pre-rigor
Semimembranosus Muscles Pellet Generated by the Nitric Oxide
Synthase System at Various L-Arginine Concentrations

| | Residual Nitrite | Range of Residual Nitrite |
|---|---|---|
| Concentration | (ppm)¹ | (ppm) |
| n | 96 | |
| 0 mM | 0.04^{b} | 0, 0.70 |
| 2 mM | 10.46^{a} | 1.05, 24.41 |
| 4 mM | 9.35^{a} | 0.70, 23.37 |
| 8 mM | 11.22^{a} | 1.05, 29.65 |
| 16 mM | 14.06^{a} | 2.44, 29.30 |
| 32 mM | 15.69^{a} | 0, 36.62 |
| SEM² | 2.19 | |

¹ppm = absorbance level × standard curve slope (1.7438) × dilution factor (200),
^{ab}LSMeans within a column with different superscripts are significantly different (P < 0.05)
²SEM: Standard error of the mean (largest) of the least squares means

### 3.3. Pigmentation and Curing Efficiency for Cooked Samples

Curing efficiency or nitrosylation is calculated as the percentage conversion of NO-heme to total heme. Cure efficiency is the percentage of total pigment converted to nitroso pigment and indicated the degree of cured color fading [22]. Cured meat pigment is extracted in a solution of 80% acetone and 20% water that extracts cured pigment heme. Total heme pigments are extracted using an acidified acetone solution that extracts heme from all heme proteins as first used by Hornsey [22]. NO-heme concentration (as ppm acid hematin)=sample A₅₄₀×290 determines the specific cure color pink from the rest of the heme pigmentation of the sample. Total heme concentration (ppm acid hematin)=sample A₆₄₀×680 determines the total heme pigmentation of the sample. Cure efficiency (%)=(ppm of nitrosoheme+ppm of total pigment)×100 and indicates how much of the product is cured and holds the cured pink stability once cooked [22, 103].

Least squares means for the degree of nitrosylation or curing efficiency for cooked sample supernatant is reported in Table 6. For curing efficiency, no concentration had the highest significant difference between sample treatments for NO— hemochrome or cure efficiency in the supernatant samples. The 2 mM (24.22 ppm), 4 mM (34.17 ppm), 16 mM (20.14 ppm) and 32 mM (31.67 ppm) L-arginine treatments had significantly higher levels of the total heme pigment than the control (0.00 ppm) however; they were not significantly different between each other. There is no observed difference between 32 mM, 16 mM, 8 mM, 4 mM, and 2 mM that shows higher levels of nitrosylation consistently. There is also an uncharacteristically high cure efficiency at all L-arginine concentrations (over 100%) indicating the ability of the NOS system to generate nitrite and nitric oxide under these specific laboratory research conditions total heme pigmentation.

TABLE 6
Least Squares Means for NO-Heme, Total Heme, and
Percent Nitrosylation (Cure Efficiency) of Cooked
Pre-rigor Pork Semimembranosus Muscles Supernatant
Generated by the Nitric Oxide Synthase System
at Various L-Arginine Concentrations

| | NO-Heme | Total Heme | |
|---|---|---|---|
| Concentration | (ppm)¹ | (ppm)² | Nitrosylation |
| n | 144 | | |

| | | | | |
|---|---|---|---|---|
| 0 | mM | 0.01^{a} | 0.00^{b} | 0.00^{a} |
| 2 | mM | 43.94^{a} | 24.22^{ab} | 125.52^{a} |
| 4 | mM | 21.09^{a} | 34.17^{ab} | 155.68^{a} |
| 8 | mM | 16.44^{a} | 70.38^{a} | 108.99^{a} |
| 16 | mM | 16.73^{a} | 20.14^{ab} | 110.11^{a} |
| 32 | mM | 16.86^{a} | 31.67^{ab} | 50.48^{a} |

| | | | |
|---|---|---|---|
| SEM² | 13.90 | 15.04 | 42.58 |

¹NO-heme pigment concentration (ppm acid hematin) = sample A₅₄₀ × 290.
²Total heme pigment concentration (ppm acid hematin) = sample A₆₄₀ × 680
³Percentage nitrosylation = (ppm NO-hemochrome/ppm total pigment) × 100
^{ab}LSMeans within a column with different superscripts are significantly different (P < 0.05)
²SEM: Standard error of the mean (largest) of the least squares means

Least squares means for the percentage of nitrosylation or curing efficiency in cooked sample pellets are reported in Table 7. There was a significant difference (P<0.05) in ppm NO-hemochrome levels between all L-arginine treatment combinations compared to the control but there were no differences between treatment concentrations. For total heme pigmentation all L-arginine treatment concentrations were higher than the control while no differences existed among the individual treatment concentrations. The 2 mM treatment had the highest concentration of total heme pigmentation (64.77 ppm). Percent nitrosylation was the greatest at 32 mM (156.72%) and was significantly different from the other treatment concentrations. The curing efficiency for 2 mM (46.51%), 4 mM (74.27%), 8 mM (70.13%), and 16 mM (97.82%) L-arginine concentrations were not significantly different from each other.

There is an observed difference between 32 mM, 16 mM, 8 mM, 4 mM, and 2 mM L-arginine concentrations that shows higher levels of nitrosylation in a more consistent manner compared to the cooked muscle supernatant. This suggests that the cooked pellet may be a more suitable source than the cooked supernatant to measure for nitrosylhemochrome and total heme concentrations.

TABLE 7
Least Squares Means for NO-Heme, Total Heme, and Percent
Nitrosylation (Cure Efficiency) of Cooked Pre-rigor Pork
Semimembranosus Muscles Pellet Generated by the Nitric Oxide
Synthase System at Various L-Arginine Concentrations

| | NO-Heme | Total Heme | |
|---|---|---|---|
| Concentration | (ppm)¹ | (ppm)² | Nitrosylation |
| n | 96 | | |

| | | | | |
|---|---|---|---|---|
| 0 | mM | 0.03^{b} | 0.12^{b} | 0.00^{b} |
| 2 | mM | 8.70^{a} | 64.77^{a} | 46.51^{ab} |
| 4 | mM | 7.77^{a} | 35.87^{ab} | 74.27^{ab} |
| 8 | mM | 9.33^{a} | 33.44^{ab} | 70.13^{ab} |
| 16 | mM | 11.69^{a} | 36.04^{ab} | 97.82^{ab} |
| 32 | mM | 13.05^{a} | 54.40^{ab} | 156.72^{a} |

| | | | |
|---|---|---|---|
| SEM² | 1.82 | 15.42 | 33.16 |

¹NO-heme pigment concentration (ppm acid hematin) = sample A₅₄₀ × 290.
²Total heme pigment concentration (ppm acid hematin) = sample A₆₄₀ × 680
³Percentage nitrosylation = (ppm NO-hemochrome/ppm total pigment) × 100
^{ab}LSMeans within a column with different superscripts are significantly different (P < 0.05)
²SEM: Standard error of the mean (largest) of the least squares means

### Conclusions

Results of this study indicate that the Nitric Oxide Synthase (NOS) system is viable, functional, and capable of generating NO and residual nitrite from pre-rigor pork semimembranosus muscle. Residual nitrite was determined to be present in samples even after three weeks of storage. Raw samples held more residual nitrite than cooked samples, indicating that a cure reaction used up available nitrite when heated in cooked samples and converted to nitrosylhemochromagen. Cooked samples nitrosylation percentages showed that while the supernatant seemed to hold a better nitrosylation, there was a more thorough distribution of pigmentation within the pellet that held significant concentrations of nitrosylhemochrome and nitrosylation.

The small levels of nitrite produced by the arginine treatments can still be significant enough to color meat and poultry that results in the characteristic cured “pink” color, with the lowest created nitrite levels at 1 ppm enough to cure poultry and 4 ppm to cure pork shoulders [106]. The higher levels of nitrite needed to cure meat for antimicrobial properties would have to reach 50-60 ppm in conjunction with pH, salt concentration, reductants, and iron content to protect against Staphylococcus aureus and Clostridium botulinum [31]. The control of bacterial growth of C. botulinum and any toxin production would have levels higher than 70 ppm [32]. With the long storage times still producing results, there is an indication that the samples will be shelf stable and storage stable to continue the cure reaction when heated then stored.

Based upon data in these applications of arginine concentrations to pre-rigor samples of Semimembranosus pork muscle, there is evidence the Nitric Oxide Synthase system is still producing nitric oxide without being in vivo. The evidence of NOS system is found in multiple medical studies of the human metabolism [3, 58, 59, 107], and in animal studies as well [4, 71, 98], suggesting the NOS system is a viable option for nitric oxide generation in tested livestock species beyond pigs [6, 94, 99, 101]. The evidence of the NOS system in pre-rigor meat promotes future research to test how long the NOS system is viable outside of pre-rigor meat by testing post-rigor meat and how long the meat has been aged (i.e. number of hours post slaughter extended to aged meat used in current cured meat products). To continue testing treatments of L-arginine at higher concentrations beyond the treatments in this study would be imperative to verify the full efficacy and efficiency of the Nitric Oxide Synthase system as an alternative curing method to generate its own nitric oxide from the meat itself.

### Post-Rigor Meat Processing

Cured meat products are formed by the conversion of nitrite to nitric oxide by addition of heat, preserving the meat and developing a cured meat color. The activation of the Nitric Oxide Synthase (NOS) by L-arginine can be used to form nitrite and be measured for cured meat color and residual nitrite formation. Pre- and post-rigor Semimembranosus muscles were treated with varying concentrations of L-arginine solutions, then analyzed for residual nitrite in raw, cooked, and cooked pellet samples, and nitrosylation in cooked samples.

Sodium nitrate and nitrite are used as the most common oxidizing agent and meat curing agent within the meats industry. As a highly reactive compound, nitrite can be converted into a variety of unstable compounds (i.e. nitrosamines, nitrous acid, nitric oxide) that are imperative to control for safe and effective curing processes [7, 43]. The curing ability of nitrite also depends on the conversion of nitrite to nitric oxide and the formation of nitrosohemochromagen by thermal processing [15, 27, 108]. Current curing methods with sodium nitrite are being called into question based on carcinogen concerns with nitrosamines [8, 9], while the alternative curing methods produced to address these concerns are not as efficient as sodium nitrite and can develop less than desirable defects for the consumer [10].

A follow-up study was conducted to investigate the validity of the ability of L-arginine to produce nitric oxide through the Nitric Oxide Synthase (NOS) system in pre-rigor and post rigor semimembranosus pork muscles. The previous study used pre-rigor muscle samples and provided evidence that the NOS system could generate residual nitrite and nitric oxide by using L-arginine as a catalyst. The residual nitrite levels were low and still witnessed after three weeks of storage, indicating the NOS system is still viable and could potentially be active in post-rigor samples as well. The residual nitrite and nitrosylation were used in this study to establish a comparative baseline between pre-rigor and post rigor treatments by L-arginine to assess its ability to generate residual nitrite and nitric oxide. This study continues the investigation of the efficacy of the amino acid arginine as the major compound for an amino acid based alternative curing system. This is further detailed in Example 13.

### EXAMPLES

The following examples are provided in order to demonstrate and further illustrate certain preferred embodiments and aspects of the present invention and are not to be construed as limiting the scope thereof. Example 1 to Example 7 describe study of treatments in pre-rigor meat. Example 8 to Example 12 describes application of L-arginine to the manufacture of various types of cured meat products in a pilot plant setting.

### Example 1

### Powdering Samples for Analysis

1. Previously frozen samples were thawed until meat could be cut.
2. Meat samples were hand cut into small cubes 12 inch or smaller.
3. Sample was placed into a wire straining basket and lowered into a container of liquid nitrogen.
4. Samples were submerged for 30 sec or until liquid nitrogen stopped bubbling.
5. Frozen sample pieces were transferred to a stainless steel waring blender and blended until a homogenous powder was formed.
6. Powdered samples were transferred to a whirl pack back and stored frozen until analysis.

### Example 2

### AOAC 950.46 Moisture Analysis

Equipment includes: Gloves; Whatman Filter paper: #2 Qualitative Circles, 125 mm Stapler with staples; #2 pencil; and Desiccator with desiccant Analytical balance/scale Convection oven

Procedure (Gloves should be worn at ALL times)
1. Construct thimbles from Whatman #2 filter paper folded into a sleeve open at one end and stapled at the other end
2. Label thimbles with #2 pencil
3. Dry thimbles for a minimum of 12 hours at 100° C using an air dry oven. Oven should not be overfilled. Only 1 pan per shelf and not stacked on desiccant. Metal pans should not tough any of the walls of the oven, as air must be able to circulate.
4. Ensure desiccator is properly equipped with functional desiccant, sealant, and is not overfilled with thimbles/samples
5. Desiccator should be opened by sliding lid to remove thimble/sample and then immediately sealed.
6. Transfer dried thimbles to desiccator
7. Cool thimbles in desiccator for 30 minutes
8. Record dried thimble weight and 1 staple to the nearest 0.0001 g. This is “initial thimble weight”. See #5 for opening/closing desiccator and place thimble immediately on the scale. Record 1st weight.
9. Put 2-3 grams of powdered homogenous sample into thimble and record the weight plus 1 staple to the nearest 0.0001 grams. This is “initial thimble/sample weight”. Each sample should be performed in triplicate.
10. Fold over open end of the thimble and seal with a staple.
11. Place thimble on clean metal pan. Samples should be laid flat and not overlapping.
12. Dry in 100 °C dry oven for 16-18 hours. Oven should not be overfilled. Only 1 pan per shelf and not stacked on desiccant. Metal pans should not tough any of the walls of the oven, as air must be able to circulate.
13. Coll in desiccator for at least 1 hour. #4 should still be true.
14. Record dried thimble weight and 1 staple to the nearest 0.0001 gram. This is “dried thimble/sample weight”. See #5 for opening/closing desiccator and place thimble immediately on the scale.

### Example 3

### Meat pH Measurement Procedure

Equipment: Blender Pint Jars; pH meter with pH electrode Stir plate; Magnetic stir bars Reagents: Distilled water; Buffer, pH 4.0 and pH 7.0

### Procedure:

1. Place approximately 10 g of the frozen powdered sample into a pint jar.
2. Add 90 g distilled water to the pint jar, attach blender blade, o-ring, and screw cap. Blend on high speed for 15 to 20 seconds to make a smooth slurry.
3. Place a magnetic stir bar in the bottom of the jar and place on stir plate. Stir plate should be moderately agitating the sample (~200 RPM) when the probe is lowered into the sample jar.
4. Measure the pH of this slurry with a pH meter that has been calibrated with two standard buffer solutions. One buffer at pH=7.0 and the other (either 4 or 10) having a pH value near that of the final.
5. The electrode should be placed in the stirred slurry for about 30 seconds to allow the electrode to equilibrate.
6. Press read to begin pH measurement. “Stable” will appear when reading is finished. Record the pH of the slurry after the electrode has stabilized.
7. Do NOT leave the pH probe in the meat slurry. Remove the pH probe from the slurry and wash it thoroughly with distilled water. Be sure to gently wipe all fat and connective tissue from the probe.
8. Always store the pH probe in CLEAN distilled water or pH 7 buffer. NEVER let the bulb dry out.

### Example 4

### Nitrite Analysis in Cured Meats Procedure (AOAC Official Method 973.31, 2000, 39.1.21, Page 8)

### Equipment:

| | |
|---|---|
| 100 ml beakers | Glass rods |
| 1000 ml Volumetric flasks | 500 ml Volumetric flasks |
| 50 ml Volumetric flasks | Hot Plate |
| Spectrophotometer (UV/VIS 540 nm) | Spec cuvettes 5 |
| ml Pipettes | 10 ml Pipettes |
| 500 ml Erlenmeyer flasks | Whatman ® No. 2 Filter paper |

Heated Water Bath
Analytical balance Homogenizer or food processor

### Reagents:

NED Reagent: Dissolve 0.2 g N-(1-naphthyl)ethylene diamine·2HCl in 150 ml 15% (v/v) acetic acid. Store in a glass-stoppered brown glass bottle. If necessary, filter before use.
Sulfanilamide Reagent: Dissolve 0.5 g sulfanilamide in 150 ml 15% (v/v) acetic acid.

Store in dark or brown glass bottle. If necessary, filter before use.

### Standard Curve Preparation:

### Nitrite Standard Solution

Stock solution (1,000 ppm NaNO₂): Dissolve 1 g (±0.0001) NaNO₂ in distilled water and dilute to 1 L.
Intermediate Solution (100 ppm NaNO₂): Dilute 100 ml of Stock Solution to 1,000 ml with distilled water.
Working Solution (1 ppm NaNO₂): Dilute 10 ml of Intermediate Solution to 1,000 ml with distilled water.

### Filter Paper:

Randomly select 3 to 4 sheets per box. Filter 40 ml water through each sheet. Add 4 ml sulfanilamide reagent, mix and wait 15 min. If any sheets are positive, discard entire box.

### Procedure:

1. Weigh 5 g (+0.01) of finely comminuted and thoroughly mixed sample into a 100 ml beaker.
2. Add approximately 40 ml distilled water and heat to 80° C. Use a glass rod to break up all lumps and mix thoroughly.
3. Transfer the heated solution to a 500 ml volumetric flask. Quantitatively wash the beaker and rod with successive portions of the hot distilled water, adding all washings to the flask (approximately 300 ml).
4. Transfer the flask to a steam bath (~100° C) and shake occasionally for 2 hour. After cooling to room temperature, bring the volume to 500 ml with distilled water and remix. Filter through two Whatman No. 2 filter papers into flask and mix solution thoroughly (discard the residue). Then transfer 25 ml of the filtrate into a 50 ml volumetric flask then add 2.5 ml sulfanilamide reagent, mix thoroughly.
5. After setting for 5 min, add 2.5 ml NED reagent, mix. Dilute to volume with distilled water, mix and set for another 15 min to let the color develop.
6. Transfer a portion of the solution to the cuvette and read absorbance at 540 nm against a blank of 45 ml distilled water+2.5 ml sulfanilamide reagent+2.5 ml NED reagent.

### Standard Curve Preparation:

Add 10, 20, 30 and 40 ml of nitrite working solution to individual 50 ml volumetric flasks. The nitrite concentration in each flask is 0.2, 0.4, 0.6 and 0.8 ppm, respectively. Add 2.5 ml of sulfanilamide reagent, mix and proceed as in steps 5 and 6. The standard curve is straight line to 1 μg/ml NaNO₂ in final solution.

### Calculation:

Nitrite Residual (ppm or μg/g)=Absorbance×K×F Where:
K=Standard Curve Slope=1.7438
F=Dilution Factor=500×2×⅕=200
   OR
The concentration may be read directly off of the spectrophotometer. Thus, K, Abs nor F are required in this case.

### Example 5

### Sample (Plasma or Serum) Preparation for Amino Acid Analysis by HPLC

### Materials and Chemicals

HClO₄ (70%), HPLC-grade H₂O, K₂CO₃
Polypropylene tubes (12×75 mm) Microcentrifuge tubes (1.5 mL)
Preparing 1.5 M HClO₄ and 2 M K₂CO₃ solutions
1.5 M HClO₄: Add slowly 32.2 mL of 70% HClO₄ to 150 mL HPLC-grade H₂O. Make up to final volume of 250 mL with HPLC-grade H₂O. Mix thoroughly.
2 M K₂CO₃: Dissolve 69.11 g of K₂CO₃ in 150 mL HPLC-grade H₂O. Make up to a final volume of 250 mL with HPLC-grade H₂O. Mix thoroughly.

### Procedure for Processing Plasma or Serum Samples for Amino Acid Analysis

1. Pipette 0.5 mL of plasma (or serum) to a 12×75 mm polypropylene tube. Place the tube in ice.
2. Add 0.5 mL of 1.5 HClO₄ to the tube (the tube remains in ice).
3. Mix the tube well (using a vortex).
4. After 2 min, add 0.25 mL of 2 M K₂CO₃ to the tube (the tube remains in ice).
5. After 3 min, mix the tube well. Then place the tube in ice for 3 min.
6. Centrifuge the tube at 2000 g and 4° C for 15 min.
7. Store the supernatant in 1.5 mL Microcentrifuge tube at −80° C or test immediately.

### Example 6

### Determination of Nitrite (UV/VIS Spectrophotometric Method)

### A. Chemicals

1. Use deionized H₂O or double glass distilled H₂O.
2. S-Reagent: Mix 50 mL of 37% HCl with 300 mL of H₂O. Add 5 g sulfanilamide. Make up to 500 mL with H₂O. Store in a brown bottle at 4° C.
3. N-Reagent: Dissolve 0.5 g N-(1-Naphthyl-)ethylenediamine dihydrochloride in 500 mL of H₂O. Store in a brown bottle at 4° C.
4. 125 mM NaNO₂ standard: Dissolve 86.3 mg of NaNO₂ in 10 mL H₂O.
   a. 1.25 mM NaNO₂ standard: Dilute 1 mL of 125 NaNO₂ in 100 mL of H₂O. (Stock solution)
   b. 80 μM NaNO₂: Dilute μl of 1.25 mM NaNO₂ in 3 mL of H₂O.

### Assay Procedures

1. To NaNO₂ Standard, add the following: 0.5 mL of NaNO₂ standard and 0.5 mL of blank cell-culture medium
To sample tube, add the following: 0.5 mL of sample (cell-culture medium) and 0.5 mL of H₂O
2. Add 100 μl of S-Reagent. Mix. Wait for 2 min.
3. Add 100 μl of N-Reagent. Wait for 10 min. Measure absorbance at 543 nm.
The colorimetric reaction is completed in 10 min, and color is stable for at least 1 hour.
This assay is not interfered by glucosamine, aminoguanidine, or N^{G}-nitro-L-arginine (NNA)

### Example 7

### Nitrosoheme and Total Heme Content of Small Samples

### Reagents

1. Acetone-a (aqueous acetone): Place 90 mL distilled water in a 1 L volume flask; add spectrophotometric grade acetone, mix and bring to volume.
2. Acetone-b (acidic acetone): Slowly add 20 mL of concentrated HCl to 80 mL of water. Transfer the dilute HCl solution to a 1 L volumetric flask, mix, and bring to volume with additional spectrophotometric grade acetone.

### Procedures

1. Do all procedures in subdued light to reduce fading of pigment.
2. Weigh out 2.0 g minced lean meat sample in a 50-mL polypropylene centrifuge tube.
3. Pipette 9.0 mL acetone-a into 50-mL tube, to obtain acetone concentration of 80%.
4. Mix thoroughly with a probe-type homogenizer or a glass rod.
5. Cap the tube to minimize evaporation of acetone, and mix by gentle swirling.
6. Let stand 10 minutes in the dark, then filter through medium-fast filter paper into a glass test tube.
7. Transfer filtrate into a 1-cm quartz cuvette and read absorbance at 540 nm. (Avoid use of disposable plastic cuvettes. They become opaque upon exposure to acetone). Calculate nitroso pigment concentration as previously described.
8. Prepare another 2.0-g sample, using acetone-b.
9. Macerate and hold 1 hour in the dark before filtering.
10. Filter the extract as before, and read absorbance at 640 nm. Calculate total pigment and cure efficiency as previously described.

### Post Rigor Studies for Injection, Test Tube Sausages, and Sausages Phases

The following (Example 8-Example 12) describes application of L-arginine to the manufacture of various types of cured meat products in a pilot plant setting.

### Example 8

### Whole Muscle Injection-Postmortem Muscle

Six (N=6) pork loins from were procured from a local distributor with a pack date of Mar. 18, 2019. Two (N=2) of these pork loins were cut into four sections (~1 kg; 8 pieces total) and weighed prior to injection with the test brine solution (Table 8). Initial muscle pH was prior to injection before injection (10, 15, 20 or 25%) as well as brine pH was measured (Table 9). The test brine was manufactured for a targeted 25% injection level (Table 8) and was prepared on the day of manufacture to simulate a commercial ham cure containing water, sodium tri-polyphosphate, salt (NaCl), L-arginine, sodium erythorbate (NaE) and sugar. Prior benchtop laboratory test brines contained water, salt, L-arginine, and sodium erythorbate. Brine percentages were calculated to simulate ingoing arginine of test tube trials (5569 ingoing arginine, 547 ppm NaE, 0.9% NaCl).

TABLE 8
Test brine formulated for 25% muscle injection.

| | 25% Pump | | Bnls loin | | |
|---|---|---|---|---|---|
| Brine Formulation | lbs | g | 25% | ppm | Targets |
| Water | 8.50 | 3862.83 | 21.92 | | |
| Sodium tri- | 0.12 | 52.94 | 0.30 | 3004.84 | (′5000) |
| polyphosphate | | | | | |
| Salt | 0.70 | 318.12 | 1.81 | | |
| L-arginine | 0.22 | 97.71 | 0.55 | 5545.41 | (′200) |
| Sugar | 0.14 | 63.62 | 0.36 | | |
| Sodium erythorbate | 0.02 | 9.63 | 0.05 | 546.80 | (′547) |
| Total | 9.69 | | 25.00 | | |

TABLE 9
Muscle weights and pH (muscle, brine, injected muscle).

| | Loin In. | Post Inject | In. muscle | Brine | Injected Loin |
|---|---|---|---|---|---|
| Loin 1 | Wt | Wt | pH | pH | pH |
| A1 (10%) | 2.3 | 2.5 | 5.59 | 10.55 | 7.12 |
| B1 (15%) | 2.3 | 2.7 | 5.59 | 10.55 | 7.08 |
| C1 (20%) | 2.2 | 2.6 | 5.59 | 10.55 | 7.14 |
| D1 (25%) | 1.7 | 2.1 | 5.59 | 10.55 | 7.18 |
| | Loin In. | Post Inject | In. Muscle | Brine | Injected Loin |
| Loin 2 | Wt | Wt | pH | pH | pH |
| A2 (10%) | 2.1 | 2.3 | 5.59 | 10.55 | 7.15 |
| B2 (15%) | 2.2 | 2.5 | 5.59 | 10.55 | 7.09 |
| C2 (20%) | 3.5 | 4.2 | 5.59 | 10.55 | 7.03 |
| D2 (25%) | 3.1 | 3.8 | 5.59 | 10.55 | 7.09 |

Samples were weighed before and after injection to ensure pickup percentage as close to the target weights of 10, 15, 20, and 25% pickup. Samples were vacuum packaged and held for two hours before thermal processing to simulate previous laboratory test tube trials. Loin sections were cooked in a smokehouse oven for 90 min until an internal temperature of 145° F (62.8° C; Dry bulb 170° F/Wet bulb 150° F) was reached.

After cooking and stabilization at room temperature, loin sections were sliced perpendicular to the long axis of the muscle fibers to determine if any nitrosylation (nitric oxide (NO) bound to myoglobin) occurred, resulting in the characteristic cured (pink) color. The samples had no observable cured color formation to indicate that curing (generation of NO and binding of NO to myoglobin to form nitroso-hemochromagen and residual nitrite) had occurred through the L-arginine activated eNOS system. Therefore no nitrite testing and/or nitrosylation testing was performed. The absence of cured color may be attributed to the concentration/amount of ingoing arginine, the dispersion of brine via injection, and/or the high alkaline pH of the brine (inclusion of sodium tri-polyphosphate, increased muscle pH by ~2.0 pH units). Based on an ingoing L-arginine brine concentration of 5545 ppm, there would be approximately 554, 830 and 1110 and 1385 ppm of ingoing L-arginine at 10, 15, 20 and 25% injection levels, respectively. These levels may not be enough to activate the eNOS system to produce enough NO to generate observable cured color when coupled with the higher alkaline muscle pH. Based on these findings it was decided that the next test phase would eliminate phosphate and use a combination of whole muscle injection and immersion in of the injected muscle in the brine systems. The hypothesis was that this curing system would lower muscle pH (enhance endothelial nitric oxide synthase (eNOS) system conversion of L-arginine to NO2) and that whole muscle immersion for a longer period of time may enhance brine solution distribution throughout the muscle (increasing the opportunity for the L-arginine to activate the eNOS system) for cure color development after thermal processing.

### Example 9

### Whole Muscle Injection or Immersion

Two (N=2) pork loins were procured from the same batch previously described (Mar. 18, 2019 pack date). Two (N=2) pork loins were cut into four sections (~1 kg; 8 pieces total) and weighed prior to injection (10, 15, 20 or 25%) with the test brine solution (Table 10). Initial muscle pH was prior to and after injection/immersion and the brine pH was measured as well (Table 11). The test brine was formulated (Table 10) on the day of manufacture to simulate a ham cure containing water, salt (NaCl), L-arginine, sodium erythorbate (NaE) and sugar. No sodium tri-polyphosphate was added to the brine, only water, salt, arginine, and sodium erythorbate in the same concentration/percentage used for prior benchtop laboratory tests. Brine percentages were calculated to simulate ingoing arginine of test tube trials (5574 ingoing arginine, 547 ppm NaE, 0.9% NaCl). Phosphate was eliminated from the test brine to decrease pH to increase the likelihood of the L-arginine activating the eNOS system found within the meat.

Four (N=4) tenderloins fabricated from four pork loins (Mar. 18, 2019 pack date) were subjected to immersion curing by placing them into the remaining (leftover) test brine (no injection) for approximately 18 hr. were immersed in the remaining brine to simulate previous test tube trials.

Injection cured pork loin sections (10, 15, 20, 25%) and immersion cured pork tenderloins were cooked in a smokehouse oven for 90 min until an internal temperature of 145° F (62.8° C; Dry bulb 170° F/Wet bulb 150° F) was reached. Samples were weighed before and after injection to validate percent pickup via injection or immersion curing. Samples were vacuum packaged and held for two hours before cooking to simulate hold in previous laboratory test trials to enhance brine absorption into the muscles.

TABLE 10
Test brine formulated for 25% muscle injection.

| | 25% Pump | | Bnls loin | | |
|---|---|---|---|---|---|
| Brine Formulation | lbs | g | 25% | ppm | Targets |
| Water | 8.50 | 3862.83 | 21.52 | | |
| Salt | 0.87 | 395.37 | 2.20 | | |
| L-arginine | 0.28 | 134.97 | 0.71 | 5574.90 | (′200) |
| Sugar | 0.14 | 64.08 | 0.36 | | |
| Sodium erythorbate | 0.01 | 6.14 | 0.03 | 546.86 | (′547) |
| Total | 9.80 | | 25.08 | | |

TABLE 11
Muscle weights and pH (muscle, brine,
injected or immersed muscle).

| | Initial | Injection | | | |
|---|---|---|---|---|---|
| Loin 1 | weight | weight | Initial pH | Brine pH | End pH |
| A1 (10%) | 2.9 | 3.2 | 5.53 | 10.79 | 5.56 |
| B2 (15%) | 2.5 | 2.9 | 5.53 | 10.79 | 5.60 |
| C3 (20%) | 2.0 | 3.5 | 5.52 | 10.79 | 5.62 |
| D4 (25%) | 2.0 | 2.5 | 5.50 | 10.79 | 6.51 |
| | Initial | Immersion | | | |
| Tenderloin | weight | weight | Initial pH | Brine pH | End pH |
| 1 | 2.2 | 2.6 | 5.56 | 10.79 | 6.10 |
| 2 | 2.3 | 2.7 | 5.55 | 10.79 | 6.15 |
| 3 | 2.1 | 2.5 | 5.58 | 10.79 | 6.13 |
| 4 | 2.2 | 2.6 | 5.54 | 10.79 | 6.12 |

After thermal processing, each sample was sliced to determine if any nitrosylation or cure color formation occurred. The samples had no color change to indicate curing reaction had occurred, therefore no nitrite testing and/or nitrosylation testing was performed. Even though phosphate was not included in the formulation the brine pH was still high. The water used in formulating the brine was tested and it was observed that the water had a pH of 8.76. It appears that the concentration of L-arginine and the high brine pH may not be at the right amount/level to achieve the desired cured meat reaction. Based on these product failures, it was decided to go back to use the original protocol used in laboratory testing—but use a waterproof sausage casings to create a “pilot plant tube” to make sure the results seen in the laboratory could be replicated in a pilot plant setting.

### Example 10

### Plastic Casing Test Tube Ground Pork Loin Sausages

The desired cured color could not initially be generated in a variety of processed meat products in a pilot plant setting. Therefore the same laboratory conditions that proved the addition of L-arginine would activate the Nitric Oxide Synthase (NOS) system and generate NO and residual nitrite (NO₂) in postmortem muscle were recreated. Pork loins (N=2) procured from a local meat distributor (Mar. 18, 2019) were used. Eight pounds of pork loins were ground (½″ then ¼″ plate) and weighed out in one pound portions. Plastic waterproof casings (2″ diameter) were clipped at one end. One pound of ground pork loin was placed in the casing and two pounds of brine (L-arginine concentration 7498 ppm) were added and the open end of the casing clipped. Based on laboratory test tube studies, meat samples would absorb 2025 of the solution which equates to absorption of approximately 1500 ppm of L-arginine. Each plastic casing contained the same proportion of meat and brine as conducted during previous laboratory experiments (Table 12). A control was manufactured by substituting distilled water for the L-arginine brine. All plastic casing “test tubes” were placed in a commercial smokehouse and cooked for 90 min until the internal temperature reached 145° F (62.8° C; Dry bulb 170° F/Wet bulb 150° F).

TABLE 12
Formulation for plastic casing test tube sausages.

| | Plastic Casing Sausages | |
|---|---|---|
| | 20% addition | |
| | AAACS-Brine Solution-1&2 | |
| | 1 | 1 |
| | GRAMS | %/PPM in Product |
| Dry Ingredients | | |
| Salt | 81.648 | 1.80% |
| L-Arginine | 6.804 | 1500/0.15% |
| Total | 88.452 | 1.95% |
| Restricted Ingredients | | |
| Sodium Erythorbate (547 ppm) | 2.481 | 546.87 |
| TOTAL | 2.481 | 0.06% |
| Liquid Ingredients | | |
| Ice water | 816.48 | 18.00% |
| Total | 816.48 | 20.00% |
| Total Brine Weight | 907.41 | 1500 ppm |
| Ground Pork Loin | 454.00 | |

After thermal processing the plastic casing test tubes were cut open and emptied into beakers, then separated into residue (meat particles) and supernatant (liquid) via paper filtration into 50 mL conical tubes for collection and subsequent analysis for residual nitrite (supernatant) and cured pigment formation/nitrosylation (meat residue).

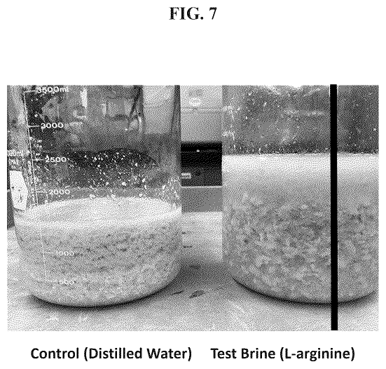

FIG. 7 shows a beaker of control (distilled water) and brine treated (L-arginine) samples of “test tube sausages”

Nitrosylation and residual nitrite analyses was performed under reduced light to avoid loss of pigmentation. L-arginine treated test tube pork sausage averaged 53.12 to 72.30 ppm of residual nitrite in the cooked meat pellet with percent nitrosylation ranging from 33 to 60 percent (Table 13). The brine was formulated to deliver 1500 ppm ingoing L-arginine at 25% absorption into the meat after two hours of immersion in the brine solution. Adding lesser amounts of the brine (10, 15 or 20%) resulted in similar results for 15, 20 and 25% addition of L-arginine brine. These results indicate that 1500 ppm L-arginine does activate the NOS system—but that perhaps a certain percentage of brine must be added to effectively distribute the L-arginine substrate to effectively generate NO and NO₂ via the NOS system (related to curing efficiency).

The reason for this method generating cured color and residual nitrite may be due to the 1:2 ratio of meat to L-arginine brine in a closed system. Under thermal processing the brine would constantly be in contact with the meat providing adequate L-arginine to allow conversion of L-arginine to nitric oxide and residual nitrite via the NOS system. In previous tests, a percentage of brine was injected into whole muscle or the muscle was immersed in the brine and removed from the excess brine then subjected to thermal processing. Additionally, particle size or surface area may also contribute to the efficacy of the NOS system conversion of L-arginine to NO and residual nitrite compared to whole muscle pieces. This observation suggests perhaps, that lower concentrations of L-arginine may result in an acceptable cure reaction in comminuted products, but high concentrations and/or brine percentages may be required for curing whole muscle pieces via injection and/or immersion.

TABLE 13
Least Squares Means for four stage arginine concentration
of nitrite and nitrosylation by NOS system in cooked
“test tube pork sausage.”

| | Nitrite | Nitrite | | Total | |
|---|---|---|---|---|---|
| Concen- | Pellet | Supernatant | NO-Heme | Heme | Nitro- |
| tration | (ppm)¹ | (ppm)¹ | (ppm)² | (ppm)³ | sylation⁴ |
| N = 15 | | | | | |
| 10% | 72.31^{a} | 33.48^{a} | 7.63^{bc} | 22.66^{a} | 33.71^{ab} |
| 15% | 53.12^{ab} | 36.50^{a} | 8.70^{b} | 19.26^{a} | 45.19^{a} |
| 20% | 59.52^{ab} | 40.80^{a} | 8.31^{b} | 22.66^{a} | 36.99^{ab} |
| 25% | 59.63^{ab} | 35.34^{a} | 16.24^{a} | 28.56^{a} | 60.13^{a} |
| Control | 20.69^{b} | 19.65^{b} | 3.57^{c} | 20.85^{a} | 17.23^{b} |
| SEM⁵ | 4.29 | 1.69 | 0.97 | 2.38 | 5.76 |

¹ppm = absorbance level × standard curve slope (1.7438) × dilution factor (200)
²NO-heme pigment concentration (ppm acid hematin) = sample A₅₄₀ × 290.
³Total heme pigment concentration (ppm acid hematin) = sample A₆₄₀ × 680
⁴Percentage nitrosylation = (ppm NO-hemochrome/ppm total pigment) × 100
^{ab}LSMeans within a column with different superscripts are significantly different (P < 0.05)
⁵SEM: Standard error of the mean (largest) of the least squares means

### Example 11

### “Pork Loin Sausages”—Apr. 18, 2019

Pork loins from a local meat distributor were procured on Mar. 18, 2019 and tested four weeks later on Apr. 18, 2019. A total of nine pounds of pork loins were split into thirds and ground through kidney, ½″, and ¼″ plates to make a restructured ham sausages formulated (Table 14) to contain either 1000 or 5000 ppm L-arginine which were stuffed in 2″ plastic casings and thermally processed. Three pounds of each grind size (9 pound batch) were mixed with high (5000 ppm), low (1000 ppm), or control (0 ppm) concentrations of brine at 25% addition using a Kitchen aid mixer. It was decided to lower the concentration of the L-arginine from 1500 ppm (Test 3) to 1000 ppm (Test 4) to verify that this concentration can generate acceptable levels of NO to develop cured color and residual nitrite for antioxidant and antimicrobial properties. Control and treatment met batches were stuffed in plastic casings in triplicate for each high, low, and control concentrations in one pound portions. “Test tube ham sausages” were hung in the smokehouse and thermally processed for approximately 90 min until the internal temperatures reached 145° F (62.8 °C; Dry bulb 170° F/Wet bulb 150° F). The samples were tested for residual nitrite and nitroso-hemochromagen pigment (Table 14) one day after thermal processing cooking (April 19^{th} to April 20^{th}), then eight days after thermal processing on April 26^{th} to determine any cure color fading and residual nitrite.

TABLE 14
Formulation for ground pork loin sausage.

| | Pork Loin Sausage | | | |
|---|---|---|---|---|
| | 25% addition | | | |
| | AAACS-Brine Solution-1&2 | | | |
| | | 1 | | 2 |
| | 1 | %/PPM in | 2 | %/PPM in |
| | GRAMS | Product | GRAMS | Product |
| Dry Ingredients | | | | |
| Salt | 32.21 | 1.80% | 32.66 | 1.80% |
| L-Arginine | 2.24 | 1000.90 | 11.33 | 5000.10 |
| Total | 34.45 | 0.13% | 43.99 | 0.63% |
| Restricted Ingredients | | | | |
| (547 ppm) | 0.984 | 549.03 | 1.00 | 550.45 |
| TOTAL | 0.984 | 0.06% | 1.00 | 0.06% |
| Liquid Ingredients | | | | |
| ICE WATER | 412.78 | 23.02% | 408.24 | 22.52% |
| Total | 412.78 | 25.00% | 408.24 | 25.00% |
| Total Brine Weight | 448.21 | 1000 ppm | 453.23 | 5000 ppm |
| Ground Pork Loin | 454.00 | | | |

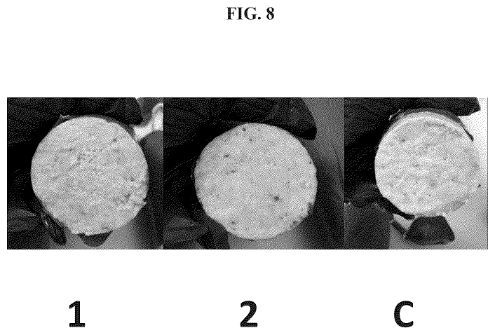

FIG. 8 shows low (1-1000 ppm), high (2-5000 ppm), and L-arginine concentrations and control (C-0 ppm) “test tube pork loin sausages”. Starting on the left, the low concentration (1) exhibits slight cured color the high concentration (2) exhibits pink cured color formation, and the control (C) has no detectable cured color.

The low L-arginine concentration treatment had higher residual nitrite (Table 15) due to the lower conversion rate of nitrite to NO to nitroso-hemochromagen compared to the higher L-arginine treatment concentration. The nitrosylation percentage ranged from 37 to 60 percent from the low to high concentrations, resulting in observable cured color formation by the NOS system. Nitrosylation percentage (cured color formation) was greater for the higher concentration since there was more nitric oxide generated via the NOS system to complex with myoglobin to form nitroso-hemochromagen, resulting in less residual nitrite.

TABLE 15
Least Squares Means for low and high L-arginine concentration for
residual nitrite and nitrosylation by NOS system in cooked “test
tube pork loin sausage” one day after thermal processing.

| | Nitrite | NO-Heme | Total Heme | |
|---|---|---|---|---|
| Concentration | (ppm)¹ | (ppm)² | (ppm)³ | Nitrosylation⁴ |
| N = 9 | | | | |
| Low | 79.16^{a} | 8.21^{a} | 22.21^{a} | 37.05^{a} |
| High | 66.73^{a} | 13.43^{b} | 22.21^{a} | 60.58^{b} |
| Control | 22.08^{b} | 4.83^{c} | 24.02^{a} | 20.08^{c} |
| SEM⁵ | 4.27 | 0.29 | 0.93 | 1.53 |

¹ppm = absorbance level × standard curve slope (1.7438) × dilution factor (200)
²NO-heme pigment concentration (ppm acid hematin) = sample A₅₄₀ × 290.
³Total heme pigment concentration (ppm acid hematin) = sample A₆₄₀ × 680
⁴Percentage nitrosylation = (ppm NO-hemochrome/ppm total pigment) × 100
^{ab}LSMeans within a column with different superscripts are significantly different (P < 0.05)
⁵SEM: Standard error of the mean (largest) of the least squares means

The same analyses were conducted 8 days post thermal processing (April 26) under the same conditions as previously described. As expected, there was a loss of residual nitrite and nitrosylation percentage during 8 days of refrigerated vacuum packaged storage, resulting in a 20-30 ppm residual nitrite decrease, and a 38-45 percent decrease in nitrosylation. During refrigerated, vacuum packaged storage of cured meat products, residual nitrite fluctuates, tending to decrease as it continues binding to myoglobin to maintain cured color though generation of nitroso-hemochromagen. Exposure to light during storage also results in cure color fading causing the percent nitrosylation as measured by nitroso-hemochromagen, which is sensitive to light, to decrease. The nitric oxide generated by high L-arginine concentrations resulted in a greater percentage of nitrosylation (Table 15), more intense cured color (FIG. 8) and less residual nitrite. During storage (Table 16) residual nitrite levels dropped due to nitrosylation with other proteins, lipids or sulfhydryl groups, or conversion to nitrate (NO₃) or nitrogen gas rather than complexing with myoglobin to maintain cure color.

TABLE 16
Least Squares Means for two stage arginine concentration of nitrite and
nitrosylation by NOS system in cooked “test tube pork ham.”

| | Nitrite | NO-Heme | Total Heme | |
|---|---|---|---|---|
| Concentration | (ppm)¹ | (ppm)² | (ppm)³ | Nitrosylation⁴ |
| N = 9 | 9 | | | |
| Low | 37.78^{a} | 12.95^{a} | 28.56^{b} | 45.28^{a} |
| High | 48.12^{a} | 14.59^{a} | 37.4^{a} | 38.65^{a} |
| Control | 11.27^{a} | 11.69^{a} | 26.29^{b} | 44.54^{a} |
| SEM⁵ | 9.72 | 1.64 | 1.47 | 3.84 |

¹ppm = absorbance level × standard curve slope (1.7438) × dilution factor (200)
²NO-heme pigment concentration (ppm acid hematin) = sample A₅₄₀ × 290.
³Total heme pigment concentration (ppm acid hematin) = sample A₆₄₀ × 680
⁴Percentage nitrosylation = (ppm NO-hemochrome/ppm total pigment) × 100
^{ab}LSMeans within a column with different superscripts are significantly different (P < 0.05)
⁵SEM: Standard error of the mean (largest) of the least squares means

### Example 12

### Test Frankfurters—Jul. 25, 2019

Based on the results of test 4, beef frankfurters were manufactured with 1000 or 5000 ppm L-arginine, 156 ppm sodium nitrite or 0.5% celery juice powder (CJP, based on meat weight) and a cure accelerator (sodium erythorbate 0 or 547 ppm or cherry powder at 0.4% meat weight). Beef (90/10, pack date 5 Jul. 2019) was used as the met source for manufacturing frankfurters (Table 17). Frankfurter emulsions were produced via a bowl chopper: Beef, water, curing agent (L-arginine or sodium nitrite), cure accelerator (sodium erythorbate or cherry powder) and water were blended and chopped at 2000 rpm for one minute. The remaining nonmeat ingredients were added (except the antimicrobial) and chopped at 2000 rpm for one minute. Protecta (sodium acetate antimicrobial) was added and the emulsion chopped at 4000 rpm for one minute. The emulsion was evacuated and placed into a vacuum assisted stuffer where each test emulsion was stuffed and twist linked into 22 mm cellulose casings weighing 40 g each. The frankfurter links were hung on smokehouse trucks, placed into a commercial smokehouse and thermally processed to 160° F (Table 18).

TABLE 17
Frankfurters manufactured with low (1000 ppm) and high
(5000 ppm) L-arginine with no added (0 ppm) or added
(~547 ppm) sodium erythorbate (cure accelerator).
Low (1000 ppm) and high (5000 ppm) L-Arginine.
No sodium erythorbate added.

| | | 1 | | 2 |
|---|---|---|---|---|
| | 1 | % in | 2 | % in |
| Dry Ingredients | GRAMS | Product | GRAMS | Product |
| Salt | 108.86 | 1.80% | 108.86 | 1.80% |
| L-Arginine | 6.05 | 0.10% | 30.22 | 0.50% |
| Total | 114.92 | 1.90% | 139.08 | 2.30% |
| | | %/PPM in | | %/PPM in |
| Liquid Ingredients | GRAMS | product | GRAMS | product |
| Ice Water | 1699.19 | 28.10% | 1673.78 | 27.70% |
| Total | 1699.19 | 30.00% | 1673.78 | 30.00% |
| Total Brine Weight | 1814.10 | 1000 ppm | 1812.86 | 5000 ppm |

Low (1000 ppm) and high (5000 ppm) L-Arginine
with sodium erythorbate added.

| | | 3 | | 4 |
|---|---|---|---|---|
| | 3 | % in | 4 | % in |
| Dry Ingredients | GRAMS | Product | GRAMS | Product |
| Salt | 108.64 | 1.80% | 108.86 | 1.80% |
| L-Arginine | 6.05 | 0.10% | 30.21 | 0.50% |
| Total | 114.69 | 1.90% | 139.07 | 2.30% |
| Restricted Ingredients | GRAMS | %/PPM | GRAMS | %/PPM |
| Sodium Erythorbate | 3.29 | 0.065% | 3.29 | 0.055% |
| (547 ppm) | | | | |
| Total | 3.29 | 0.065% | 3.29 | 0.055% |
| | | %/PPM in | | %/PPM in |
| Liquid Ingredients | GRAMS | product | GRAMS | product |
| Ice Water | 1696.46 | 28.05% | 1669.2 | 27.64% |
| Total | 1696.46 | 30.00% | 1669.2 | 30.00% |
| Total Brine Weight | 1814.44 | 1000 ppm | 1811.6 | 5000 ppm |

Meat and seasoning formulation to
manufacture frankfurters with test brines.

| | GRAMS |
|---|---|
| Meat | |
| Beef-90/10 | 6046.49 |
| Restricted Ingredients | |
| Phosphate (0.35%; 3500 ppm) | 20.64 |
| Seasonings | |
| Soy Protein Concentrate | 90.72 |
| Potato Starch | 122.47 |
| Corn Syrup Solids | 122.47 |
| Dextrose | 36.36 |
| MSG | 3.03 |
| Onion Powder | 1.51 |
| Garlic Powder | 1.13 |
| Antimicrobial | |
| Antimicrobial | 22.68 |

TABLE 18
Thermal processing schedule for frankfurter manufacture.

| | | | | | Internal | | | | | |
|---|---|---|---|---|---|---|---|---|---|---|
| | | | Dry Bulb | Wet Bulb | Temperature | Blower/Fan | | Water | Smoke | Smoke |
| Step | Time | | (F) | (F) | (F) | Speed | Damper | Humidity | Pre-Heat | Generator |
| 1 | 30 | min | 120 | 100 | | On-50 | | ON | ON | |
| 2 | 20 | min | 130 | 110 | | On-50 | ON | ON | | ON |
| 3 | 20 | min | 140 | 120 | | On-50 | ON | ON | | ON |
| 4 | 20 | min | 160 | 140 | | On-50 | ON | ON | | ON |
| 5 | | | 180 | 160 | 160 | On-50 | | | | |
| 6 | 2 | min | 160 | | | On-50 | | | | |
| 7 | | | Shower | | 100 | | | | | |

After thermal processing and chilling (40° F), the casings were peeled from the frankfurters and were vacuum packaged and stored under refrigerated conditions for residual nitrite and nitrosylation. The residual nitrite levels (Table 19) for L-arginine treated frankfurters after 7 days of storage ranged from 8.02 to 15.87 ppm, with almost twice as much found in the samples that included sodium erythorbate. The NOS system efficiency was increased by addition of a cure accelerant. This product contained of 30% added ingredients—water and nonmeat ingredients. This was done to determine if the L-arginine could the NOS system to generate sufficient NO for cure color development and residual nitrite for antioxidant and antimicrobial effect. Cure color (nitrosylation) for L-arginine frankfurters ranged from 43.64 to 59.68 percent, indicating the formation of the cure color pigment nitroso-hemochromagen.

TABLE 19
Least squares means for residual nitrite and nitrosylation for test frankfurters.

| | | Cure | | | Total | |
|---|---|---|---|---|---|---|
| Concentration | | Accelerator | Nitrite | NO-Heme | Heme | Nitrosylation ⁴ |
| (ppm) | Cure | (ppm/%) | (ppm)¹ | (ppm)² | (ppm)³ | (%) |
| n = 18 | | | | | | |
| 1000 | 0 | 0 | 8.02^{d} | 17.79^{b} | 41.71^{a} | 43.64^{a} |
| 5000 | 0 | 0 | 10.64^{cd} | 27.94^{a} | 52.81^{a} | 54.26^{a} |
| 1000 | 0 | 547 | 13.43^{bc} | 23.59^{ab} | 40.35^{a} | 59.68^{a} |
| 5000 | 0 | 547 | 15.87^{b} | 28.32^{a} | 51.00^{a} | 55.59^{a} |
| 0.50% | Celery | Cherry | 11.97^{c} | 16.43^{b} | 82.05^{a} | 93.54^{b} |
| | Juice | Powder, 0.4% | | | | |
| | Powder | | | | | |
| 156 | Sodium | Sodium | 21.27^{a} | 17.88^{b} | 79.11^{a} | 94.93^{b} |
| | Nitrite | Erythorbate, | | | | |
| | | 547 ppm | | | | |
| SEM⁵ | | | 0.76 | 2.73 | 13.48 | 25.08 |

¹ppm = absorbance level × standard curve slope (1.7438) × dilution factor (200)
²NO-heme pigment concentration (ppm acid hematin) = sample A₅₄₀ × 290.
³Total heme pigment concentration (ppm acid hematin) = sample A₆₄₀ × 680
⁴ Percentage nitrosylation = (ppm NO-hemochrome/ppm total pigment) × 100
^{ab}LSMeans within a column with different superscripts are different (P < 0.05)
⁵SEM: Standard error of the mean (largest) of the least squares means

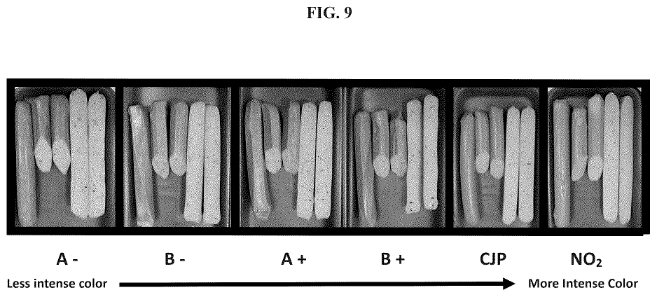

The frankfurters cured with celery juice powder or sodium nitrite had 11.97 and 21.27 ppm respectively which was significantly higher than all concentrations of the L-arginine/sodium erythorbate treatments as well as higher percent nitrosylation—93.53 and 94.93% respectively, resulting in a more intense cured meat color. Cure color is also demonstrated in FIG. 9.

FIG. 9 shows the color of low (A) and high concentrations of beef frankfurters with and without sodium erythorbate. Low (A-1000 ppm) and high (B-5000 ppm) L-arginine with (~547 ppm-“+”) or without (0 ppm “−”) added sodium erythorbate (cure accelerator) compared to naturally cured/uncured celery juice powder (CJP 0.5%, with cherry juice powder 0.4%, as cure accelerator) and sodium nitrite cured (NO₂, 156 ppm) with sodium erythorbate (547 ppm) cure accelerator frankfurters.

For conventionally cured meat products (cured with direct addition of sodium nitrite) the following ingoing amounts of sodium nitrite are required for these effects: 30-50 ppm for strong and stable cure color; 20-60 ppm for nitrite to act as an indirect antioxidant; and 80-140 ppm as effective hurdle against growth of Salmonella, Staphylococcus aureus, and Clostridium botulinum. The residual amount of nitrite is considerably lower compared to the amount of nitrite initially added to the product, making its control more difficult. About 10%-20% of the added nitrite could be analytically detected in cured meat immediately after processing (Cassens, 1997) [15, 27, 28]. Since this discovery focuses on ingoing ppm of L-arginine rather that ingoing ppm of sodium nitrite to generate NO and NO₂, the determination of residual nitrite is one method to compare differences and similarities among curing treatments. Frankfurters cured with celery juice powder or sodium nitrite with 547 ppm of a cure accelerator generated ~12 and 18 ppm residual sodium nitrite respectively. The frankfurters made with either 1000 or 5000 ppm L-arginine with 547 ppm of a cure accelerator generated 13 and 16 ppm residual sodium nitrite respectively. Both L-arginine treatments generated more residual nitrite than the celery juice powder cure treatment while the 500 ppm L-arginine treatment was similar to the 156 ppm ingoing sodium nitrite cure treatment. However, the celery juice powder and sodium nitrite curing treatments were significantly higher in percent nitrosylation, indicating that the cure color development is not as efficient. This can be seen in FIG. 9.

The take home message from these tests are:
1. The NOS system is functional in post rigor meat
2. Addition of 1000 or 5000 ppm L-arginine generates NO and residual NO₂
3. Addition of a cure accelerator enhances NO and residual nitrite generation by the NOS system
4. Curing meat via activation of the NOS system via L-arginine addition appears to be a feasible curing method

Additional studies need to investigate if L-arginine curing system can maintain cure color stability, and provide antioxidant and/or antimicrobial properties compared to meat products manufactured via celery juice powder or sodium nitrite.

### Example 13

### The Nitric Oxide Synthase System Producing Nitric Oxide in Post Rigor Semimembranosus Pork Muscles

Cured meat products are formed by the conversion of nitrite to nitric oxide by addition of heat, preserving the meat and developing a cured meat color. The activation of the Nitric Oxide Synthase (NOS) by L-arginine can be used to form nitrite and be measured for cured meat color and residual nitrite formation. Pre- and post-rigor Semimembranosus muscles were treated with varying concentrations of L-arginine solutions, then analyzed for residual nitrite in raw, cooked, and cooked pellet samples, and nitrosylation in cooked samples.

### Materials and Methods

Experimental design Pre-rigor pork semimembranosus muscle samples were collected from four pre-rigor pork carcasses (n=4) harvested at the Rosenthal Meat Science and Technology Center at Texas A&M University at three separate times over a three day period (N=12). Post-rigor pork semimembranosus muscle samples were collected from the same carcasses eighteen hours after harvesting to ensure the full onset and completion of rigor (N=12). Muscle samples were treated with the same five concentrations of L-arginine and water as the control treatment. Samples were either heated (water bath increasing from room temperature (~24° C) to 62° C for 60 min) or left raw/fresh (uncooked). The overall experiment was designed as a 6 (5 L-arginine concentrations and a control) by 4 (pork carcasses) by 2 (heating treatment (raw and cooked)) factorial replicated 3 times (collection) (N=144) for both pre-rigor and post-rigor muscle types.

Immersion/stabilization phase reagent preparation Solutions were prepared by Wu's specifications [101] to stabilize the muscle samples for enclosed reactions within 50 mL conical tubes. Each 50 mL conical tube contained 72 mg sodium chloride (NaCl) (granular USP, FCC, Avantor-Macron Fine Chemicals) and 576 ppm sodium erythorbate (NaE) (FCC, Spectrum Chemical), in 8 mL deionized water. The NaCl was used to suspend and stabilize any reaction and the NaE was used to accelerate the cure reaction. The L-arginine (L-arginine monohydrochloride, Ajinomoto Inc., Raleigh, NC) concentrations were prepared separately for administration as a treatment once the five grams of meat were added to the reaction tubes at dilutions of 0 mM, 2 mM, 4 mM, 8 mM 16 mM, and 32 mM.

Sample collection, preparation, and treatment Pre-rigor semimembranosus muscles were collected from four pork carcasses (left side of each carcass) at three different harvest times across three days approximately one hour after exsanguination. The post-rigor semimembranosus muscles were collected from the same four pork carcasses (right side of each carcass) approximately eighteen hours after exsanguination across three days. The semimembranosus muscle was used in this study due to its myoglobin and mitochondria concentrations within the skeletal muscle, accessing the nitric oxide synthase (NOS) system and nitric oxide generation for viability of reaction. Pre-rigor samples were aseptically excised (60-75 g) from the left side of the semimembranosus muscle, using the aitch bone as the reference point, while the post-rigor samples were aseptically excised (60-75 g) from the right side of the semimembranosus muscle eighteen hours after harvest. The muscle samples were transported to the research lab within the Rosenthal Meat Science Center where any excess connective tissue and fat was removed.

### Treatment of Pre-Rigor and Post-Rigor Semimembranosus Muscles

Raw Muscle Samples The stabilization and reaction procedures for the samples were modified from Wu [101]. Twenty-four 5 g muscle samples were individually placed to 50 mL conical tubes. A total of 24, 5 g samples were produced for each of the 6 concentrations of treatments. Each tube contained 8 mL of 0.9% NaCl and 576 ppm sodium erythorbate solution. After the muscle samples were added to the tubes, 2 mL of the deionized, distilled water (control), or one of the five L-arginine solutions was added. The L-arginine solution activated the NOS system to generate NO and residual nitrite through reaction in immersion. After two hours of immersion, the samples were reweighed for percent solution pickup and then transferred to new 50 mL centrifuge conical tubes with 25 mL of a 0.9% NaCl solution to stabilize the samples and cease any further reactions. Raw (unheated) samples were then homogenized after transfer for 30 sec at 7000 rpm (Kinematica Polytron Pt-10-35 GT Homogenizer, Kinematica Inc, Bohemia, NY). Samples were spun down in a centrifuge at 4500×g for ten minutes at 4° C until the supernatant was clear. (Avanti J-25 Centrifuge with JA 17 Rotor, Beckman Coulter Inc., Atlanta, GA). The supernatant was collected with a pipette at a minimum volume of 10 mL and transferred to a 15 mL centrifuge tube. The supernatant was tested for pH by benchtop pH meter before being stored at −30° C.

Cooked Muscle Samples Muscle samples that were heated followed the same protocol as described for raw (unheated) samples but placed in a water bath after transfer and cooked from 27° C to 62° C internal temperature within one hour to simulate a hot dog cycle. Internal temperature was monitored using a thermocouple probe (HH501BT Type T Thermometer, Omega Engineering Inc., Norwalk, CT). Once cooked, all samples were weighed for percent solution pickup and then subjected to the same procedures as the raw samples. The supernatant and residual pellet were stored at −30° C until analyzed for nitrosylation.

pH assessment Initial pre-rigor (approximately one hour after exsanguination) and post-rigor (approximately eighteen hours after exsanguination) muscle sample pH was taken before the muscle samples were dissected into 5 g samples for treatment (5-7 minutes after excision from carcass) was taken via a handheld pH probe. Supernatant were used to determine final pH after immersion was taken with a glass probe (probe was placed into tube directly to not dilute sample further from already diluted levels from deionized water). pH of raw and cooked samples was determined using a benchtop pH meter (VWR Symphony 810, VWR International) with a glass probe (VWR Symphony Red Tip Reference Probe, VWR International Radnor, PA).

Residual nitrite assessment The supernatant for raw and cooked samples of both pre-rigor and post-rigor were analyzed for residual nitrite after deproteinization by sample preparation for amino acid analysis by HPLC [102]. Determination of nitrite (UV/VIS Spectrophotometric Method) was used for detecting any residual nitrite formed within the enclosed system.

Cure efficiency assessment Cooked meat samples were analyzed for the degree of nitrosylation through residual nitrite from the Pearson and Tauber [109]method from the modified Hornsey's [22] procedure for analyzing small samples [103] from the supernatant and pellet. 2 mL or 2 g of the samples were treated with acetone to measure NO-heme concentration and for total heme concentration, 2 mL or 2 g of the samples were treated with acetone and hydrochloric acid. Both samples were measured using a spectrophotometer (2100 Series Spectrophotometer, Unico, Dayton, NJ) and a 1 cm quartz cuvette. NO-heme concentration (ppm acid hematin) was read at 540 nm, and total heme concentration (ppm acid hematin) was determined at 640 nm to determine nitrosylation as the indication of the effectiveness of L-arginine in curing the samples. This procedure measured the conversion levels of myoglobin to nitrosohemochromagen, the cured meat color, and the amount of conversion as compared to the total pigmentation within the sample.

Statistical analysis Data was analyzed by JMP software for Least Square Means and ANOVA with P=0.05 to determine significant main effects (arginine concentration, nitrosylation). Least squares means were calculated to determine significant main effects, and significant differences were determined by Tukey's HSD with P<0.05. Sample analyses were conducted in triplicate and the experiment was replicated three times.

### Results

Percent pickup and pH Initial muscle samples for pH (Table 20) was slightly lower than the sample pH after the immersion phase (5.87 and 5.61 respectively) but was not significantly different (5.51-6.04) even with the addition of alkaline L-arginine (pH of 7.2 to 8.2) [104]. Percent sample weight pickup was determined after two hours of immersion in the L-arginine, sodium erythorbate, and NaCl for raw (unheated samples). Percent pickup for the cooked samples was determined after two hours of immersion and approximately one hour of cooking to an internal temperature of 62° C and cooling to room temperature. Post rigor percent pickup was determined in the same way as pre-rigor samples after eighteen hours of rigor onset. The pickup percentages of both pre-rigor and post-rigor raw and cooked samples across all L-arginine concentrations (0-32 mM) were not significantly different. Percent solution pickup provides information as to the ability of L-arginine to activate the Nitric Oxide Synthase system.

TABLE 20
Least Square Means of Initial and Immersion pH of Carcass
Samples and Percent Solution of Raw and Cooked Pre-rigor
and Post rigor Semimembranosus Pork Muscles

| | | | | | Post rigor | | |
|---|---|---|---|---|---|---|---|
| | | Car- | Pre-rigor | | Car- | | |
| Variable | | cass | Raw | Cooked | cass | Raw | Cooked |
| n | | 12 | 72 | 72 | 12 | 72 | 72 |
| Initial pH | | 5.87 | | | 5.61 | | |
| SEM¹ | | 0.08 | | | 0.04 | | |
| pH after 2 | | | | | | | |
| hours of | | | | | | | |
| sample immersion | | | | | | | |
| 0 | mM | | 5.91^{a} | 5.97^{a} | | 5.54^{a} | 5.75^{a} |
| 2 | mM | | 5.94^{a} | 6.03^{a} | | 5.52^{a} | 5.77^{a} |
| 4 | mM | | 6.04^{a} | 6.01^{a} | | 5.52^{a} | 5.75^{a} |
| 8 | mM | | 5.93^{a} | 5.99^{a} | | 5.53^{a} | 5.66^{a} |
| 16 | mM | | 5.91^{a} | 6.00^{a} | | 5.53^{a} | 5.75^{a} |
| 32 | mM | | 5.93^{a} | 5.97^{a} | | 5.56^{a} | 5.76^{a} |
| SEM¹ | | | 0.07 | 0.04 | | 0.02 | 0.04 |
| Sample Pickup, % | | | | | | | |
| 0 | mM | | 22.93^{a} | 25.81^{a} | | 27.69^{a} | 20.83^{a} |
| 2 | mM | | 22.99^{a} | 26.75^{a} | | 29.10^{a} | 20.59^{a} |
| 4 | mM | | 24.21^{a} | 27.46^{a} | | 28.22^{a} | 21.81^{a} |
| 8 | mM | | 20.99^{a} | 25.56^{a} | | 28.37^{a} | 21.60^{a} |
| 16 | mM | | 23.04^{a} | 29.33^{a} | | 28.29^{a} | 21.17^{a} |
| 32 | mM | | 24.84^{a} | 26.55^{a} | | 28.18^{a} | 21.64^{a} |

| | | | | |
|---|---|---|---|---|
| SEM¹ | 1.40 | 1.36 | 2.36 | 1.86 |

¹SEM: Standard error of the mean (largest) of the least squares means
^{ab}LSMeans within a main effect and column with different superscripts are significantly different (P < 0.05)

### Residual Nitrite Values for Supernatant (Raw and Cooked) and Pellet (Cooked) Samples

Residual nitrite was determine using the modified AOAC Official Method 973.31 (Nitrite Analysis in Cured Meats Procedure) and was verified by Wu [101, 102, 105] with sample (plasma or serum) preparation for amino acid analysis by HPLC and determination of nitrite (UV/VIS Spectrophotometric Method) [102]. This method was used to best determine any residual nitrite found in samples to compensate for both pre-rigor and post rigor effects on detecting residual nitrite. All samples were tested one week later after being held in a −30° C freezer then thawed in a 0° C cooler.

Residual nitrite for pre-rigor raw muscle sample supernatant (Table 21) shows that all concentrations of L-arginine (11.92-44.58 ppm) were significantly higher than the control (0.26 ppm), but not significantly different among the five concentrations. The range of residual nitrite generated by the NOS system at each L-arginine concentration indicates the variability of the NOS system in generating residual nitrite through the varying L-arginine concentrations. There is also evidence of a bimodal trend in the maximum at 8 mM, decrease in 16 mM, and increase in 32 mM, suggesting another possible maximum outside of the L-arginine treatments.

TABLE 21
Least Squares Means for Residual Nitrite of Raw Pre-rigor and Post
rigor Semimembranosus Muscles Supernatant Generated by the Nitric
Oxide Synthase System at Various L-Arginine Concentrations

| | | Residual | Residual | Range of |
|---|---|---|---|---|
| | | Pre-rigor | Post rigor | Residual |
| Concentration | | Nitrite (ppm)¹ | Nitrite (ppm)¹ | Nitrite (ppm) |
| n | | 72 | 72 | |
| 0 | mM | 0.26^{b} | 2.06^{b} | 0, 7.32 |
| 2 | mM | 15.26^{a} | 9.42^{a} | 0.35, 20.22 |
| 4 | mM | 34.93^{a} | 14.50^{a} | 0, 43.94 |
| 8 | mM | 44.58^{a} | 21.83^{a} | 0.35, 141.50 |
| 16 | mM | 11.92^{a} | 23.54^{a} | 0.70, 104.28 |
| 32 | mM | 22.09^{a} | 16.51^{a} | 0.70, 76.38 |

| | | |
|---|---|---|
| SEM² | 17.33 | 5.52 |

¹ppm = absorbance level × standard curve slope (1.7438) × dilution factor (200)
²SEM: Standard error of the mean (largest) of the least squares means
^{ab}LSMeans within a main effect and column with different superscripts are significantly different (P < 0.05)

The residual nitrite means of the supernatant of raw post rigor samples are reported in Table 21. All concentrations of L-arginine had significantly higher residual nitrite levels (9.06-23.54 ppm) compared to the control (2.06 ppm). The L-arginine concentrations however were not significantly different between each other with 8 and 16 mM generating the highest residual nitrite values. The lower residual nitrite values for post rigor muscle samples indicates that the NOS system may not be as efficient in converting L-arginine to residual nitrite and NO. Sample storage conditions can affect results as noted by Cassens et al. [15, 27, 28] and Keeton et al. [25]

TABLE 22
Least Squares Means for Residual Nitrite of Cooked
Pre-rigor and Post rigor Semimembranosus Muscles
Supernatant Generated by the Nitric Oxide Synthase
System at Various L-Arginine Concentrations

| | | Residual | Residual | Range of |
|---|---|---|---|---|
| | | Pre-rigor | Post rigor | Residual |
| Concentration | | Nitrite (ppm)¹ | Nitrite (ppm)¹ | Nitrite (ppm) |
| n | | 72 | 72 | |
| 0 | mM | 1.25^{b} | 4.21^{b} | 0, 14.65 |
| 2 | mM | 50.72^{a} | 61.12^{a} | 0.35, 211.69 |
| 4 | mM | 47.72^{ab} | 61.93^{a} | 0.70, 227.04 |
| 8 | mM | 38.63^{ab} | 52.69^{ab} | 0.70, 172.64 |
| 16 | mM | 24.62^{ab} | 53.74^{a} | 1.05, 163.92 |
| 32 | mM | 20.08^{ab} | 52.90^{ab} | 1.05, 179.96 |

| | | |
|---|---|---|
| SEM² | 28.15 | 11.87 |

¹ppm = absorbance level × standard curve slope (1.7438) × dilution factor (200)
²SEM: Standard error of the mean (largest) of the least squares means
^{ab}LSMeans within a main effect and column with different superscripts are significantly different (P < 0.05)

Residual nitrite means of the supernatant of the cooked pre- and post-rigor samples are reported in Table 22. The 2 mM concentration for pre-rigor had the highest significant level of residual nitrite (50.72 ppm), while 4 mM (47.72 ppm), 8 mM (38.63 ppm), 16 mM (24.62 ppm), and 32 mM (20.08 ppm) were not significantly different from each other. Pre-rigor muscle tended to generate less residual nitrite indicating that heating may have enhanced the conversion of nitrite to nitric oxide. For post-rigor muscle 2 mM (61.12 ppm), 4 mM (61.93 ppm), and 16 mM (53.74) had higher residual nitrite levels compared to the other treatments and the control.

The 8 mM (52.69 ppm) and 32 mM (52.90 ppm) treatments were different. There is evidence of a bimodal effect in certain lower concentrations of L-arginine found in live tissue endogenous use, suggesting that more variation in residual nitrite generation at different L-arginine concentrations would be observed compared to post-rigor muscle samples [3, 101].

TABLE 23
Least Squares Means for Residual Nitrite of Cooked Pre-rigor and
Post rigor Semimembranosus Muscles Pellet Generated by the Nitric
Oxide Synthase System at Various L-Arginine Concentrations

| | | Residual | Range of |
|---|---|---|---|
| | Residual Pre- | Post rigor | Residual |
| | rigor Nitrite | Nitrite | Nitrite |
| Concentration | (ppm)¹ | (ppm)¹ | (ppm) |
| n | 72 | 72 | |
| 0 mM | 10.75^{b} | 11.02^{b} | 6.63, 15.69 |
| 2 mM | 22.87^{a} | 19.36^{b} | 8.37, 40.11 |
| 4 mM | 22.64^{a} | 23.72^{ab} | 9.42, 34.18 |
| 8 mM | 19.70^{a} | 22.06^{ab} | 13.25, 28.95 |
| 16 mM | 31.94^{a} | 22.15^{ab} | 9.07, 183.10 |
| 32 mM | 40.14^{a} | 32.87^{a} | 12.21, 175.43 |
| SEM² | 7.74 | 3.11 | |

¹ppm = absorbance level × standard curve slope (1.7438) × dilution factor (200)
²SEM: Standard error of the mean (largest) of the least squares means
^{ab}LSMeans within a main effect and column with different superscripts are significantly different (P < 0.05)

The residual nitrite amounts for cooked pre- and post-rigor pellet samples (Table 23) were lower compared to the raw and cooked supernatant samples (Table 22). All L-arginine treatments were exhibited higher residual nitrite than the control (10.75 ppm and 11.02 ppm respectively). Overall, pre-rigor pellet samples were not significantly different from one another, with the highest level at 32 mM (40.14 ppm). For post-rigor pellet samples, 4 mM (23.72 ppm), 8 mM (22.06 ppm), and 16 mM (22.15 ppm) were significantly different from the control (11.02 ppm) but not from each other. The 32 mM concentration of L-arginine yielded the highest residual nitrite level (32.87 ppm). The lower levels of residual nitrite in pre- and post-rigor cooked pellet samples compared to the pre- and post-rigor cooked supernatant samples (Table 3) is to due the conversion of nitrite to nitric oxide due to the heating process. It has been reported that cooking may result in the loss of 20 to 80% of the available nitrite [18].

Pigmentation and Curing Efficiency for Cooked Samples Curing efficiency or nitrosylation is calculated as the percentage conversion of NO-heme to total heme. Cure efficiency is the percentage of total pigment converted to nitroso pigment and indicates the degree of cured color fading [22]. Cured meat pigment is extracted in a solution of 80% acetone and 20% water that extracts cured pigment heme. Total heme pigments are extracted using an acidified acetone solution that extracts heme from all heme proteins as first used by Hornsey [22]. NO-heme concentration (as ppm acid hematin)=sample A₅₄₀×290 determines the specific cure color pink from the rest of the heme pigmentation of the sample. Total heme concentration (ppm acid hematin)=sample A₆₄₀×680 determines the total heme pigmentation of the sample. Cure efficiency (%)=(ppm of nitrosoheme+ppm of total pigment)×100 and indicates how much of the product is cured and holds the cured pink stability once cooked [22, 103].

The nitrosylation or curing efficiency for pre-rigor supernatant samples are found in Table 24. There were differences between all cooked supernatant samples and the control for NO-heme, total heme, and nitrosylation, while there were little differences noted between L-arginine concentrations.

TABLE 24
Least Squares Means for NO-Heme, Total Heme, and
Percent Nitrosylation (Cure Efficiency) of Cooked
Pre-rigor Pork Semimembranosus Muscles Supernatant
Generated by the Nitric Oxide Synthase System
at Various L-Arginine Concentrations

| | NO-Heme | Total Heme | Nitrosylation |
|---|---|---|---|
| Concentration | (ppm)¹ | (ppm)² | (%)³ |
| n | 72 | | |
| 0 mM | 16.07^{b} | 32.41^{b} | 49.42^{b} |
| 2 mM | 26.02^{ab} | 50.43^{a} | 60.23^{a} |
| 4 mM | 28.17^{ab} | 40.86^{a} | 70.03^{a} |
| 8 mM | 32.98^{a} | 45.11^{a} | 75.71^{a} |
| 16 mM | 22.45^{ab} | 42.05^{a} | 55.02^{a} |
| 32 mM | 27.67^{ab} | 44.94^{a} | 66.20^{a} |
| SEM⁴ | 4.01 | 4.85 | 8.99 |

¹NO-heme pigment concentration (ppm acid hematin) = sample A₅₄₀ × 290.
²Total heme pigment concentration (ppm acid hematin) = sample A₆₄₀ × 680
³Percentage nitrosylation = (ppm NO-hemochrome/ppm total pigment) × 100
^{ab}LSMeans within a column with different superscripts are significantly different (P < 0.05)
⁴SEM: Standard error of the mean (largest) of the least squares means

The 2 mM (26.02 ppm), 4 mM (28.17 ppm), 16 mM (22.45 ppm), and 32 mM concentrations were significantly different from the control (16.07 ppm) but not from each other. For NO-heme. The overall nitrosylation levels are high enough to indicate formation of the nitrosohemachromagen “cured pink color” within the samples, indicating that L-arginine addition can activate the NOS system to produce nitric oxide at these concentrations.

Table 25 shows the NO-heme, total heme, and nitrosylation of cooked pre-rigor pellet samples. The NO-heme and nitrosylation were both significantly different from the control but not different from each concentration. The total heme values were different between the control (33.83 ppm) and all L-arginine concentrations, with the highest total heme concentration at 16 mM (123.31 ppm). However, there were no significant differences between the 2 mM (61.48 ppm), 4 mM (52.07 ppm), 8 mM (80.07 ppm), and 32 mM (53.72 ppm) concentrations.

TABLE 25
Least Squares Means for NO-Heme, Total Heme, and
Percent Nitrosylation (Cure Efficiency) of Cooked
Pre-rigor Pork Semimembranosus Muscles Pellet
Generated by the Nitric Oxide Synthase System
at Various L-Arginine Concentrations

| | NO-Heme | Total Heme | Nitrosylation |
|---|---|---|---|
| Concentration | (ppm)¹ | (ppm)² | (%)³ |
| n | 72 | | |
| 0 mM | 8.94^{b} | 33.83^{b} | 37.10^{b} |
| 2 mM | 19.02^{a} | 61.48^{ab} | 52.09^{a} |
| 4 mM | 18.82^{a} | 52.07^{ab} | 49.31^{a} |
| 8 mM | 16.38^{a} | 80.07^{ab} | 31.43^{a} |
| 16 mM | 26.56^{a} | 123.31^{a} | 55.29^{a} |
| 32 mM | 33.37^{a} | 53.72^{ab} | 86.11^{a} |
| SEM⁴ | 6.52 | 19.73 | 17.69 |

¹NO-heme pigment concentration (ppm acid hematin) = sample A₅₄₀ × 290.
²Total heme pigment concentration (ppm acid hematin) = sample A₆₄₀ × 680
³Percentage nitrosylation = (ppm NO-hemochrome/ppm total pigment) × 100
^{ab}LSMeans within a column with different superscripts are significantly different (P < 0.05)
⁴SEM: Standard error of the mean (largest) of the least squares means

Post rigor supernatant samples for NO-heme, total heme, and nitrosylation are represented in Table 26. All concentrations for NO-heme, total heme, and Nitrosylation had significant differences from the control (15.13 ppm, 39.67 ppm, and 56.16% respectively), but no differences were observed between L-arginine concentrations. There was a higher concentration observed for NO-heme, total heme, and nitrosylation at the 32 mM concentration.

TABLE 26
Least Squares Means for NO-Heme, Total Heme, and
Percent Nitrosylation (Cure Efficiency) of Cooked
Post rigor Pork Semimembranosus Muscles Supernatant
Generated by the Nitric Oxide Synthase System
at Various L-Arginine Concentrations

| | NO-Heme | Total Heme | Nitrosylation |
|---|---|---|---|
| Concentration | (ppm)¹ | (ppm)² | (%)³ |
| n | 72 | | |
| 0 mM | 15.13^{b} | 39.67^{b} | 56.16^{b} |
| 2 mM | 23.76^{a} | 64.43^{a} | 61.38^{a} |
| 4 mM | 22.81^{a} | 73.33^{a} | 55.90^{a} |
| 8 mM | 25.98^{a} | 62.90^{a} | 79.27^{a} |
| 16 mM | 20.54^{a} | 54.46^{a} | 52.33^{a} |
| 32 mM | 25.50^{a} | 59.73^{a} | 104.27^{a} |
| SEM⁴ | 3.91 | 12.67 | 17.66 |

¹NO-heme pigment concentration (ppm acid hematin) = sample A₅₄₀ × 290.
²Total heme pigment concentration (ppm acid hematin) = sample A₆₄₀ × 680
³Percentage nitrosylation = (ppm NO-hemochrome/ppm total pigment) × 100
^{ab}LSMeans within a column with different superscripts are significantly different (P < 0.05)
⁴SEM: Standard error of the mean (largest) of the least squares means

Table 27 represents the NO-heme, total heme, and nitrosylation of post rigor pellet samples. The total heme and nitrosylation were both significantly different for all concentrations from the control but not significantly different from each other. The NO-heme had the highest concentration of the nitrosohemochromagen pigment at the 32 mM concentration (27.33 ppm) while the 4 mM (19.72 ppm), 8 mM (18.34 ppm), and 16 mM (18.42 ppm) concentrations were all significantly different from the control (9.16 ppm) but not different from each other.

TABLE 27
Least Squares Means for NO-Heme, Total Heme, and
Percent Nitrosylation (Cure Efficiency) of Cooked
Post rigor Pork Semimembranosus Muscles Pellet
Generated by the Nitric Oxide Synthase System
at Various L-Arginine Concentrations

| | NO-Heme | Total Heme | Nitrosylation |
|---|---|---|---|
| Concentration | (ppm)¹ | (ppm)² | (%)³ |
| n | 72 | | |
| 0 mM | 9.16^{b} | 66.13^{b} | 30.46^{b} |
| 2 mM | 16.10^{b} | 62.56^{a} | 31.22^{a} |
| 4 mM | 19.72^{ab} | 67.72^{a} | 35.19^{a} |
| 8 mM | 18.34^{ab} | 63.58^{a} | 35.53^{a} |
| 16 mM | 18.42^{ab} | 51.68^{a} | 62.80^{a} |
| 32 mM | 27.33^{a} | 85.11^{a} | 34.51^{a} |
| SEM⁴ | 2.57 | 13.35 | 8.72 |

¹NO-heme pigment concentration (ppm acid hematin) = sample A₅₄₀ × 290.
²Total heme pigment concentration (ppm acid hematin) = sample A₆₄₀ × 680
³Percentage nitrosylation = (ppm NO-hemochrome/ppm total pigment) × 100
^{ab}LSMeans within a column with different superscripts are significantly different (P < 0.05)
⁴SEM: Standard error of the mean (largest) of the least squares means

### Discussion

Results of this study indicate that the Nitric Oxide Synthase System (NOS) system is still viable in pre- and post-rigor muscle samples. The system can still generate nitric oxide for the use of curing the meat of the semimembranosus muscle, even after one week of storage. Cooked samples held more residual nitrite overall, correlating with the lower levels of nitrosylation due to not converting to nitrosohemochromagen compared to the previous study done on pre-rigor muscle samples.

The levels of nitrite produced by both pre-rigor and post rigor were higher than the previous study, indicating the effect of storage time on the depletion of residual nitrite [18]. These average levels with the higher L-arginine concentrations can color the meat to a characteristic cured “pink” color for minimum of 1 ppm to cure poultry and 4 ppm to cure pork shoulders [106] while showing a trend to have the higher residual nitrite levels (50-60 ppm) to cure meat for antimicrobial properties [31]. These levels work in correlation with pH, salt concentration, reductants, and iron content to protect against Staphylococcus aureus and Clostridium botulinum, C. botulinum spores, and subsequent toxin production from these spores 70 ppm residual nitrite is reached [31, 32].

Based upon the data for pre-rigor and post-rigor samples of pork semimembranosus muscles with the same applied L-arginine concentrations as previously described pre-rigor study, there is significant evidence that the Nitric Oxide Synthase system produces nitric oxide in pre-rigor muscle and post-rigor meat [94]. The shift from the existing research in the NOS system found in human and animal metabolism [3, 58, 59, 71, 75, 98, 107] requires a focus on the mechanism of the NOS system for nitric oxide generation across all meat producing livestock [6, 94, 99]. The duration of ageing meat should be tested next to verify the viability of the NOS system outside of the post-rigor muscle phase (i.e. past 18 hours to the average ages of meats used in current cured meat products). L-arginine at higher concentrations should also be tested to verify the theory of a maximum efficiency of L-arginine outside of the concentrations used in this study. This would verify the efficiency of the Nitric Oxide Synthase system as an alternative curing method within meat itself without exhausting the system and rendering it ineffective to produce its own nitric oxide.

### Example 14

### No Erythorbate—Low AA—10% Addition

Composition and Brine composition. The amino acid used may be L-arginine, L-citrulline, or a combination thereof. Phosphate and cure accelerator (sodium erythorbate or cherry powder) and/or additional ingredients may be added separately.

TABLE 28

| | | | | Boneless | Cure |
|---|---|---|---|---|---|
| | | 10% Pump | | ham | Ingredients |
| AA Test Brine | lbs | g | 10% | ppm | % |
| water | 77.5 | 35219.88 | 7.75 | | |
| Commercial Cure | | | | | |
| Blend | | | | | |
| salt | 18 | 8180.1 | 1.80 | | 80.00 |
| Amino acid | 1 | 454.45 | 0.10 | 1000 | 4.44 |
| sugar | 3.5 | 1590.575 | 0.35 | | 15.56 |
| | 22.5 | | | | 100 |
| Total | 100 | | 10.00 | | |

### Example 15

### No Erythorbate—Low AA—20% Addition

Composition and Brine composition. The amino acid used may be L-arginine, L-citrulline, or a combination thereof. Phosphate and cure accelerator (sodium erythorbate or cherry powder) and/or additional ingredients may be added separately.

TABLE 29

| | | | | Boneless | Cure |
|---|---|---|---|---|---|
| | | 20% Pump | | ham | Ingredients |
| AA Test Brine | lbs | g | 20% | ppm | % |
| water | 88.75 | 40332.44 | 17.75 | | |
| Commercial Cure | | | | | |
| Blend | | | | | |
| salt | 9.00 | 4090.05 | 1.80 | | 80.00 |
| Amino acid | 0.50 | 227.23 | 0.10 | 1000 | 4.44 |
| sugar | 1.75 | 795.29 | 0.35 | | 15.56 |
| | 11.25 | | | | 100.00 |
| Total | 100 | | 20.00 | | |

### Example 16

### No Erythorbate—Low AA—30% Addition

Composition and Brine composition. The amino acid used may be L-arginine, L-citrulline, or a combination thereof. Phosphate and cure accelerator (sodium erythorbate or cherry powder) and/or additional ingredients may be added separately.

TABLE 30

| | | | | | Cure |
|---|---|---|---|---|---|
| | | 30% Pump | | | Ingredients |
| AA Test Brine | lbs | g | 30% | ppm | % |
| water | 92.50 | 42036.63 | 27.75 | | |
| Commercial Cure | | | | | |
| Blend | | | | | |
| salt | 6.00 | 2726.70 | 1.80 | | 80.16 |
| Amino acid | 0.34 | 152.24 | 0.10 | 1005.15 | 4.48 |
| sugar | 1.15 | 522.62 | 0.35 | | 15.36 |
| | 7.49 | | | | 100.00 |
| Total | 99.99 | | 30 | | |

### Example 17

### No Erythorbate—Low AA—40% Addition

Composition and Brine composition. The amino acid used may be L-arginine, L-citrulline, or a combination thereof. Phosphate and cure accelerator (sodium erythorbate or cherry powder) and/or additional ingredients may be added separately.

TABLE 31

| | | | | | Cure |
|---|---|---|---|---|---|
| | | 40% Pump | | | Ingredients |
| AA Test Brine | lbs | g | 40% | ppm | % |
| water | 94.2 | 42809.19 | 37.75 | | |
| Commercial Cure | | | | | |
| Blend | | | | | |
| salt | 4.5 | 2045.03 | 1.80 | | 80.07 |
| Amino acid | 0.25 | 113.61 | 0.10 | 1001.80 | 4.45 |
| sugar | 0.87 | 395.37 | 0.35 | | 15.48 |
| | 5.62 | | | | 100.00 |
| Total | 99.82 | | 40 | | |

### Example 18

### No Erythorbate—Low AA—50% Addition

Composition and Brine composition. The amino acid used may be L-arginine, L-citrulline, or a combination thereof. Phosphate and cure accelerator (sodium erythorbate or cherry powder) and/or additional ingredients may be added separately.

TABLE 32

| | | | | | Cure |
|---|---|---|---|---|---|
| | | 50% Pump | | | Ingredients |
| AA Test Brine | lbs | g | 50% | ppm | % |
| water | 95.00 | 43172.75 | 47.75 | | |
| Commercial Cure | | | | | |
| Blend | | | | | |
| salt | 3.58 | 1626.93 | 1.80 | | 79.91 |
| Amino acid | 0.20 | 90.89 | 0.10 | 1005.23 | 4.46 |
| sugar | 0.70 | 318.12 | 0.35 | | 15.63 |
| | 4.48 | | | | 100.00 |
| Total | 99.48 | | 50 | | |

### Example 19

### No Erythorbate—High AA—10% Addition

Composition and Brine composition. The amino acid used may be L-arginine, L-citrulline, or a combination thereof. Phosphate and cure accelerator (sodium erythorbate or cherry powder) and/or additional ingredients may be added separately.

TABLE 33

| | | | | Boneless | Cure |
|---|---|---|---|---|---|
| | | 10% Pump | | loin | Ingredients |
| AA Test Brine | lbs | g | 20% | ppm | % |
| water | 73.50 | 33402.08 | 7.35 | | |
| Commercial Cure | | | | | |
| Blend | | | | | |
| salt | 18.00 | 8180.10 | 1.80 | | 67.92 |
| Amino acid | 5.00 | 2272.25 | 0.50 | 5000 | 18.87 |
| sugar | 3.50 | 1590.58 | 0.35 | | 13.21 |
| | 26.50 | | | | 100 |
| Total | 100 | | 10.00 | | |

### Example 20

### No Erythorbate—High AA—20% Addition

Composition and Brine composition. The amino acid used may be L-arginine, L-citrulline, or a combination thereof. Phosphate and cure accelerator (sodium erythorbate or cherry powder) and/or additional ingredients may be added separately.

TABLE 34

| | | | | Boneless | Cure |
|---|---|---|---|---|---|
| | | 20% Pump | | loin | Ingredients |
| AA Test Brine | lbs | g | 20% | ppm | % |
| water | 86.75 | 39423.54 | 17.35 | | |
| Commercial Cure | | | | | |
| Blend | | | | | |
| salt | 9.00 | 4090.05 | 1.80 | | 67.92 |
| Amino acid | 2.50 | 1136.13 | 0.50 | 5000 | 18.87 |
| sugar | 1.75 | 795.29 | 0.35 | | 13.21 |
| | 13.25 | | | | 100 |
| Total | 100 | | 20.00 | | 500 |

### Example 21

### No Erythorbate—High AA—30% Addition

Composition and Brine composition. The amino acid used may be L-arginine, L-citrulline, or a combination thereof. Phosphate and cure accelerator (sodium erythorbate or cherry powder) and/or additional ingredients may be added separately.

TABLE 35

| | | | | | Cure |
|---|---|---|---|---|---|
| | | 30% Pump | | | Ingredients |
| AA Test Brine | lbs | g | 30% | ppm | % |
| water | 91.00 | 41354.95 | 27.35 | | |
| Commercial Cure | | | | | |
| Blend | | | | | |
| salt | 6.00 | 2726.70 | 1.80 | | 68.03 |
| Amino acid | 1.67 | 758.93 | 0.50 | 5019.03 | 18.93 |
| sugar | 1.15 | 522.62 | 0.35 | | 13.04 |
| | 8.82 | | | | 100 |
| Total | 99.82 | | 30 | | 499.1 |

### Example 22

### No Erythorbate—High AA—40% Addition

Composition and Brine composition. The amino acid used may be L-arginine, L-citrulline, or a combination thereof. Phosphate and cure accelerator (sodium erythorbate or cherry powder) and/or additional ingredients may be added separately.

TABLE 36

| | | | | | Cure |
|---|---|---|---|---|---|
| | | 40% Pump | | | Ingredients |
| AA Test Brine | lbs | g | 40% | ppm | % |
| water | 93.25 | 42377.46 | 37.34 | | |
| Commercial Cure | | | | | |
| Blend | | | | | |
| salt | 4.50 | 2045.03 | 1.80 | | 67.87 |
| Amino acid | 1.25 | 568.06 | 0.50 | 5006.01 | 18.85 |
| sugar | 0.88 | 399.92 | 0.35 | | 13.27 |
| | 6.63 | | | | 100.00 |
| Total | 99.88 | | 40 | | |

### Example 23

### No Erythorbate—High AA—50% Addition

Composition and Brine composition. The amino acid used may be L-arginine, L-citrulline, or a combination thereof. Phosphate and cure accelerator (sodium erythorbate or cherry powder) and/or additional ingredients may be added separately.

TABLE 37

| | | | | | Cure |
|---|---|---|---|---|---|
| | | 50% Pump | | | Ingredients |
| AA Test Brine | lbs | g | 50% | ppm | % |
| water | 94.00 | 42718.30 | 47.35 | | |
| Commercial Cure | | | | | |
| Blend | | | | | |
| salt | 3.58 | 1626.93 | 1.80 | | 67.93 |
| Amino acid | 1.00 | 454.45 | 0.50 | 5036.77 | 18.98 |
| sugar | 0.69 | 313.57 | 0.35 | | 13.09 |
| | 5.27 | | | | 100.00 |
| Total | 99.27 | | 50 | | |

### Example 24

TABLE 38
Cure ingredient Formulation Percent Ingredient Ranges

| | Percent Pump | | | | | | | | | |
|---|---|---|---|---|---|---|---|---|---|---|
| | 10% | 10% | 20% | 20% | 30% | 30% | 40% | 40% | 50% | 50% |
| | Ingoing ppm L-Arginine | | | | | | | | | |
| | 1000 ppm | 5000 ppm | 1000 ppm | 5000 ppm | 1000 ppm | 5000 ppm | 1000 ppm | 5000 ppm | 1000 ppm | 5000 ppm |
| salt | 80.00 | 67.92 | 80.00 | 67.92 | 80.16 | 68.03 | 80.07 | 67.87 | 79.91 | 67.93 |
| Amino acid | 4.44 | 18.87 | 4.44 | 18.87 | 4.48 | 18.93 | 4.45 | 18.85 | 4.46 | 18.98 |
| sugar | 15.56 | 13.21 | 15.56 | 13.21 | 15.36 | 13.04 | 15.48 | 13.27 | 15.63 | 13.09 |
| Targets | | | | | | | | | | |
| Salt | 1.80% | | | | | | | | | |
| Sugar | 0.35% | | | | | | | | | |

| | | |
|---|---|---|
| L-Arginine | 1000 and 5000 ppm | 0.1 and 0.5% |

### Example 25

### An Amino Acid Alternative Curing System for Beef Frankfurters—September to December 2020

The efficacy of an amino acid based alternative curing system compared to a conventional curing system (direct addition of sodium nitrite) was evaluated in Beef Frankfurters. Beef frankfurters containing 156 ppm sodium nitrite (conventional curing) and beef frankfurters manufactured using three amino acid concentrations will be evaluated for cured color intensity, cured color stability, lipid oxidation, volatiles and aerobic plate counts. This research addresses the safety and quality attributes of a novel “no sodium nitrite” meat curing system.

Sodium nitrite is added to processed meat products to maintain microbial quality, flavor, color and shelf stability. Consumer demand for natural and organic products has increased due to concerns of the health risks associated with the addition of synthetic additives (i.e., sodium nitrite). Currently, no effective single replacement ingredient possessing the functional properties of sodium nitrite has been identified. Our proposed research investigates the efficacy of curing meat via the addition of a specific amino acid used in previous benchtop laboratory studies and small scale non-replicated pilot plant manufacture.

Consumer behavior and purchasing trends of processed meat products have varied significantly in recent years. Documents published by the WHO-IARC have recommended the classification of cured meat products containing sodium nitrite as carcinogenic according to the World Health Organization International Agency for Research on Cancer in 2015. Although cured meat products provide a slight portion of one's dietary intake of nitrites, the human body can produce nitrite in two different mechanisms. The first mechanism is endogenous and is referred to as the nitric oxide synthase pathway, or NOS. The second mechanism is through dietary consumption, which is exogenous [110]. Due to these concerns, a demand for a safe, high-quality, processed meat product has increased with all-natural labels [111]. Sodium nitrite is vital to develop cure color and flavor and provide shelf stability and antimicrobial properties [24]. Thus, researchers have sought out to find a substitute for sodium nitrite to cure meat products. There is no single ingredient that exists to replace the functional properties of sodium nitrite. Current research at Texas A&M University has indicated that the use of arginine activates the nitric oxide synthase system in meat to generate nitric oxide and residual nitrite in pork semimembranosus muscle, resulting in the development of cured meat color without the direct addition of sodium nitrite [112]. However, this alternative curing system has not been evaluated in replicated pilot plant manufacturing studies.

This project was introduced to examine the hypothesis that the amino acid curing agent's application to all-beef frankfurters will be equivalent too, if not exceed, the physicochemical and biological attributes of an all-beef frankfurter cured with sodium nitrite. Thus, resulting in no significant difference in the meat product's overall microbial properties or quality. Therefore, the project's objective is to assess the ability of a novel amino acid alternative curing system to cure (generation of nitric oxide and residual nitrite) all-beef frankfurters compared to conventionally cured (sodium nitrite) all-beef frankfurters.

The objective of this study is to evaluate the efficacy of an amino acid based alternative curing system to generate nitric oxide and residual nitrite compared to a conventional curing system (direct addition of sodium nitrite). Our research hypothesis is that the amino acid based curing system will generate similar amounts of nitric oxide and residual nitrite compared to conventional sodium nitrite curing in beef frankfurters.

### Product Manufacture

Batches (~13 kg) of a standard beef frankfurter emulsion will be manufactured with selected arginine concentrations (1,000, 2,500 or 5000 ppm) with either 0 or 547 ppm of sodium erythorbate (cure accelerator) and compared to two conventionally cured (sodium nitrite 156 ppm, 0 or 547 ppm sodium erythorbate) beef frankfurters controls. After thermal processing and chilling according to USDA-FSIS Appendix A—Thermal processing (71° C) and B—Cooling procedures (2° C) guidelines, the frankfurters will be vacuum packaged and stored under refrigeration (2° C) until analyzed at 0, 14, 28 and 56 days post manufacture.

TABLE 39
L-Arginine curing treatment compositions for Beef Frankfurters

| | Frankfurters | | | | |
|---|---|---|---|---|---|
| L-Arginine Treatments | lbs | g | oz | ppm | percent |
| T-3000 | | | | | |
| Meat | 25.000 | 11361.250 | 400.000 | | |
| Water | 2.500 | 1136.125 | 40.000 | | 10% |
| Seasonings w/salt/ | 0.875 | 397.644 | 14.000 | | |
| erythorbate | | | | | |
| Amino acid | 0.075 | 34.084 | 1.200 | 3000.00 | |
| Phosphate | 0.088 | 39.764 | 1.400 | 3500.00 | |
| Total | 28.538 | | | | |
| T-4000 | | | | | |
| Meat | 25.000 | 11361.25 | 400.00 | | |
| Water | 2.500 | 1136.13 | 40.00 | | 10% |
| Seasonings w/salt/ | 0.875 | 397.64 | 14.00 | | |
| erythorbate | | | | | |
| Amino acid | 0.100 | 45.45 | 1.60 | 4000.00 | |
| Phosphate | 0.088 | 39.76 | 1.40 | 3500.00 | |
| Total | 28.563 | | | | |
| T-5000 | | | | | |
| Meat | 25.000 | 11361.25 | 400.00 | | |
| Water | 2.500 | 1136.13 | 40.00 | | 10% |
| Seasonings w/salt/ | 0.875 | 397.64 | 14.00 | | |
| erythorbate | | | | | |
| Amino acid | 0.125 | 56.81 | 2.00 | 5000.00 | |
| Phosphate | 0.088 | 39.76 | 1.40 | 3500.00 | |
| Total | 28.588 | | | | |
| Sodium Nitrite Control | | | | | |
| Meat | 25.000 | 11361.25 | 400.00 | | |
| Water | 2.500 | 1136.13 | 40.00 | | 10% |
| Seasonings w/salt/ | 0.875 | 397.64 | 14.00 | | |
| erythorbate | | | | | |
| Sodium nitrite | 0.063 | 28.40 | 1.00 | 156.25 | |
| (Prague powder) | | | | | |
| Phosphate | 0.088 | 39.76 | 1.40 | 3500.00 | |
| Total | 28.525 | | | | |

### Sample Analyses for Each Storage Day (Days 1, 7, 14, 28 and 56)

Residual nitrite assessment. The samples were analyzed for residual nitrite after deproteinization by sample preparation for amino acid analysis by HPLC.

Cure efficiency assessment. Cooked meat samples were analyzed for the degree of nitrosylation. Samples will be analyzed at 540 nm for NO-heme concentration and 640 nm for total heme concentration to determine the conversion of myoglobin to nitrosohemochromagen

Internal/external color. Cooked samples were evaluated for L(lightness), a(redness), b (yellowness) color scores using a Hunterlab MiniScan XE, calibrated with white and black tiles.

Water Activity. Cooked sample water activity was measured (in triplicate) using an Aqualab Model Series 3 water activity meter.

Aerobic Plate Counts. Samples were serially diluted and aseptically plated onto 2 sets of Petri film (3M® Microbiology, St. Paul, MN). One set of aerobic count (AC) films will be incubated for 48 hours at 35° C before enumeration to quantify aerobic mesophiles. One set of AC petrifilms will be incubated for 7 days at 4° C to quantify aerobic psychrotrophs.

Thiobarbituric acid reactive substances (TBARS test for lipid oxidation. Duplicate ten gram ground be samples were added to a 125 ml poly bottles containing 50 ml of distilled deionized water. Five ml of Propyl Gallate and 5 ml of EDTA was added to each sample and then the sample was homogenized at 15,000 RPM for 1 minute, using a high shear homogenizer. The homogenized 66 ml meat sample and additional 31.5 ml of distilled deionized water was added to a 500 ml kjeldahl distillation flask containing five to six glass boiling beads and 2.5 ml of 4N HCl. The kjeldahl flask was connected to the distillation unit and allowed to distill until 50 ml of distillate was collected. The 50 ml of distillate was transferred into 50 ml centrifuge tubes and stored covered from light at 4° C for no longer than 18 hrs. Five ml of the distillate and 5 ml of 0.02M TBA solution was added to 50 ml screw cap test tubes in duplicate and heated (water batch) at 100° C for 35 min. Following heating the solution was cooled and then pipetted onto a 96 well plate to be read at 532 nm on a Bio-Tek microplate reader within 1 hour. pH determination. Ten grams of powdered sample was blended with 90 mL of distilled deionized water for pH determination using a glass probe (VWR Symphony Red Tip Reference Probe, VWR International Radnor, PA and benchtop pH meter (VWR Symphony 810, VWR International Radnor, PA). The benchtop pH meter was calibrated using a three point calibration with pH buffer solutions of 4, 7, and 10.

Proximate composition (Moisture, Fat, Protein, and Ash). Moisture and fat content was determined on cooked samples (in triplicate) using a CEM Smart Trac 5 system. Protein was determined using a LECO F-528 Nitrogen analyzer.

### Statistical Analyses

The experiment was designed as a 2 (0 or 547 sodium erythorbate)×3 (arginine concentrations) randomized complete block comparing the novel amino acid beef frankfurter curing treatments (6) to two beef frankfurter controls (156 ppm sodium nitrite; 0 and 547 ppm sodium erythorbate). Samples were vacuum packaged and refrigerated and evaluated on Day 1, 7, 14, 28 and 56 post manufacture. Differences between treatment and control samples will be determined using Tukey's Least Significant Difference procedure at P<0.05 level. The experiment was replicated three times.

TABLE 40
Raw means for pH values of L-arginine treated and
sodium nitrite treated frankfurters

| | | Day | | | |
|---|---|---|---|---|---|
| Treatments | PPM | 1 | 7 | 14 | 28 |
| L-arginine | | | | | |
| 1 | 3000 | 5.91 | 5.86 | 6.02 | 6.06 |
| 2 | 4000 | 5.92 | 5.90 | 5.96 | 6.00 |
| 3 | 5000 | 5.87 | 5.92 | 5.94 | 6.01 |
| Control | | | | | |
| Sodium Nitrite | 156 | 5.94 | 5.95 | 5.97 | 6.02 |

TABLE 41
Raw means for water activity (Aw) values of L-arginine
treated and sodium nitrite treated frankfurters

| | | Day | | | |
|---|---|---|---|---|---|
| Treatments | PPM | 1 | 7 | 14 | 28 |
| L-arginine | | | | | |
| 1 | 3000 | 0.979 | 0.978 | 0.976 | 0.982 |
| 2 | 4000 | 0.979 | 0.982 | 0.975 | 0.975 |
| 3 | 5000 | 0.982 | 0.957 | 0.972 | 0.976 |
| Control | | | | | |
| Sodium Nitrite | 156 | 0.979 | 0.979 | 0.972 | 0.978 |

TABLE 42
Raw means for color (L, a, b) values of L-arginine
treated and sodium nitrite treated frankfurters

| | | | Day | | | |
|---|---|---|---|---|---|---|
| Treatments | PPM | | 1 | 7 | 14 | 28 |
| L-arginine | | | | | | |
| 1 | 3000 | | | | | |
| | Internal | L | 55.96 | 55.85 | 57.34 | 57.36 |
| | | a | 6.68 | 6.81 | 7.01 | 6.92 |
| | | b | 15.70 | 14.74 | 14.84 | 14.58 |
| | External | L | 42.67 | 42.49 | 44.08 | 44.00 |
| | | a | 13.40 | 14.64 | 13.11 | 12.99 |
| | | b | 26.26 | 24.18 | 24.46 | 22.86 |
| 2 | 4000 | | | | | |
| | Internal | L | 56.59 | 56.62 | 56.95 | 57.10 |
| | | a | 6.50 | 6.32 | 6.82 | 7.01 |
| | | b | 15.61 | 14.75 | 14.76 | 14.49 |
| | External | L | 42.95 | 43.05 | 44.15 | 43.77 |
| | | a | 13.02 | 14.09 | 13.23 | 12.75 |
| | | b | 25.57 | 25.34 | 24.50 | 23.05 |
| 3 | 5000 | | | | | |
| | | L | 56.64 | 56.65 | 57.47 | 55.83 |
| | | a | 6.47 | 6.46 | 6.95 | 7.08 |
| | | b | 14.85 | 14.84 | 15.12 | 14.53 |
| | External | L | 41.97 | 43.68 | 44.74 | 42.09 |
| | | a | 13.24 | 13.98 | 12.67 | 13.25 |
| | | b | 26.00 | 24.84 | 24.02 | 23.66 |
| Control | | | | | | |
| Sodium Nitrite | 156 | | | | | |
| | Internal | L | 54.68 | 55.69 | 55.65 | 55.02 |
| | | a | 15.09 | 14.51 | 14.66 | 14.72 |
| | | b | 12.55 | 11.94 | 12.12 | 11.78 |
| | External | L | 41.92 | 45.09 | 43.67 | 43.43 |
| | | a | 24.82 | 22.74 | 22.66 | 23.69 |
| | | b | 26.24 | 23.35 | 23.67 | 24.60 |

Color scores based on 100 point scale.
L = whiteness; a = redness; b = yellowness

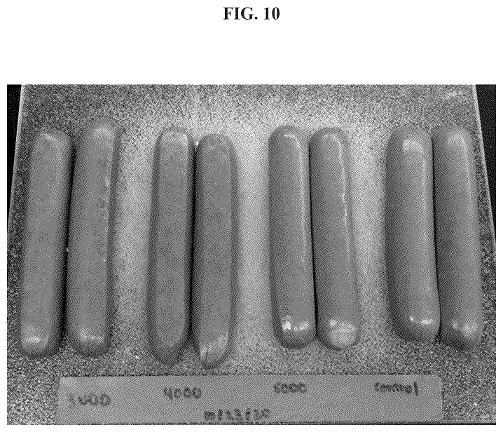

FIG. 10 shows the external color of L-arginine treated and sodium nitrite treated beef frankfurters.

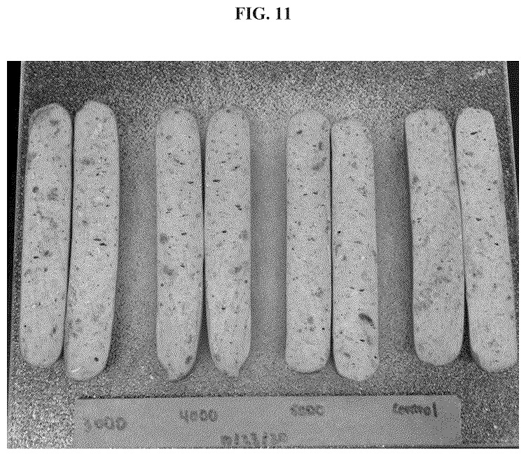

FIG. 11 shows the internal color of L-arginine treated and sodium nitrite treated beef frankfurters.

TABLE 43
Raw means for residual sodium nitrite values of L-arginine
treated and sodium nitrite treated beef frankfurters

| | | Day | | | |
|---|---|---|---|---|---|
| Treatments | PPM | 1 | 7 | 14 | 28 |
| L-arginine | | | | | |
| 1 | 3000 | 55.90 | 55.83 | 62.60 | 58.68 |
| 2 | 4000 | 49.92 | 60.36 | 53.71 | 79.07 |
| 3 | 5000 | 73.95 | 61.77 | 52.91 | 100.11 |
| Control | | | | | |
| Sodium Nitrite | 156 | 85.05 | 74.53 | 121.03 | 73.73 |

TABLE 44
Raw means for TBA values (indicator of lipid oxidation) for
L-arginine treated and sodium nitrite treated frankfurters

| | | Day | | | |
|---|---|---|---|---|---|
| Treatments | PPM | 1 | 7 | 14 | 28 |
| L-arginine | | | | | |
| 1 | 3000 | 0.540 | 1.000 | 1.056 | 1.158 |
| 2 | 4000 | 0.577 | 0.745 | 0.839 | 0.718 |
| 3 | 5000 | 0.501 | 0.773 | 0.854 | 0.894 |
| Control | | | | | |
| Sodium Nitrite | 156 | 0.456 | 0.659 | 0.701 | 0.860 |

TBA values of 1.0 indicate initial lipid oxidation/rancidity.

TABLE 45
Raw means for aerobic plate count (APC) values for L-arginine
treated and sodium nitrite treated frankfurters

| | | Day | | | |
|---|---|---|---|---|---|
| Treatments | PPM | 1 | 7 | 14 | 28 |
| L-arginine | | | | | |
| 1 | 3000 | 3.29 | 3.37 | 3.54 | 4.78 |
| 2 | 4000 | 2.84 | 3.57 | 3.36 | 5.68 |
| 3 | 5000 | 2.93 | 3.39 | 3.46 | 3.81 |
| Control | | | | | |
| Sodium Nitrite | 156 | 3.08 | 3.98 | 3.53 | 4.07 |

APC values reported as Log/Colony Forming Units (CFU)/g.

Table 44 and Table 45 indicate shelf life and microbial stability are not compromised. In one embodiment, the present invention contemplates a method of extending the shelf life of a meat product.

### Example 26

### Establishing a Residual Nitrite Equivalency Scale

### Objective

The objective of this study was to assess the ability of L-arginine (L-arginine HCL, Ajinomoto) to generate residual sodium nitrite (RNO₂) compared to sodium nitrite in post rigor beef, pork and poultry samples. The goal is to develop reference scale that provides data to determine what concentrations of L-arginine are comparable to sodium nitrite (Prague Powder) concentrations in generating a similar amount of residual nitrite in ground beef, pork and poultry samples heated to three different endpoint temperatures.

### Methods

Fresh ground meat (beef, pork or poultry) was separated in ~0.5 Kg batches and mixed with 2% salt and 10% added water. Appropriate amounts of sodium nitrite (120, 156 or 200 ppm) or L-arginine (1000, 2000, 3000, 4000 or 5000 ppm) with (Phase I) or without (Phase II) a cure accelerator (sodium erythorbate at 547 ppm). Each individual batch was mixed (1 min) in a food processor, removed for temperature and pH analyses and then placed into a jerky extruder tube. Approximately 25 g of sample were extruded into 50 mL centrifuge, then capped and labeled and placed into a controlled water batch and heated to a designated internal endpoint temperature (132, 158, or 165° F).

Sodium nitrite (Prague Powder; 93.75% NaCl and 6.25% sodium nitrite) was used to incorporate three regulatory approved concentrations of sodium nitrite (120, 156 and 200 ppm) into ground beef pork and poultry samples (~25 g each). Samples also contained 547 ppm sodium erythorbate, a cure accelerator (Phase I) and without sodium erythorbate (Phase II). Samples were placed into test tubes and heated in a controlled water bath to 132, 158 and 165° F. Samples were held in a 40° F cooler for seven days then tested for residual nitrite. Residual nitrite was tested after deproteinization for amino acid analysis by HPLC. Determination of nitrite (UV/VIS Spectrophotometric Method) was used to detect any residual nitrite for best results in detecting minute amounts of nitrite. Residual nitrite levels were read in a 96 well plate reader at 540 nm.

Both phases of the experiment were designed as a factorial (concentration level and endpoint temperature) randomized complete block design with three replications. Observations for sodium nitrite treated samples were based on 3 species×3 concentrations×2 test samples per concentration×4 independent readings×3 replications=216 observations for each species type for Phase I and Phase II. Observations for L-arginine treated samples were based on 3 species×5 concentrations×2 test samples per concentration×4 independent readings×3 replications=360 observations for each for species type for Phase I and Phase II. Least squares means were generated and Tukey's HSD used to determine significance at P<0.05.

Key Findings from this Study were:

L-arginine treated samples generated similar residual nitrite levels compared to sodium nitrite treated samples across all L-arginine concentrations and all species (beef, pork, poultry) when sodium erythorbate was used, except for poultry samples containing 200 ppm sodium nitrite (Table 46, Table 47, Table 48, Table 52, Table 53, Table 54, and Summary Table A: Table 58).

L-arginine concentrations at 1000, 2000 and 3000 ppm appear to generate similar residual nitrite values compared to sodium nitrite concentrations of 120, 156 and 200 ppm for all species (beef, pork poultry) when sodium erythorbate was used, except for poultry samples containing 200 ppm sodium nitrite (Table 46, Table 47, Table 48, Table 52, Table 53, Table 54, and Summary Table A: Table 58).

Higher concentrations of L-arginine (4000 and 5000 ppm) in samples resulted in lower residual nitrite values when sodium erythorbate was used compared to lower L-arginine concentrations. This is in part due to better conversion of residual nitrite to NO (required for cured color development), resulting in less residual sodium nitrite.

L-arginine treated samples were consistently lower in residual nitrite values compared to sodium nitrite treated samples when no cure accelerator (sodium erythorbate) was included

The effect of temperature (132, 158 and 165° F) on generation of residual nitrite was mixed for both sodium nitrite and L-arginine treated samples, with temperature being confounded with concentration (concentration×temperature interaction) or the main effect of temperature was not significant for either treatment (pork). Temperature significantly impacted residual nitrite values of beef (L-arginine samples only) and poultry (sodium nitrite samples only)

### CONCLUSION

Results of this study indicate that in the presence of a cure accelerator, L-arginine concentration of 1000, 2000 and 3000 ppm results in the activation of the nitric oxide synthase system to generate residual nitrite values comparable to sodium nitrite concentrations of 120, 156 and 200 ppm. Without the use of a cure accelerator, all L-arginine concentrations generated lower residual nitrite values compared to sodium nitrite treated samples.

TABLE 46
Least Squares Means for Main Effects of Concentration and Temperature and the Two Way Interaction of
Concentration and Temperature for Residual Nitrite Levels in Sodium Nitrite Beef Samples (Phase I)³

| n = 216 | Residual Nitrite (ppm)¹ | | | | |
|---|---|---|---|---|---|
| Concentration | 120 ppm | 156 ppm | 200 ppm | SEM² | p-value |
| | 75.33 | 81.08 | 72.05 | 6.94 | 0.6451 |
| Temperature | 132 °F | 158 °F | 165 °F | | |
| | 104.42^{a} | 61.54^{b} | 62.50^{b} | 7.09 | <0.0001 |
| Conc × Temp | 120 ppm | 156 ppm | 200 ppm | | |
| 132 °F | 119.32^{a} | 107.54^{ab} | 86.41^{abc} | 12.66 | 0.0238 |
| 158 °F | 60.08^{bc} | 77.51^{abc} | 47.02^{c} | | |
| 165 °F | 46.59^{c} | 58.18^{bc} | 82.73^{ab} | | |

¹ppm = absorbance level × standard curve slope (1.7438) × dilution factor (200)
²SEM: Standard error of the mean (largest) of the least squares means
³With 547 ppm sodium erythorbate
^{a-b}LSMeans for each main effect within a row with different superscripts by row different (P < 0.05)
^{a-c}LSMeans for each significant main effect two way interaction within each row and column with different superscripts are different (P < 0.05)

TABLE 47
Least Squares Means for Main Effects of Concentration and Temperature and the Two Way Interaction of
Concentration and Temperature for Residual Nitrite Levels in Sodium Nitrite Pork Samples (Phase I)³

| n = 216 | Residual Nitrite (ppm)¹ | | | | |
|---|---|---|---|---|---|
| Concentration | 120 ppm | 156 ppm | 200 ppm | SEM² | p-value |
| | 42.30^{b} | 62.37^{a} | 68.22^{a} | 6.11 | 0.0045 |
| Temperature | 132 °F | 158 °F | 165 °F | | |
| | 63.03 | 48.21 | 61.66 | 5.54 | 0.1115 |
| Conc × Temp | 120 ppm | 156 ppm | 200 ppm | | |
| 132 °F | 58.68 | 66.93 | 63.47 | 10.58 | 0.0610 |
| 158 °F | 41.15 | 46.37 | 57.10 | | |
| 165 °F | 27.07 | 73.82 | 84.08 | | |

¹ppm = absorbance level × standard curve slope (1.7438) × dilution factor (200)
²SEM: Standard error of the mean (largest) of the least squares means
³With 547 ppm sodium erythorbate
^{a-b}LSMeans for each main effect within a row with different superscripts by row different (P < 0.05)

TABLE 48
Least Squares Means for Main Effects of Concentration and Temperature and the Two Way Interaction of
Concentration and Temperature for Residual Nitrite Levels in Sodium Nitrite Poultry Samples (Phase I)³

| n = 216 | Residual Nitrite (ppm)¹ | | | | |
|---|---|---|---|---|---|
| Concentration | 120 ppm | 156 ppm | 200 ppm | SEM² | p-value |
| | 64.56^{b} | 78.51^{ab} | 90.59^{a} | 4.30 | 0.0002 |
| Temperature | 132 °F | 158 °F | 165 °F | | |
| | 84.75^{a} | 79.98^{ab} | 68.93^{b} | 4.30 | 0.0303 |
| Conc × Temp | 120 ppm | 156 ppm | 200 ppm | | |
| 132 °F | 66.48 | 80.52 | 107.26 | 7.45 | 0.3816 |
| 158 °F | 68.47 | 85.36 | 86.10 | | |
| 165 °F | 58.74 | 69.65 | 78.41 | | |

¹ppm = absorbance level × standard curve slope (1.7438) × dilution factor (200)
²SEM: Standard error of the mean (largest) of the least squares means
³With 547 ppm sodium erythorbate
^{a-b}LSMeans for each main effect within a row with different superscripts by row different (P < 0.05)

TABLE 49
Least Squares Means for Main Effects of Concentration and Temperature and the Two Way Interaction of
Concentration and Temperature for Residual Nitrite Levels in Sodium Nitrite Beef Samples (Phase II)³

| Concentration | | | | | |
|---|---|---|---|---|---|
| n = 216 | Residual Nitrite (ppm)¹ | | | | |
| Concentration | 120 ppm | 156 ppm | 200 ppm | SEM² | p-value |
| | 182.18 | 202.15 | 196.51 | 9.27 | 0.2891 |
| Temperature | 132 °F | 158 °F | 165 °F | | |
| | 190.58 | 207.32 | 182.94 | 9.88 | 0.1388 |
| Conc × Temp | 120 ppm | 156 ppm | 200 ppm | | |
| 132 °F | 187.92 | 199.54 | 184.28 | 18.13 | 0.3861 |
| 158 °F | 204.95 | 214.72 | 202.30 | | |
| 165 °F | 153.68 | 192.19 | 202.96 | | |

¹ppm = absorbance level × standard curve slope (1.7438) × dilution factor (200)
²SEM: Standard error of the mean (largest) of the least squares means
³Without 547 ppm sodium erythorbate

TABLE 50
Least Squares Means for Main Effects of Concentration and Temperature and the Two Way Interaction of
Concentration and Temperature for Residual Nitrite Levels in Sodium Nitrite Pork Samples (Phase II)³

| n = 216 | Residual Nitrite (ppm)¹ | | | | |
|---|---|---|---|---|---|
| Concentration | 120 ppm | 156 ppm | 200 ppm | SEM² | p-value |
| | 214.53^{a} | 183.17^{b} | 172.38^{b} | 7.57 | 0.0002 |
| Temperature | 132 °F | 158 °F | 165 °F | | |
| | 192.61 | 186.00 | 185.85 | 7.48 | 0.6573 |
| Conc × Temp | 120 ppm | 156 ppm | 200 ppm | | |
| 132 °F | 173.70^{ab} | 208.65^{ab} | 196.48^{ab} | 13.24 | 0.0480 |
| 158 °F | 178.90^{ab} | 166.20^{b} | 232.01^{a} | | |
| 165 °F | 164.54^{b} | 174.67^{ab} | 215.08^{ab} | | |

¹ppm = absorbance level × standard curve slope (1.7438) × dilution factor (200)
²SEM: Standard error of the mean (largest) of the least squares means
³Without 547 ppm sodium erythorbate
^{a-b}LSMeans for each main effect within a row with different superscripts by row different (P < 0.05)
^{a-b}LSMeans for each significant main effect two way interaction within each row and column with different superscripts are different (P < 0.05)

TABLE 51
Least Squares Means for Main Effects of Concentration and Temperature and the Two Way Interaction of
Concentration and Temperature for Residual Nitrite Levels in Sodium Nitrite Poultry Samples (Phase II)³

| n = 216 | Residual Nitrite (ppm)¹ | | | | |
|---|---|---|---|---|---|
| Concentration | 120 ppm | 156 ppm | 200 ppm | SEM² | p-value |
| | 160.83^{c} | 181.93^{b} | 220.86^{a} | 5.03 | <0.0001 |
| Temperature | 132 °F | 158 °F | 165 °F | | |
| | 207.82^{a} | 183.34^{b} | 172.46^{b} | 5.32 | <0.0001 |
| Conc × Temp | 120 ppm | 156 ppm | 200 ppm | | |
| 132 °F | 171.64^{cde} | 202.54^{bc} | 249.27^{a} | 9.64 | 0.0133 |
| 158 °F | 148.63^{e} | 177.54^{cde} | 223.86^{ab} | | |
| 165 °F | 162.23^{de} | 165.70^{cde} | 189.46^{cd} | | |

¹ppm = absorbance level × standard curve slope (1.7438) × dilution factor (200)
²SEM: Standard error of the mean (largest) of the least squares means
³Without 547 ppm sodium erythorbate
^{a-c}LSMeans for each main effect within a row with different superscripts by row different (P < 0.05)
^{a-e}LSMeans for each significant main effect two way interaction within each row and column with different superscripts are different (P < 0.05)

TABLE 52
Least Squares Means for Main Effects of Concentration and Temperature
and the Two Way Interaction of Concentration and Temperature for Residual
Nitrite Levels in L-Arginine Beef Samples (Phase I)³

| | Residual Nitrite (ppm)¹ | | | | | | |
|---|---|---|---|---|---|---|---|
| n = 320 | | | | | | | |
| Concentration | 1000 ppm | 2000 ppm | 3000 ppm | 4000 ppm | 5000 ppm | SEM² | p-value |
| | 75.81^{a} | 74.96^{a} | 73.42^{a} | 69.45^{a} | 48.27^{b} | 4.02 | <0.0001 |
| Temperature | 132 °F | 158 °F | 165 °F | | | | |
| | 75.28^{a} | 71.90^{a} | 57.96^{b} | | | 3.09 | 0.0002 |
| Conc × Temp | 1000 ppm | 2000 ppm | 3000 ppm | 4000 ppm | 5000 ppm | | |
| 132 °F | 85.37 | 82.58 | 78.11 | 72.90 | 57.48 | 7.08 | 0.1557 |
| 158 °F | 76.56 | 66.33 | 84.73 | 83.35 | 48.52 | | |
| 165 °F | 65.51 | 75.98 | 57.42 | 52.11 | 38.80 | | |

¹ppm = absorbance level × standard curve slope (1.7438) × dilution factor (200)
²SEM: Standard error of the mean (largest) of the least squares means
³With 547 ppm sodium erythorbate
^{a-b}LSMeans for each main effect within a row with different superscripts by row different (P < 0.05)

TABLE 53
Least Squares Means for Main Effects of Concentration and Temperature
and the Two Way Interaction of Concentration and Temperature for Residual
Nitrite Levels in L-Arginine Pork Samples (Phase I)³

| Concentration | | Residual Nitrite (ppm)¹ | | | | | |
|---|---|---|---|---|---|---|---|
| n = 320 | | | | | | | |
| Concentration | 1000 ppm | 2000 ppm | 3000 ppm | 4000 ppm | 5000 ppm | SEM² | p-value |
| | 57.57 | 68.91 | 61.54 | 52.07 | 64.52 | 9.01 | 0.5421 |
| Temperature | 132 °F | 158 °F | 165 °F | | | | |
| | 53.72 | 63.29 | 65.72 | | | 6.34 | 0.3523 |
| Conc × Temp | 1000 ppm | 2000 ppm | 3000 ppm | 4000 ppm | 5000 ppm | | |
| 132 °F | 39.35 | 80.08 | 60.68 | 48.21 | 40.28 | 16.76 | 0.4775 |
| 158 °F | 70.84 | 66.63 | 61.71 | 52.12 | 65.12 | | |
| 165 °F | 62.52 | 60.04 | 62.24 | 55.87 | 88.16 | | |

¹ppm = absorbance level × standard curve slope (1.7438) × dilution factor (200)
²SEM: Standard error of the mean (largest) of the least squares means
³With 547 ppm sodium erythorbate

TABLE 54
Least Squares Means for Main Effects of Concentration and Temperature
and the Two Way Interaction of Concentration and Temperature for Residual
Nitrite Levels in L-Arginine Poultry Samples (Phase I)³

| | Residual Nitrite (ppm)¹ | | | | | | |
|---|---|---|---|---|---|---|---|
| n = 320 | | | | | | | |
| Concentration | 1000 ppm | 2000 ppm | 3000 ppm | 4000 ppm | 5000 ppm | SEM² | p-value |
| | 65.44^{ab} | 72.28^{a} | 54.95^{bc} | 48.16^{cd} | 38.14^{d} | 3.46 | <0.0001 |
| Temperature | 132 °F | 158 °F | 165 °F | | | | |
| | 48.43 | 55.64 | 53.32 | | | 2.64 | 0.3899 |
| Conc × Temp | 1000 ppm | 2000 ppm | 3000 ppm | 4000 ppm | 5000 ppm | | |
| 132 °F | 76.46^{ab} | 63.44^{abc} | 60.08^{abc} | 50.99^{a-d} | 41.15^{cd} | 6.41 | 0.0008 |
| 158 °F | 60.52^{abc} | 77.50^{a} | 65.81^{abc} | 49.31^{a-d} | 25.07^{d} | | |
| 165 °F | 59.36^{abc} | 75.91^{ab} | 38.96^{cd} | 44.17^{cd} | 48.20^{bcd} | | |

¹ppm = absorbance level × standard curve slope (1.7438) × dilution factor (200)
²SEM: Standard error of the mean (largest) of the least squares means
³With 547 ppm sodium erythorbate
^{a-d}LSMeans for each main effect within a row with different superscripts by row different (P < 0.05)
^{a-d}LSMeans for each significant main effect two way interaction within each row and column with different superscripts are different (P < 0.05)

TABLE 55
Least Squares Means for Main Effects of Concentration and Temperature
and the Two Way Interaction of Concentration and Temperature for Residual
Nitrite Levels in L-Arginine Beef Samples (Phase II)³

| | Residual Nitrite (ppm)¹ | | | | | | |
|---|---|---|---|---|---|---|---|
| n = 320 | | | | | | | |
| Concentration | 1000 ppm | 2000 ppm | 3000 ppm | 4000 ppm | 5000 ppm | SEM² | p-value |
| | 107.03^{a} | 105.44^{a} | 102.80^{a} | 90.87^{a} | 40.23^{b} | 6.21 | <0.0001 |
| Temperature | 132 °F | 158 °F | 165 °F | | | | |
| | 95.63^{a} | 95.30^{a} | 77.89^{b} | | | 4.71 | 0.0126 |
| Conc × Temp | 1000 ppm | 2000 ppm | 3000 ppm | 4000 ppm | 5000 ppm | | |
| 132 °F | 110.31^{a} | 101.25^{abc} | 107.12^{ab} | 101.77^{ab} | 52.68^{cd} | 11.25 | 0.0447 |
| 158 °F | 117.12^{a} | 96.50^{abc} | 111.73^{a} | 113.35^{a} | 37.81^{d} | | |
| 165 °F | 93.64^{abc} | 118.58^{a} | 89.54^{abc} | 57.51^{bcd} | 30.19^{d} | | |

¹ppm = absorbance level × standard curve slope (1.7438) × dilution factor (200)
²SEM: Standard error of the mean (largest) of the least squares means
³Without 547 ppm sodium erythorbate
^{a-b}LSMeans for each main effect within a row with different superscripts by row different (P < 0.05)
^{a-d}LSMeans for each significant main effect two way interaction within each row and column with different superscripts are different (P < 0.05)

TABLE 56
Least Squares Means for Main Effects of Concentration and Temperature
and the Two Way Interaction of Concentration and Temperature for Residual
Nitrite Levels in L-Arginine Pork Samples (Phase II)³

| | Residual Nitrite (ppm)¹ | | | | | | |
|---|---|---|---|---|---|---|---|
| n = 320 | | | | | | | |
| Concentration | 1000 ppm | 2000 ppm | 3000 ppm | 4000 ppm | 5000 ppm | SEM² | p-value |
| | 73.46^{b} | 94.97^{ab} | 85.31^{ab} | 102.65^{a} | 72.06^{b} | 6.49 | 0.0013 |
| Temperature | 132 °F | 158 °F | 165 °F | | | | |
| | 67.81^{c} | 103.33^{a} | 85.93^{b} | | | 4.85 | <0.0001 |
| Conc × Temperature | 1000 ppm | 2000 ppm | 3000 ppm | 4000 ppm | 5000 ppm | | |
| 132 °F | 53.73^{c} | 85.87^{bc} | 68.26^{bc} | 71.48^{bc} | 59.74^{c} | 12.42 | 0.0177 |
| 158 °F | 84.43^{bc} | 113.28^{ab} | 90.54^{bc} | 150.78^{a} | 77.63^{bc} | | |
| 165 °F | 82.22^{bc} | 85.76^{bc} | 97.13^{bc} | 85.70^{bc} | 78.82^{bc} | | |

¹ppm = absorbance level × standard curve slope (1.7438) × dilution factor (200)
²SEM: Standard error of the mean (largest) of the least squares means
³Without 547 ppm sodium erythorbate
^{a-c}LSMeans for each main effect within a row with different superscripts by row different (P < 0.05)
^{a-c}LSMeans for each significant main effect two way interaction within each row and column with different superscripts are different (P < 0.05)

TABLE 57
Least Squares Means for Main Effects of Concentration and Temperature
and the Two Way Interaction of Concentration and Temperature for Residual
Nitrite Levels in L-Arginine Poultry Samples (Phase II)³

| Concentration | Residual Nitrite (ppm)¹ | | | | | | |
|---|---|---|---|---|---|---|---|
| n = 320 | | | | | | | |
| Concentration | 1000 ppm | 2000 ppm | 3000 ppm | 4000 ppm | 5000 ppm | SEM² | p-value |
| | 65.37^{a} | 66.58^{a} | 57.60^{ab} | 60.63^{ab} | 45.02^{b} | 5.41 | 0.0234 |
| Temperature | 132 °F | 158 °F | 165 °F | | | | |
| | 65.70 | 56.32 | 55.10 | | | 4.06 | 0.1299 |
| Conc × Temperature | 1000 ppm | 2000 ppm | 3000 ppm | 4000 ppm | 5000 ppm | | |
| 132 °F | 87.36^{a} | 65.60^{ab} | 53.90^{ab} | 67.76^{ab} | 53.87^{ab} | 10.15 | 0.0204 |
| 158 °F | 63.54^{ab} | 61.51^{ab} | 73.59^{a} | 52.15^{ab} | 30.83^{b} | | |
| 165 °F | 45.19^{ab} | 72.63^{ab} | 45.32^{ab} | 61.99^{ab} | 50.37^{ab} | | |

¹ppm = absorbance level × standard curve slope (1.7438) × dilution factor (200)
²SEM: Standard error of the mean (largest) of the least squares means
³Without 547 ppm sodium erythorbate
^{a-b}LSMeans for each main effect within a row with different superscripts by row different (P < 0.05)
^{a-b}LSMeans for each significant main effect two way interaction within each row and column with different superscripts are different (P < 0.05)

Summary Table A: Table 58. Equivalency Scale
Summary Least Squares Means for Main Effect of Concentration on
Residual Nitrite Levels in Sodium Nitrite and L-Arginine Beef, Pork
and Poultry Samples (Phase 1)³ from Previous Tables.
Residual Nitrite (ppm)¹

| | Beef | | | | | Significance |
|---|---|---|---|---|---|---|
| Concentration | 120 ppm | 156 ppm | 200 ppm | | | |
| Sodium Nitrite | 75.33 | 81.08 | 72.05 | | | C × T P < 0.05 |
| Concentration | 1000 ppm | 2000 ppm | 3000 ppm | 4000 ppm | 5000 ppm | P < 0.0001 |
| L-Arginine | 75.81 | 74.96 | 73.42 | 69.45 | 48.27 | |
| | Pork | | | | | Significance |
| Concentration | 120 ppm | 156 ppm | 200 ppm | | | |
| Sodium Nitrite | 42.30 | 62.37 | 68.22 | | | P < 0.01 |
| Concentration | 1000 ppm | 2000 ppm | 3000 ppm | 4000 ppm | 5000 ppm | NS |
| L-Arginine | 57.57 | 68.91 | 61.54 | 52.07 | 64.52 | |
| | Poultry | | | | | Significance |
| | 120 ppm | 156 ppm | 200 ppm | | | |
| Sodium | 64.56 | 78.51 | 90.59 | | | P < 0.001 |
| Nitrite | | | | | | |
| Concentration | 1000 ppm | 2000 ppm | 3000 ppm | 4000 ppm | 5000 ppm | P < 0.0001 |
| L-Arginine | 65.44 | 72.28 | 54.95 | 48.16 | 38.14 | |

¹ppm = absorbance level × standard curve slope (1.7438) × dilution factor (200);
²SEM: Standard error of the mean (largest) of the least squares means;
³With 547 ppm sodium erythorbate

Summary Table B: Table 59. Equivalency Scale.
Summary Least Squares Means for Main Effect of Concentration
Residual Nitrite Levels in Sodium Nitrite and L-Arginine Beef,
Pork and Poultry Samples (Phase II)³ from Previous Tables.
Residual Nitrite (ppm)¹

| | Beef | | | | | Significance |
|---|---|---|---|---|---|---|
| Concentration | 120 ppm | 156 ppm | 200 ppm | | | NS |
| Sodium Nitrite | 182.18 | 202.15 | 196.51 | | | |
| Concentration | 1000 ppm | 2000 ppm | 3000 ppm | 4000 ppm | 5000 ppm | C × T P < 0.05 |
| L-Arginine | 107.03 | 105.44 | 102.80 | 90.87 | 40.23 | |
| | Pork | | | | | Significance |
| Concentration | 120 ppm | 156 ppm | 200 ppm | | | C × T P < 0.05 |
| Sodium Nitrite | 214.53 | 183.17 | 172.38 | | | |
| Concentration | 1000 ppm | 2000 ppm | 3000 ppm | 4000 ppm | 5000 ppm | C × T P < 0.05 |
| L-Arginine | 73.46 | 94.97 | 85.31 | 102.65 | 72.06 | |
| | Poultry | | | | | Significance |
| Concentration | 120 ppm | 156 ppm | 200 ppm | | | C × T P < 0.05 |
| Sodium Nitrite | 64.56 | 78.51 | 90.59 | | | |
| Concentration | 1000 ppm | 2000 ppm | 3000 ppm | 4000 ppm | 5000 ppm | C × T P < 0.05 |
| L-Arginine | 65.44 | 72.28 | 54.95 | 48.16 | 38.14 | |

¹ppm = absorbance level × standard curve slope (1.7438) × dilution factor (200);
²SEM: Standard error of the mean (largest) of the least squares means;
³Without 547 ppm sodium erythorbate

Summary Table C: Table 60. Equivalency Scale
Summary Least Squares Means for Main Effect of Temperature on
Residual Nitrite Levels in Sodium Nitrite and L-Arginine Beef,
Pork and Poultry Samples (Phase 1)³ from Previous Tables.
Residual Nitrite (ppm)¹

| | Beef | | | Significance |
|---|---|---|---|---|
| Temperature | 132 °F | 158 °F | 165 °F | C × T P < 0.05 |
| Sodium Nitrite | 104.42 | 61.54 | 62.50 | |
| Temperature | 132 °F | 158 °F | 165 °F | P < 0.001 |
| L-Arginine | 75.28 | 71.90 | 57.96 | |
| | Pork | | | Significance |
| Temperature | 132 °F | 158 °F | 165 °F | NS |
| Sodium Nitrite | 63.03 | 48.21 | 61.66 | |
| Temperature | 132 °F | 158 °F | 165 °F | NS |
| L-Arginine | 53.72 | 63.29 | 65.72 | |
| | Poultry | | | Significance |
| Temperature | 132 °F | 158 °F | 165 °F | |
| Sodium Nitrite | 84.75 | 79.98 | 68.93 | P < 0.05 |
| Temperature | 132 °F | 158 °F | 165 °F | C × T P < 0.001 |
| L-Arginine | 48.43 | 55.64 | 53.32 | |

¹ppm = absorbance level × standard curve slope (1.7438) × dilution factor (200);
²SEM: Standard error of the mean (largest) of the least squares means;
³With 547 ppm sodium erythorbate

Summary Table D: Table 61. Equivalency Scale
Summary Least Squares Means for Main Effect of Temperature on
Residual Nitrite Levels in Sodium Nitrite and L-Arginine Beef,
Pork and Poultry Samples (Phase II)³ from Previous Tables.

| | Residual Nitrite (ppm)¹ | | | |
|---|---|---|---|---|
| | Beef | | | Significance |
| Temperature | 132 °F | 158 °F | 165 °F | NS |
| Sodium Nitrite | 190.58 | 207.32 | 182.94 | |
| Temperature | 132 °F | 158 °F | 165 °F | C × T P < 0.05 |
| L-Arginine | 95.63 | 95.30 | 77.89 | |
| | Pork | | | Significance |
| Temperature | 132 °F | 158 °F | 165 °F | C × T P < 0.05 |
| Sodium Nitrite | 192.61 | 186.00 | 185.85 | |
| Temperature | 132 °F | 158 °F | 165 °F | C × T P < 0.05 |
| L-Arginine | 67.81 | 103.33 | 85.93 | |
| | Poultry | | | Significance |
| Temperature | 132 °F | 158 °F | 165 °F | |
| Sodium Nitrite | 207.82 | 183.34 | 172.46 | C × T P < 0.05 |
| Temperature | 132 °F | 158 °F | 165 °F | C × T P < 0.05 |
| L-Arginine | 65.70 | 56.32 | 55.10 | |

¹ppm = absorbance level × standard curve slope (1.7438) × dilution factor (200);
²SEM: Standard error of the mean (largest) of the least squares means;
³Without 547 ppm sodium erythorbate

Thus, specific compositions and methods of amino acid alternative curing system have been disclosed. It should be apparent, however, to those skilled in the art that many more modifications besides those already described are possible without departing from the inventive concepts herein. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Although the invention has been described with reference to these preferred embodiments, other embodiments can achieve the same results. Variations and modifications of the present invention will be obvious to those skilled in the art and it is intended to cover in the appended claims all such modifications and equivalents. The entire disclosures of all applications, patents, and publications cited above, and of the corresponding application are hereby incorporated by reference.

### REFERENCES

1. Savic, I. V. (1985) “Small-Scale Sausage Production,” FAO.
2. Krol, B. and Tinbergen, B. (1974) “Proceedings of the International Symposium on Nitrite in Meat Products, Held at the Central Institute for Nutrition and Food Research Tno, Zeist, the Netherlands, Sep. 10-14, 1973,” in International Symposium of Nitrite in Meat Products (1973: Zeist, Netherlands), Pudoc, Zeist, Netherlands.
3. Wu, G. and Morris, S. M., Jr. (1998) “Arginine Metabolism: Nitric Oxide and Beyond,” Biochem. J. 336 (Pt 1)(Pt 1), 1-17.
4. Nussler, A. K. et al. (1994) “Coinduction of Nitric Oxide Synthase and Argininosuccinate Synthetase in a Murine Macrophage Cell Line. Implications for Regulation of Nitric Oxide Production,” J. Biol. Chem. 269(2), 1257-1261.
5. Warner, R. D. et al. (2005) “Effects of Nitric Oxide and Oxidation in vivo and Postmortem on Meat Tenderness,” Meat Sci. 71(1), 205-217.
6. Harper, G. S. (1999) “Trends in Skeletal Muscle Biology and the Understanding of Toughness in Beef,” Aust. J. Agric. Res. 50(7), 1105-1129.
7. Honikel, K.-O. (2008) “The Use and Control of Nitrate and Nitrite for the Processing of Meat Products,” Meat Sci. 78(1), 68-76.
8. Sindelar, J. J. and Milkowski, A. L. (2012) “Human Safety Controversies Surrounding Nitrate and Nitrite in the Diet,” Nitric Oxide 26(4), 259-266.
9. Council, N. R. (1985) “The Health Effects of Nitrate, Nitrite, and N-Nitroso Compounds: National Academy of Sciences.,” National Academy of Sciences, Washington, DC.
10. Redfield, A. L. and Sullivan, G. A. (2015) “Effects of Conventional and Alternative Curing Methods on Processed Turkey Quality Traits,” Poult. Sci 94(12), 3005-3014.
11. Bryan, N. S. (2016) “Dietary Nitrite: From Menace to Marvel,” Functional Foods in Health and Disease 6, 691-701.
12. Zhao, Y et al. (2015) “Vascular Nitric Oxide: Beyond Enos,” J. Pharmacol. Sci. 129(2), 83-94.
13. Binkerd, E. F. and Kolari, O. E. (1975) “The History and Use of Nitrate and Nitrite in the Curing of Meat,” Food Cosmet. Toxicol. 13(6), 655-661.
14. Haldane, J. (1901) “The Colorimetric Determination of Homoglobin,” J. Physiol. (Lond.) 26(6), 497-504.
15. Cassens, R. (1990) in Nitrite-Cured Meat, pp 3-36, Food and Nutrition Press Inc., Trumbull, CT.
16. Regulations, U. S. C. o. F. (1978) “Sections 319.2, Products and Nitrates and Nitrites; 424.21 Curing Agents; 424.22(B) Use of Nitrite and Sodium Ascorbate or Sodium Erythorbate (Isoascorbate) in Bacon. In 9. Animals and Animal Products, 1978.”
17. United State Department of Agriculture. (1995) “Processing Inspectors' Calculations Handbook,” Washington, DC, US Government Printing Office.
18. Cassens, R. G. et al. (1978) “The Use of Nitrite in Meat,” Bioscience 28(10), 633-637.
19. Kosaka, H. (1999) “Nitric Oxide and Hemoglobin Interactions in the Vasculature,” Biochimica et Biophysica Acta (BBA)—Bioenergetics 1411(2), 370-377.
20. Richards, M. P. (2012) “Redox Reactions of Myoglobin,” Antioxid. Redox Signal. 18(17), 2342-2351.
21. Cornforth, D. et al. (1992) “Methods for Identification and Prevention of Pink Color in Cooked Meat,” Proceedings—Annual Reciprocal Meat Conference of the American Meat Science Association (USA), 1992.
22. Hornsey, H. C. (1956) “The Colour of Cooked Cured Pork. I.—Estimation of the Nitric Oxide-Haem Pigments,” J. Sci. Food Agric. 7(8), 534-540.
23. Killday, K. B. et al. (1988) “Structural Characterization of Nitrosylhemochromogen of Cooked Cured Meat: Implications in the Meat-Curing Reaction,” J. Agric. Food Chem. 36(5), 909-914.
24. Alahakoon, A. U. et al. (2015) “Alternatives to Nitrite in Processed Meat: Up to Date,” Trends Food Sci. Technol. 45(1), 37-49.
25. Keeton, J. et al. (2009) “A National Survey of the Nitrite/Nitrate Concentrations in Cured Meat Products and Non-Meat Foods Available at Retail-Npb #08-124,” National Pork Board Research Report 2009.
26. Houser, T. A. et al. (2005) “The Effects of Irradiation at 1.6 Kgy on Quality Characteristics of Commercially Produced Ham and Pork Frankfurters over Extended Storage,” J. Food Sci. 70(4), S262-S266.
27. Cassens, R. G. (1997) “Composition and Safety of Cured Meats in the USA,” Food Chem. 59(4), 561-566.
28. Cassens, R. G. (1997) “Residual Nitrite in Cured Meat,” Food Technology 51(2), 53-55.
29. Olsman, W. and Krol, B. (1972) “Depletion of Nitrite in Heated Meat Products During Storage,” in Proceedings of Meat Research Workers Conference 1972, pp 409-415, Guelph.
30. Kubberod, G. et al. (1974) “Reaction of Nitrite with Sulfhydryl Groups of Myosin,” J. Food Sci. 39(6), 1228-1230.
31. Cammack, R. et al. (1999) “Nitrite and Nitrosyl Compounds in Food Preservation,” Biochimica et Biophysica Acta (BBA)—Bioenergetics 1411(2), 475-488.
32. ROBERTS, T. A. and INGRAM, M. (1973) “Inhibition of Growth of Cl. botulinum at Different pH Values by Sodium Chloride and Sodium Nitrite,” Int. J. Food Sci. Technol. 8(4), 467-475.
33. Stamler, J. S. et al. (1992) “Nitric Oxide Circulates in Mammalian Plasma Primarily as an S-Nitroso Adduct of Serum Albumin,” P.N.A.S. 89(16), 7674.
34. Newberne, P. M. (1979) “Nitrite Promotes Lymphoma Incidence in Rats,” Science 204(4397), 1079.
35. Council, N. R. (1982) “Alternatives to the Current Use of Nitrite in Foods Part 2 of a 2-Part Study,” National Academy of Sciences, Washington, DC.
36. Council, N. R. (1982) “Alternatives to the Current Use of Nitrite in Foods Part 1 of a 2-Part Study,” National Academy of Sciences, Washington, DC.
37. Sarasua, S. and Savitz, D. A. (1994) “Cured and Broiled Meat Consumption in Relation to Childhood Cancer: Denver, Colorado (United States),” Cancer Causes Control 5(2), 141-148.
38. Peters, J. M. et al. (1994) “Processed Meats and Risk of Childhood Leukemia (California, USA),” Cancer Causes Control 5(2), 195-202.
39. Preston-Martin, S. et al. (1996) “Maternal Consumption of Cured Meats and Vitamins in Relation to Pediatric Brain Tumors,” Cancer Epidemiol. Biomark. Prev. 5(8), 599.
40. Navia, J. L. et al. (2010) “Integrating the Totality of Food and Nutrition Evidence for Public Health Decision Making and Communication,” Crit. Rev. Food Sci. Nutr. 50 Suppl 1(s1), 1-8.
41. Alexander, D. D. et al. (2011) “Meta-Analysis of Prospective Studies of Red Meat Consumption and Colorectal Cancer,” Eur. J. Cancer Prev. 20(4), 293-307.
42. Scanlan, R. A. (1983) “Formation and Occurrence of Nitrosamines in Food,” Cancer Res. 43(5 Suppl), 2435s-2440s.
43. Herrmann, S. S. et al. (2014) “N-Nitrosamines in Processed Meat Products-Analysis, Occurrence, Formation, Mitigation and Exposure,” in National Food Institute, Technical University of Denmark.
44. Herrmann, S. S. et al. (2015) “Formation and Mitigation of N-Nitrosamines in Nitrite Preserved Cooked Sausages,” Food Chem. 174, 516-526.
45. Sindelar, J. J. and Houser, T. A. (2009) “Alternative Curing Systems,” in Ingredients in Meat Products (Tarté, R., Ed.), pp 379-405, Springer, New York, NY
46. Mller, A. J. et al. (1993) “Comparison of Organic Acid Salts for Clostridium botulinum Control in an Uncured Turkey Product,” J. Food Prot. 56(11), 958-962.
47. Sofos, J. N. et al. (1979) “Botulism Control by Nitrite and Sorbate in Cured Meats: A Review,” J. Food Prot. 42(9), 739-770.
48. Sindelar, J. J. (2006) “Investigating Uncured No Nitrate or Nitrite Added Processed Meat Products,” in Meat Science, Iowa State University.
49. Shahidi, F. and Pegg, R. B. (1992) “Nitrite-Free Meat Curing Systems: Update and Review,” Food Chem. 43(3), 185-191.
50. Sindelar, J. J. et al. (2007) “Effects of Vegetable Juice Powder Concentration and Storage Time on Some Chemical and Sensory Quality Attributes of Uncured, Emulsified Cooked Sausages,” J. Food Sci. 72(5), S324-S332.
51. Sebranek, J. G. and Bacus, J. N. (2007) “Cured Meat Products without Direct Addition of Nitrate or Nitrite: What Are the Issues?,” Meat Sci. 77(1), 136-147.
52. Klaenhammer, T. R. (1993) “Genetics of Bacteriocins Produced by Lactic Acid Bacteria*,” FEMS Microbiol. Rev. 12(1-3), 39-85.
53. Krause, B. L. et al. (2011) “Incubation of Curing Brines for the Production of Ready-to-Eat, Uncured, No-Nitrite-or-Nitrate-Added, Ground, Cooked and Sliced Ham,” Meat Sci. 89(4), 507-513.
54. Federal Regulations. (2006) “Title 9—Animals and Animal Products in Code of Federal Regulations: 2006.”
55. Federal Regulations. (2006) “Food Labeling—Cfr—Code of Federal Regulations Title 21: 2006.”
56. Hunault, C. C. et al. (2009) “Bioavailability of Sodium Nitrite from an Aqueous Solution in Healthy Adults,” Toxicol. Lett. 190(1), 48-53.
57. Archer, D. L. (2002) “Evidence That Ingested Nitrate and Nitrite Are Beneficial to Health,” J. Food Prot. 65(5), 872-875.
58. Morris Jr, S. M. and Billiar, T. R. (1994) “New Insights into the Regulation of Inducible Nitric Oxide Synthesis,” American Journal of Physiology—Endocrinology and Metabolism 266(6), E829-E839.
59. Kelm, M. (1999) “Nitric Oxide Metabolism and Breakdown,” Biochimica et Biophysica Acta (BBA)—Bioenergetics 1411(2), 273-289.
60. Shiva, S. et al. (2007) “Deoxymyoglobin Is a Nitrite Reductase That Generates Nitric Oxide and Regulates Mitochondrial Respiration,” Circ. Res. 100(5), 654-661.
61. Bogle, R. G. et al. (1992) “L-Arginine Transport Is Increased in Macrophages Generating Nitric Oxide,” Biochem. J 284(1), 15-18.
62. Sato, H. et al. (1992) “Effect of Lipopolysaccharide on Transport and Metabolism of Arginine in Mouse Peritoneal Macrophages,” J Leukoc. Biol. 52(2), 161-164.
63. Alderton, W. K. et al. (2001) “Nitric Oxide Synthases: Structure, Function and Inhibition,” Biochem. J. 357(Pt 3), 593-615.
64. Forstermann, U. and Munzel, T. (2006) “Endothelial Nitric Oxide Synthase in Vascular Disease: From Marvel to Menace,” Circulation 113(13), 1708-1714.
65. Schmidt, H. H. H. W. et al. (1996) “No ·NO from NO Synthase,” P.N.A.S. 93(25), 14492.
66. Tengan, C. H. et al. (2012) “Nitric Oxide in Skeletal Muscle: Role on Mitochondrial Biogenesis and Function,” Int. J Mol. Sci. 13(12), 17160-17184.
67. Stamler, J. S. and Meissner, G. (2001) “Physiology of Nitric Oxide in Skeletal Muscle,” Physiol. Rev 81(1), 209-237.
68. Borutaité, V. and Brown, G. C. (1996) “Rapid Reduction of Nitric Oxide by Mitochondria, and Reversible Inhibition of Mitochondrial Respiration by Nitric Oxide,” Biochem. J. 315 (Pt 1)(Pt 1), 295-299.
69. Bredt, D. S. et al. (1990) “Localization of Nitric Oxide Synthase Indicating a Neural Role for Nitric Oxide,” Nature 347(6295), 768-770.
70. Semenza, G. L. (2005) “New Insights into Nnos Regulation of Vascular Homeostasis,” J. Clin. Invest. 115(11), 2976-2978.
71. Nathan, C. F. and Hibbs, J. B. (1991) “Role of Nitric Oxide Synthesis in Macrophage Antimicrobial Activity,” Curr. Opin. Immunol. 3(1), 65-70.
72. Hibbs, J. B. et al. (1987) “Macrophage Cytotoxicity: Role for L-Arginine Deiminase and Imino Nitrogen Oxidation to Nitrite,” Science 235(4787), 473.
73. Salvemini, D. et al. (1989) “Human Neutrophils and Mononuclear Cells Inhibit Platelet Aggregation by Releasing a Nitric Oxide-Like Factor,” P.N.A.S. 86(16), 6328.
74. Kelm, M. et al. (1995) “Role of Nitric Oxide in the Regulation of Coronary Vascular Tone in Hearts from Hypertensive Rats,” Hypertension 25(2), 186-193.
75. Zweier, J. L. et al. (1999) “Non-Enzymatic Nitric Oxide Synthesis in Biological Systems,” Biochimica et Biophysica Acta (BBA)—Bioenergetics 1411(2), 250-262.
76. Shiva, S. (2013) “Nitrite: A Physiological Store of Nitric Oxide and Modulator of Mitochondrial Function,” Redox Biology 1(1), 40-44.
77. Huang, Z. et al. (2005) “Enzymatic Function of Hemoglobin as a Nitrite Reductase That Produces NO under Allosteric Control,” J. Clin. Invest. 115(8), 2099-2107.
78. Hendgen-Cotta, U. B. et al. (2008) “Nitrite Reductase Activity of Myoglobin Regulates Respiration and Cellular Viability in Myocardial Ischemia-Reperfusion Injury,” P.N.A.S. 105(29), 10256.
79. Totzeck, M. et al. (2012) “Nitrite Regulates Hypoxic Vasodilation Via Myoglobin-Dependent Nitric Oxide Generation,” Circulation 126(3), 325-334.
80. Castello, P. R. et al. (2006) “Mitochondrial Cytochrome Oxidase Produces Nitric Oxide under Hypoxic Conditions: Implications for Oxygen Sensing and Hypoxic Signaling in Eukaryotes,” Cell Metab. 3(4), 277-287.
81. Shiva, S. et al. (2007) “Nitrite Augments Tolerance to Ischemia/Reperfusion Injury Via the Modulation of Mitochondrial Electron Transfer,” J. Exp. Med. 204(9), 2089-2102.
82. Mo, L. et al. (2012) “Nitrite Activates AMP Kinase to Stimulate Mitochondrial Biogenesis Independent of Soluble Guanylate Cyclase,” Free Radic. Biol. Med. 53(7), 1440-1450.
83. Gladwin, M. T. and Kim-Shapiro, D. B. (2008) “The Functional Nitrite Reductase Activity of the Heme-Globins,” Blood 112(7), 2636-2647.
84. Ignarro, L. J. et al. (1993) “Oxidation of Nitric Oxide in Aqueous Solution to Nitrite but Not Nitrate: Comparison with Enzymatically Formed Nitric Oxide from L-Arginine,” P.N.A.S. 90(17), 8103.
85. Sessa, W. C. et al. (1990) “The Metabolism of L-Arginine and Its Significance for the Biosynthesis of Endothelium-Derived Relaxing Factor: L-Glutamine Inhibits the Generation of L-Arginine by Cultured Endothelial Cells,” Proc. Natl. Acad. Sci. U.S.A. 87(21), 8607-8611.
86. Bogle, R. G. et al. (1992) “Identification of Inhibitors of Nitric Oxide Synthase That Do Not Interact with the Endothelial Cell L-Arginine Transporter,” Br. J. Pharmacol. 105(4), 768-770.
87. Schmidt, K. et al. (1993) “Characterization of Endothelial Cell Amino Acid Transport Systems Involved in the Actions of Nitric Oxide Synthase Inhibitors,” Mol. Pharmacol. 44(3), 615.
88. Schmidt, K. et al. (1994) “Uptake of Nitric Oxide Synthase Inhibitors by Macrophage Raw 264.7 Cells,” Biochem. J 301 (Pt 2)(Pt 2), 313-316.
89. Bogle, R. G. et al. (1995) “Induction of Ng-Monomethyl-L-Arginine Uptake: A Mechanism for Differential Inhibition of NO Synthases?,” American Journal of Physiology—Cell Physiology 269(3), C750-C756.
90. Simmons, W. W. et al. (1996) “Cytokines and Insulin Induce Cationic Amino Acid Transporter (CAT) Expression in Cardiac Myocytes: Regulation of L-Arginine Transport and NO Production by CAT-1, CAT-2a, and CAT-2b,” J. Biol. Chem. 271(20), 11694-11702.
91. Stevens, B. R. et al. (1996) “Induced Nitric Oxide Synthesis Is Dependent on Induced Alternatively Spliced CAT-2 Encoding L-Arginine Transport in Brain Astrocytes,” J. Biol. Chem. 271(39), 24017-24022.
92. Modolell, M. et al. (1997) “Oxidation of Ng-Hydroxyl-L-Arginine to Nitric Oxide Mediated by Respiratory Burst: An Alternative Pathway to NO Synthesis,” FEBS Lett. 401(2), 123-126.
93. Morita, M. et al. (2014) “Oral Supplementation with a Combination of L-Citrulline and L-Arginine Rapidly Increases Plasma L-Arginine Concentration and Enhances NO Bioavailability,” Biochem. Biophys. Res. Commun. 454(1), 53-57.
94. Cook, C. J. et al. (1998) “Measurement of Nitric Oxide and the Effect of Enhancing or Inhibiting It on Tenderness Changes of Meat,” Meat Sci. 48(1), 85-89.
95. Liu, R. et al. (2016) “Effect of Protein S-Nitrosylation on Autolysis and Catalytic Ability of M-Calpain,” Food Chem. 213, 470-477.
96. Su, D. et al. (2013) “Quantitative Site-Specific Reactivity Profiling of S-Nitrosylation in Mouse Skeletal Muscle Using Cysteinyl Peptide Enrichment Coupled with Mass Spectrometry,” Free Radic. Biol. Med. 57, 68-78.
97. Liu, R. et al. (2019) “Effect of Nitric Oxide on Myofibrillar Proteins and the Susceptibility to Calpain-1 Proteolysis,” Food Chem. 276, 63-70.
98. Zweier, J. L. et al. (1995) “Enzyme-Independent Formation of Nitric Oxide in Biological Tissues,” Nat. Med. 1(8), 804-809.
99. Kobzik, L. et al. (1994) “Nitric Oxide in Skeletal Muscle,” Nature 372(6506), 546-548.
100. Melody, J. L. et al. (2004) “Early Postmortem Biochemical Factors Influence Tenderness and Water-Holding Capacity of Three Porcine Muscles,” J. Anim. Sci. 82(4), 1195-1205.
101. Wu, G. et al. (1997) “Endogenous Synthesis of Arginine Plays an Important Role in Maintaining Arginine Homeostasis in Postweaning Growing Pigs,” J. Nutr. 127(12), 2342-2349.
102. Li, H. et al. (2000) “Rapid Determination of Nitrite by Reversed-Phase High-Performance Liquid Chromatography with Fluorescence Detection,” Journal of Chromatography B: Biomedical Sciences and Applications 746(2), 199-207.
103. Association, A. M. S. (2012) “Amsa Meat Color Measurement Guidelines: Amsa. American Meat Science Association: 2012.”
104. Fitch, C. A. et al. (2015) “Arginine: Its pKa Value Revisited,” Protein science: a publication of the Protein Society 24(5), 752-761.
105. Jiao, L. et al. (2013) “Determination of Nitrite Using Uv Absorption Spectra Based on Multiple Linear Regression,” Asian J. Chem. 35(4), 2273-2277.
106. Heaton, K. M. et al. (2000) “Minimum Sodium Nitrite Levels for Pinking of Various Cooked Meats as Related to Use of Direct or Indirect-Dried Soy Isolates in Poultry Rolls,” Meat Sci. 55(3), 321-329.
107. Suhr, F. et al. (2013) “Skeletal Muscle Function During Exercise-Fine-Tuning of Diverse Subsystems by Nitric Oxide,” Int. J. Mol. Sci. 14(4), 7109-7139.
108. Izumi, K. et al. (1989) “Reaction of Nitrite with Ascorbic Acid and Its Significant Role in Nitrite-Cured Food,” Meat Sci. 26(2), 141-153.
109. Pearson, A. and Tauber, F. (1984) “Analytical Methods,” in Processed Meats, pp 351-388, Springer.
110. Bryan, N. S. (2009) “Cardioprotective Actions of Nitrite Therapy and Dietary Considerations,” Front Biosci (Landmark Ed) 14, 4793-4808.
111. Jayasena, D. and Jo, C. (2013) “Essential Oils as Potential Antimicrobial Agents in Meat and Meat Products: A Review,” Trends Food Sci. Technol. 34, 96-108.
112. Modrow, K. and Osburn, W. N. (2020) “Nitric Oxide Production in Pre-Rigor Semimembranosus Pork Muscle,” in Proceedings of the 66th International Congress of Meat Science and Technology August 3-7.

We claim:

1. A method for curing meat comprising,
a. providing
i. a curing composition comprising amino acid L-arginine, wherein said composition comprises no nitrite,
ii. meat,
b. treating said meat with said curing composition as a function of the weight of said meat so as to generate nitric oxide to provide the desired meat product.

2. The method for curing meat according to claim 1, wherein said meat is pre-rigor meat.

3. The method for curing meat according to claim 1, wherein said meat is post-rigor meat.

4. The method for curing meat according to claim 1, wherein said curing composition further comprises NaCl and sodium erythorbate.

5. The method for curing meat according to claim 1, wherein said curing composition further comprises citrulline.

6. The method for curing meat according to claim 4, wherein the sodium chloride is in a range from 0.5% to 2.0% by weight of said meat.

7. The method according to claim 1, wherein the curing composition is injected into said meat.

8. The method according to claim 1, wherein said curing composition is in the form of a solution.

9. The method according to claim 8, wherein the curing composition is injected into said meat.

10. The method according to claim 8, wherein said meat is immersed in said solution for at least two hours.

11. The method for curing meat according to claim 8, wherein the treating step is performed by mixing said curing composition directly with the meat, and mechanical agitation the of the meat mixture to provide uniform distribution of the curing composition in the meat being treated.

12. The method according to claim 1, wherein said curing composition is a dry formulation.

13. (canceled)

14. The method according to claim 1, wherein said method is a replacement for the standard nitrite curing method.

15. (canceled)

16. (canceled)

17. (canceled)

18. (canceled)

19. (canceled)

20. (canceled)

21. A method for curing meat comprising,
a. providing
i. a curing composition comprising amino acid L-arginine, wherein said composition comprises no nitrite,
ii. meat,
b. dissolving said curing composition to form a curing composition solution, and
c. exposing said meat in said curing composition solution as a function of the weight of said meat so as to generate nitric oxide to provide the desired meat product.

22. The method according to claim 21, wherein exposing further comprises heating said meat internal temperature of 62° C.

23. The method according to claim 21, wherein the curing composition is injected into said meat.

24. The method according to claim 21, wherein said exposing comprises immersion in said curing composition solution for at least two hours.

25. The method for curing meat according to claim 21, wherein the exposing step is performed by mixing said curing composition directly with the meat, and mechanical agitation the of the meat mixture to provide uniform distribution of the curing composition in the meat being treated.

26. The method according to claim 21, wherein said exposing further initiates the reaction of endothelial nitric oxide synthase with said L-arginine to generate nitric oxide.

27. The method according to claim 1, wherein said treating further comprises heating said meat internal temperature of 62° C.

28. The method according to claim 1, wherein said composition comprises a cure accelerator.
